(19) United States
(12) Patent Application Publication
(10) Pub. No.: US 2026/0086332 A1
(43) Pub. Date: Mar. 26, 2026

(54) IMAGING OPTICAL SYSTEM

(71) Applicant: SIGMA CORPORATION, Kanagawa (JP)

(72) Inventor: Yukihiro YAMAMOTO, Fukuoka (JP)

(73) Assignee: SIGMA CORPORATION, Kanagawa (JP)

(21) Appl. No.: 19/325,938

(22) Filed: Sep. 11, 2025

(30) Foreign Application Priority Data
Sep. 20, 2024 (JP) 2024-163217

(51) Int. Cl. G02B 13/00; G02B 5/00; H04N 23/55

(52) U.S. Cl. CPC G02B 13/0045; G02B 5/005; G02B 13/006; H04N 23/55

(57) ABSTRACT

Provided is an imaging optical system that is compatible with a large image sensor, and achieves both a large aperture ratio and good aberration correction in consideration of weight reduction of a focus lens that is mainly driven in focusing. An imaging optical system consists of, in order from an object side: a front group GrF having a positive refractive power; a first focus group GrFC1 having a negative refractive power; a second focus group GrFC2 having a negative refractive power; and a rear group GrR having a positive refractive power. During focusing from infinity to a short distance, the front group GrF and the rear group GrR are fixed with respect to an image surface, the first focus group GrFC1 moves to the image side. The second focus group GrFC2 moves to the object side, and specific conditional expressions are satisfied.

### TECHNICAL FIELD

The present invention relates to an imaging optical system suitable for an imaging lens used in an imaging apparatus such as a still camera or a video camera.

### BACKGROUND ART

In recent years, cameras employing large image sensors have been widespread in imaging apparatuses such as digital still cameras and video cameras. In addition, a lens having a large aperture ratio is desired in order to obtain a large blurred image and to use a high-speed shutter. On the other hand, in the case of the auto focus or the video capturing, it is desirable to reduce the weight of the lens used for focusing in order to reduce the load on the actuator. However, in a case where the lens is configured with a large aperture ratio, the lens used for focusing is also increased in size, and the burden on the actuator and the control of the actuator is increased. In particular, in a telephoto lens having a large aperture ratio, the lens diameter tends to increase, so it is an important issue to reduce the weight of the lens for focusing.

### RELATED ART DOCUMENT

### Patent Document

[Patent Document 1] JP2023-009759 A
[Patent Document 2] WO2021/220579A
[Patent Document 3] WO2019/187633A
[Patent Document 4] JP2021-043376 A
[Patent Document 5] JP2021-067801 A

### SUMMARY OF THE INVENTION

For example, Patent Documents 1 to 3 disclose imaging optical systems that are compatible with large sized image sensors and are expected to perform auto focus. In Patent Documents 1 to 3, the weights of the focus lenses are reduced, and particularly, in Patent Documents 2 and 3, the effect of good aberration correction by floating focus can be confirmed. However, in the examples, the imaging optical systems are approximately F1.8, and in a case where the aperture ratio is further increased, the entire lens system becomes larger.

In addition, Patent Documents 4 and 5 disclose further imaging optical systems having large aperture ratios. In Patent Documents 4 and 5, it can be seen that it is difficult to achieve both aberration correction and reduction in weight of focusing in a case where further increase in aperture ratio is performed.

The present invention has been made in view of such circumstances, and an object of the present invention is to provide an imaging optical system that is compatible with a large image sensor, and achieves both a large aperture ratio and good aberration correction in consideration of weight reduction of a focus lens that is mainly driven in focusing.

In order to achieve the above object, the present invention provides an imaging optical system consisting of, in order from an object side: a front group GrF having a positive refractive power; a first focus group GrFC1 having a negative refractive power; a second focus group GrFC2 having a negative refractive power; and a rear group GrR having a positive refractive power, in which during focusing from infinity to a short distance, the front group GrF and the rear group GrR are fixed with respect to an image surface, the first focus group GrFC1 moves to the image side, the second focus group GrFC2 moves to the object side, and the following conditional expressions are satisfied.

$$0.20 < LGrF / fF < 1.4 \qquad ( 1 )$$

LGrF: a length of the front group GrF on an optical axis in an infinity-focusing state
fF: a focal length of the front group GrF in the infinity-focusing state

### Advantage of the Invention

According to the present invention, it is possible to provide an imaging optical system that is compatible with a large image sensor, and achieves both a large aperture ratio and good aberration correction in consideration of weight reduction of a focus lens that is mainly driven in focusing.

### BRIEF DESCRIPTION OF THE DRAWINGS

FIG. 1 is a lens configuration diagram according to Example 1 of an imaging optical system of the present invention.

FIG. 2 is a longitudinal aberration diagram of the imaging optical system of Example 1 at an infinite photographing distance.

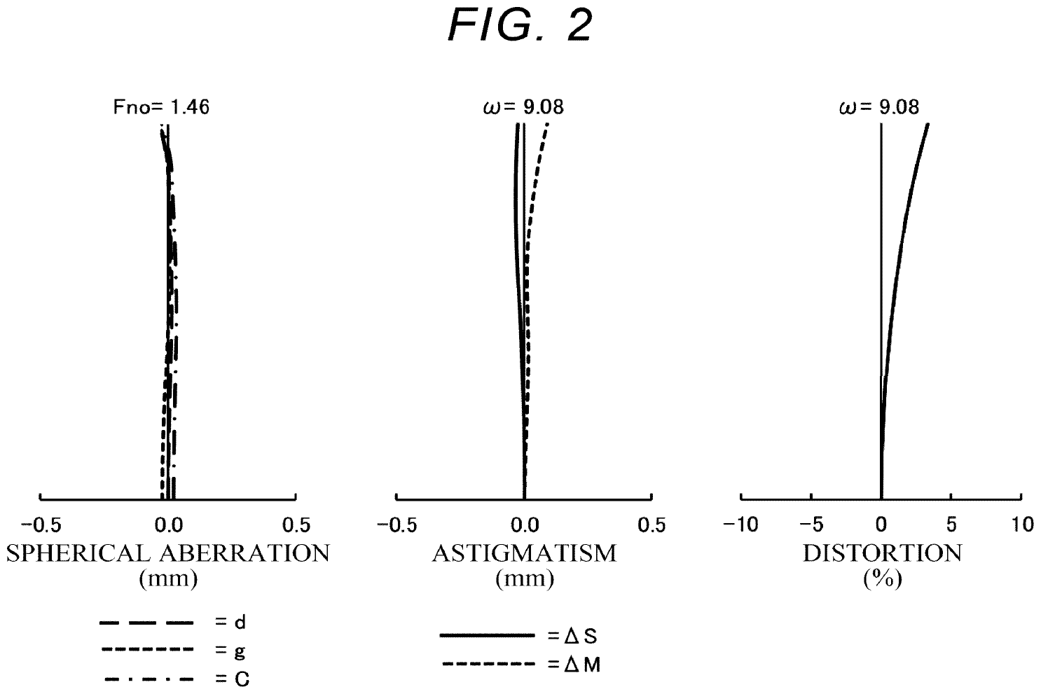

FIG. 3 is a longitudinal aberration diagram of the imaging optical system of Example 1 at a focusing distance of 2.4 m.

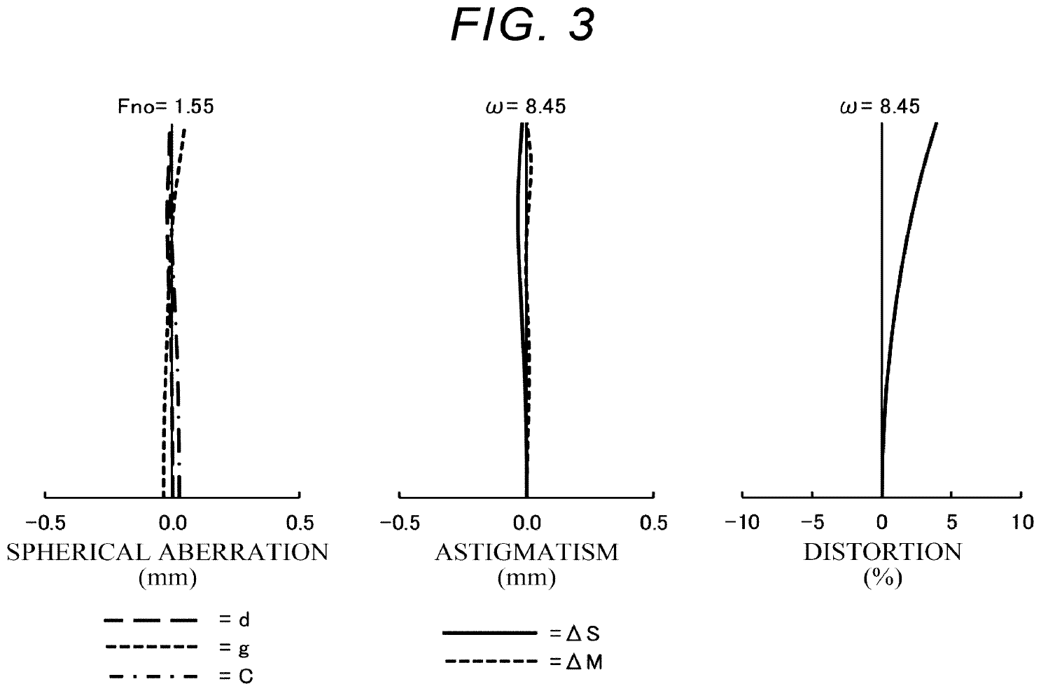

FIG. 4 is a longitudinal aberration diagram of the imaging optical system of Example 1 at a focusing distance of 1.1 m.

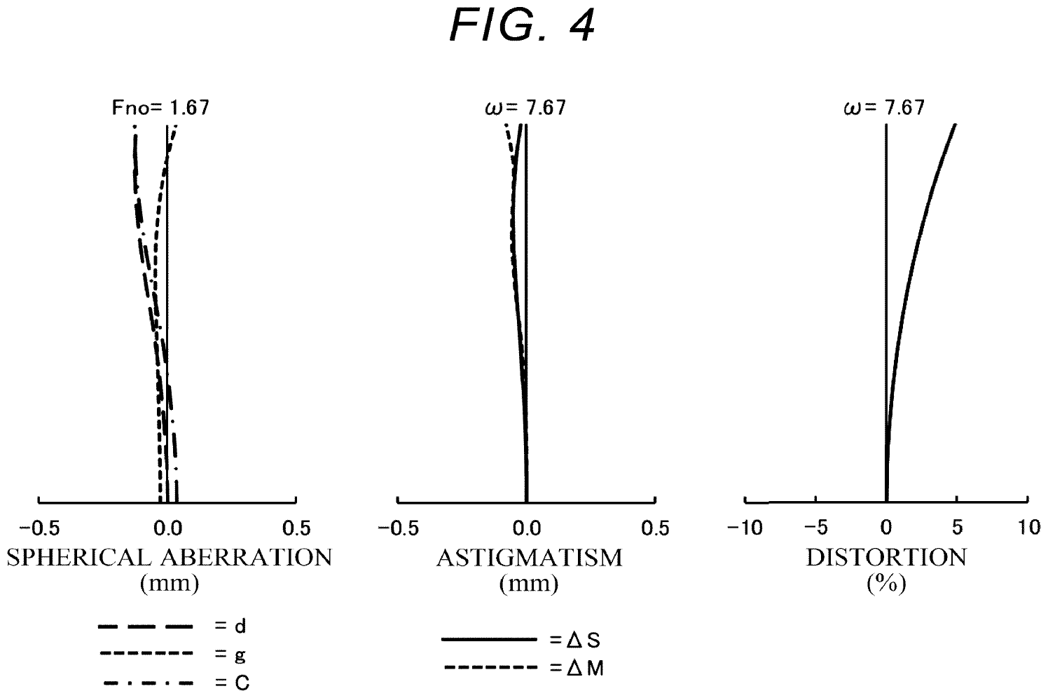

FIG. 5 is a lateral aberration diagram of the imaging optical system of. Example 1 at an infinite photographing distance.

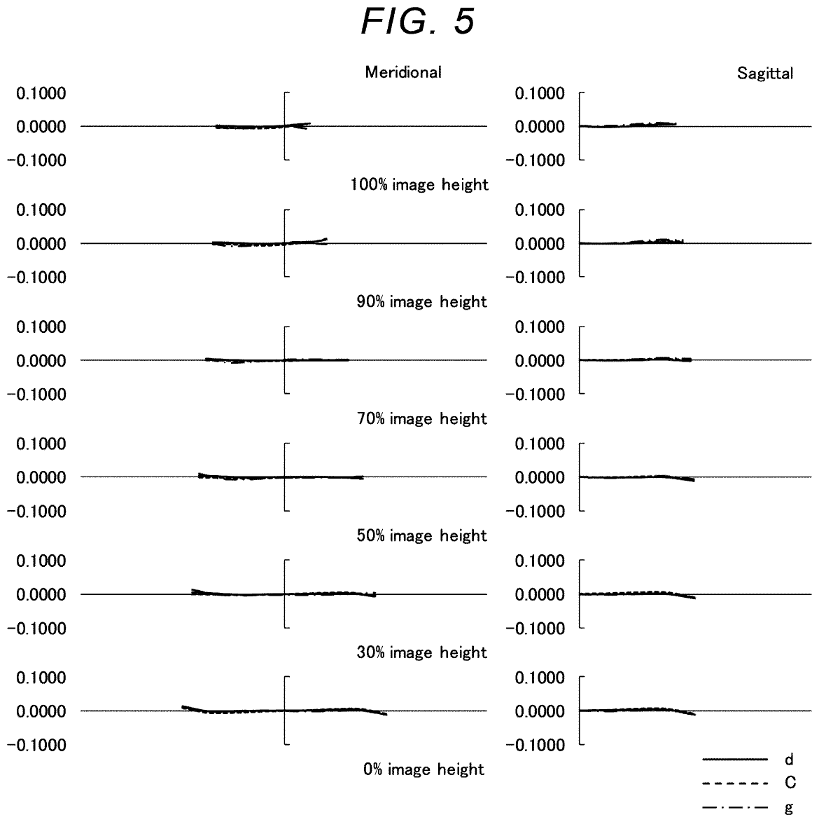

FIG. 6 is a lateral aberration diagram of the imaging optical system of Example 1 at a focusing distance of 2.4 m.

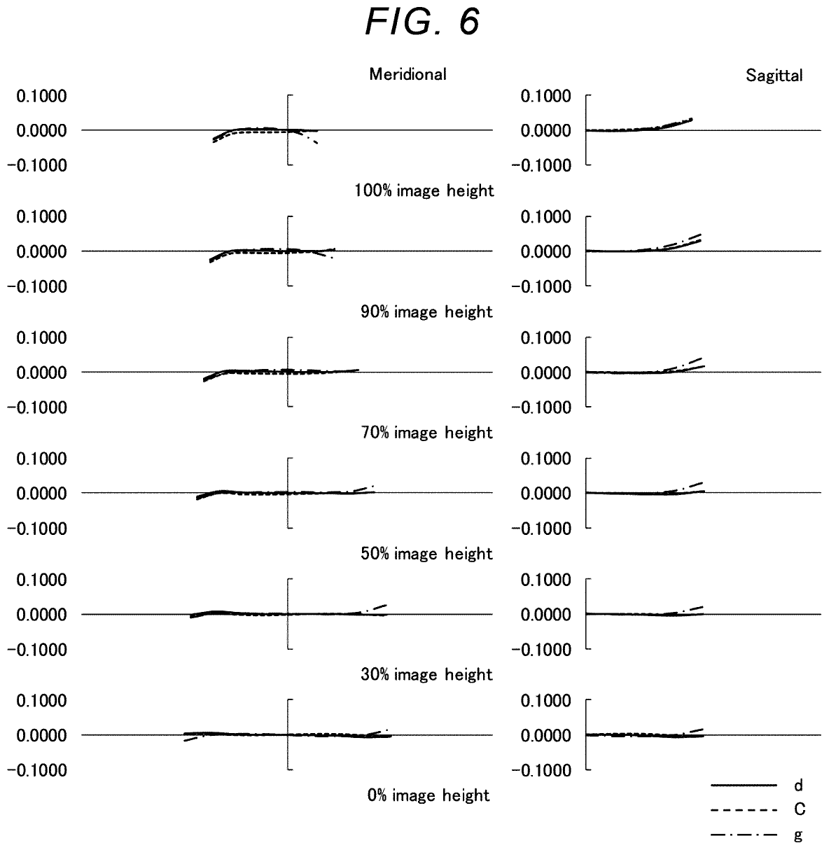

FIG. 7 is a lateral aberration diagram of the imaging optical system of Example 1 at a focusing distance of 1.1 m.

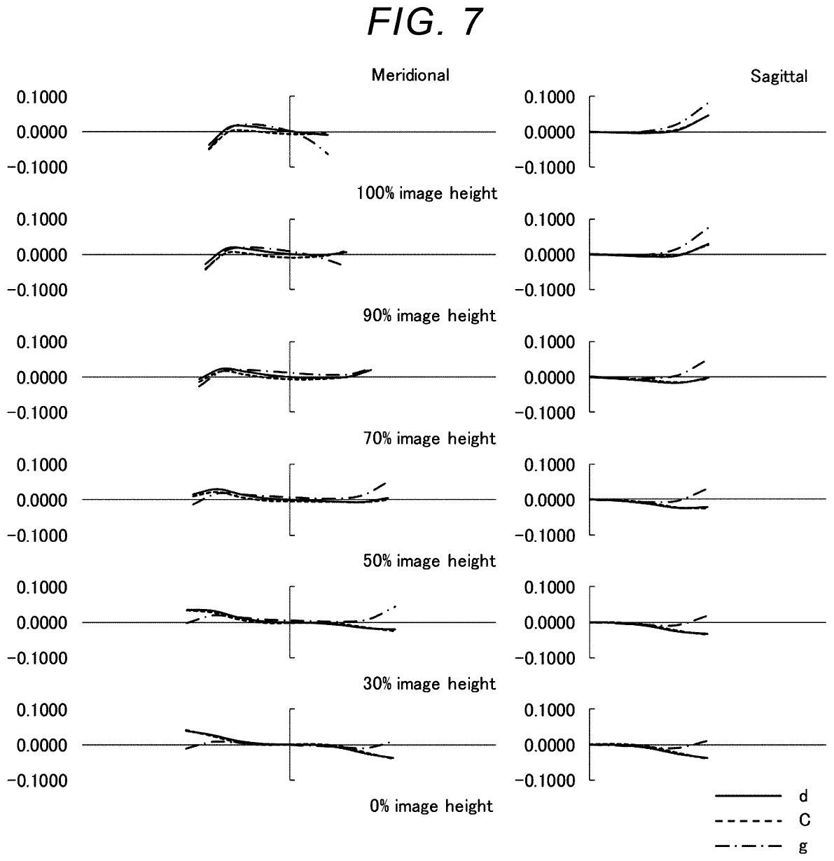

FIG. 8 is a lens configuration diagram according to Example 2 of an imaging optical system of the present invention.

FIG. 9 is a longitudinal aberration diagram of the imaging optical system of Example 2 at an infinite photographing distance.

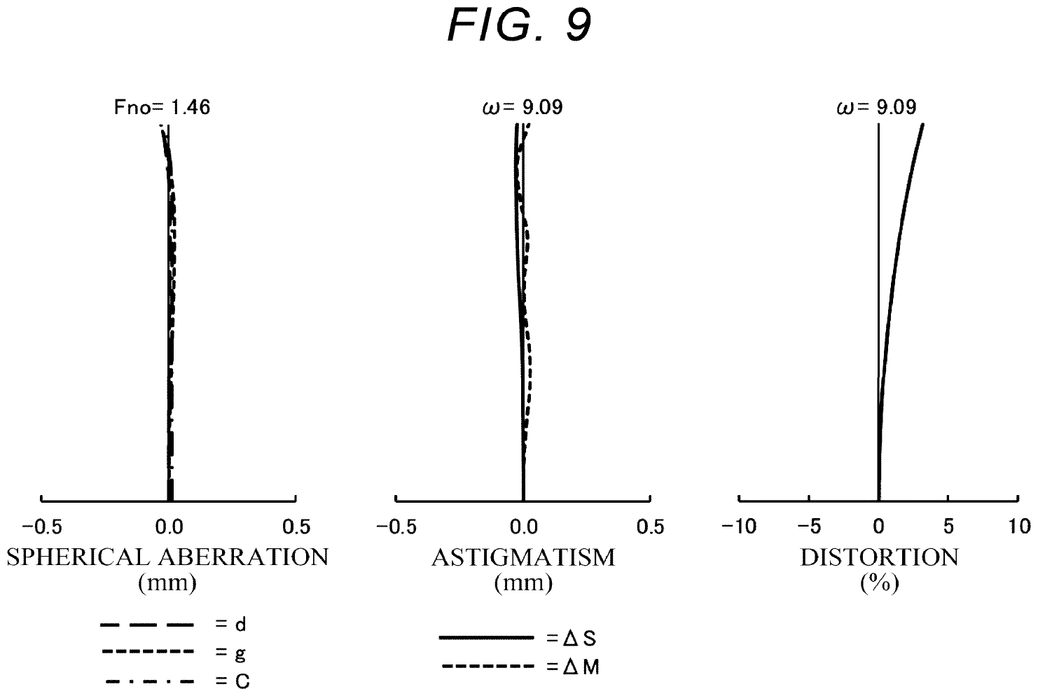

FIG. 10 is a longitudinal aberration diagram of the imaging optical system of Example 2 at a focusing distance of 2.4 m.

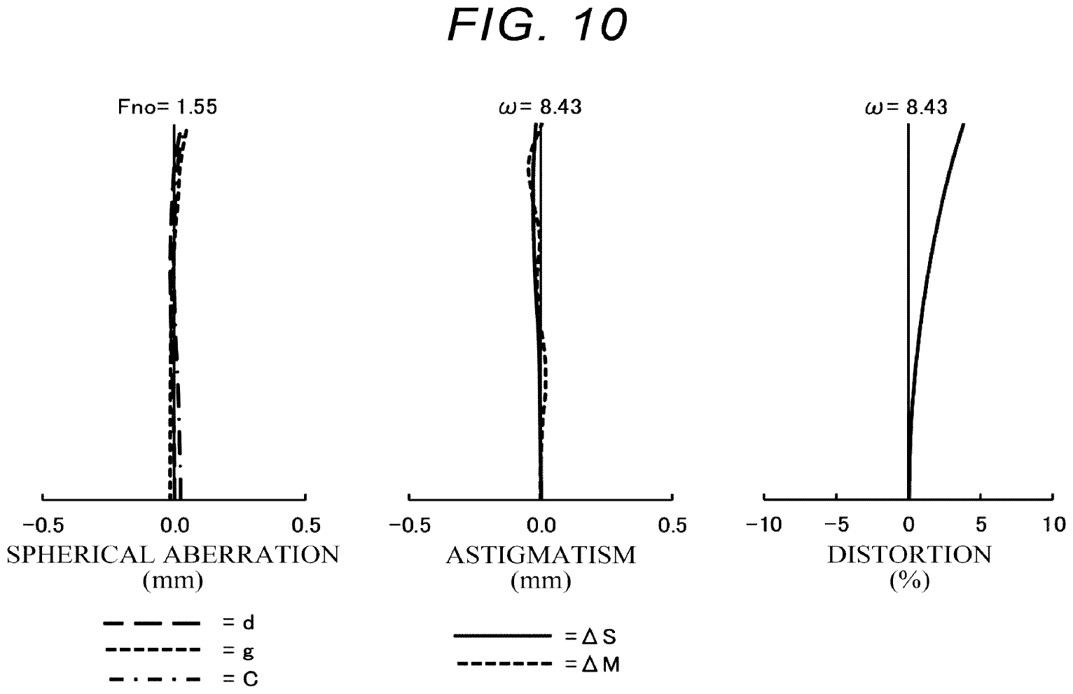

FIG. 11 is a longitudinal aberration diagram of the imaging optical system of Example 2 at a focusing distance of 1.1 m.

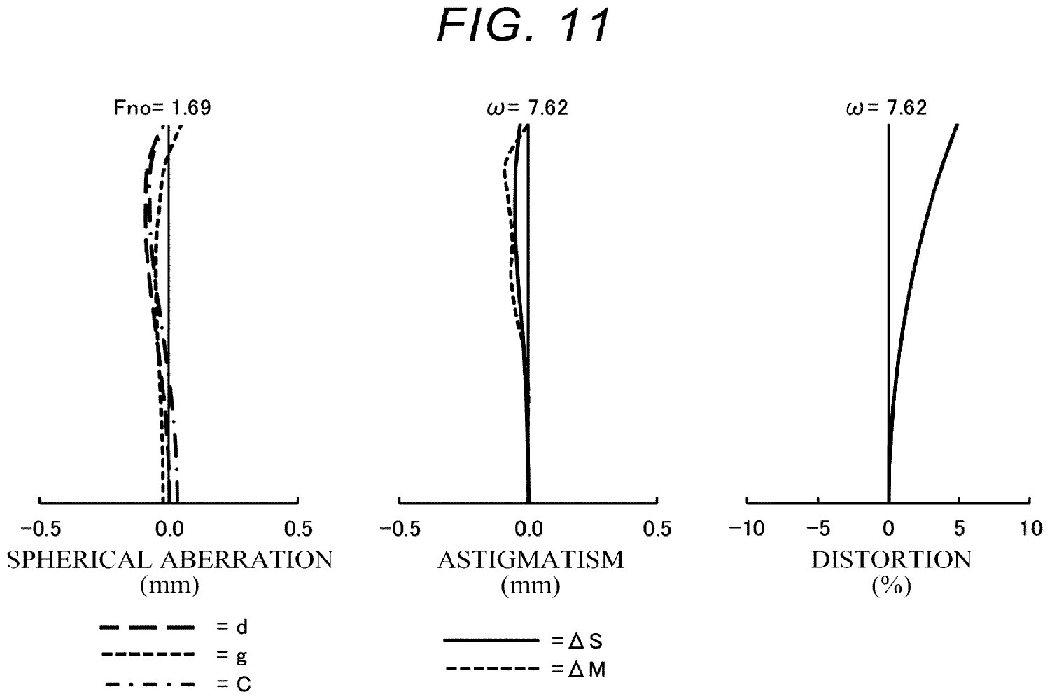

FIG. 12 is a lateral aberration diagram of the imaging optical system of Example 2 at an infinite photographing distance.

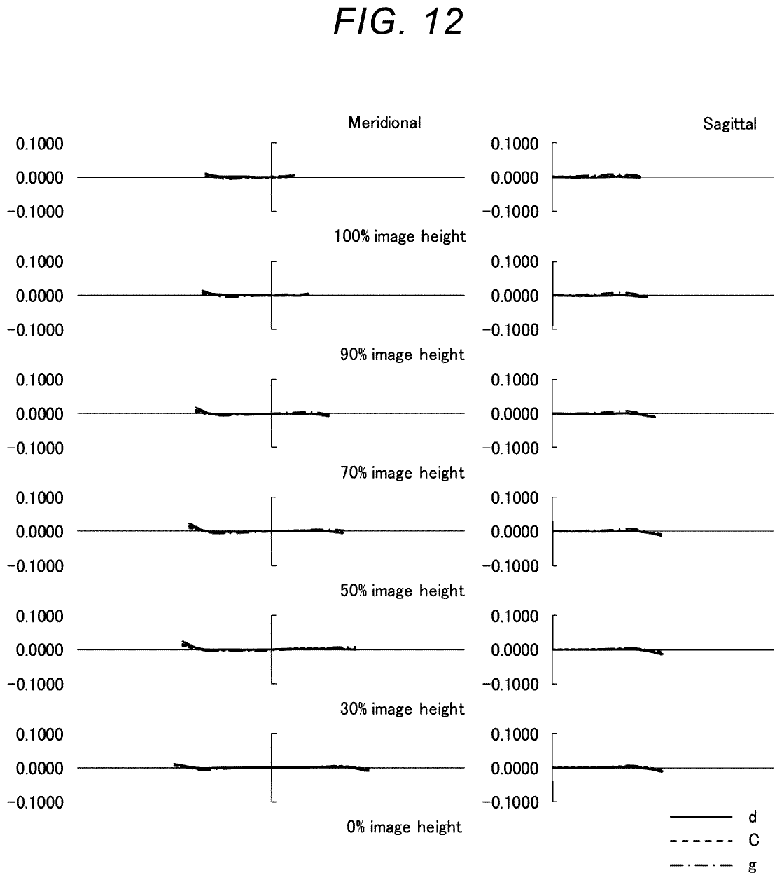

FIG. 13 is a lateral aberration diagram of the imaging optical system of Example 2 at a focusing distance of 2.4 m.

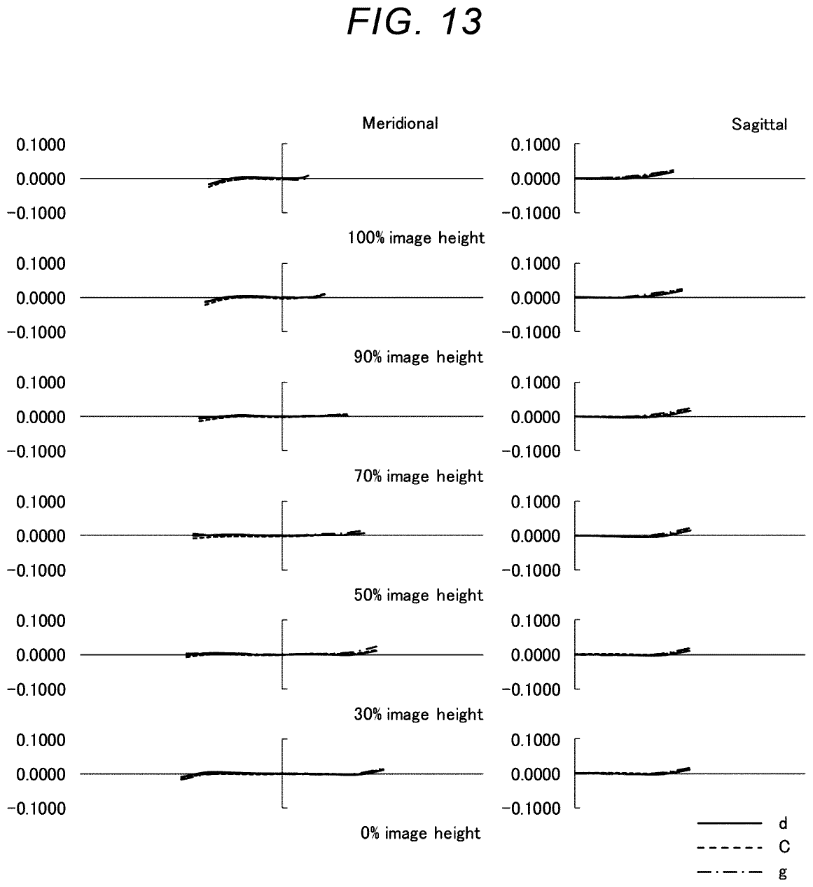

FIG. 14 is a lateral aberration diagram of the imaging optical system of Example 2 at a focusing distance of 1.1 m.

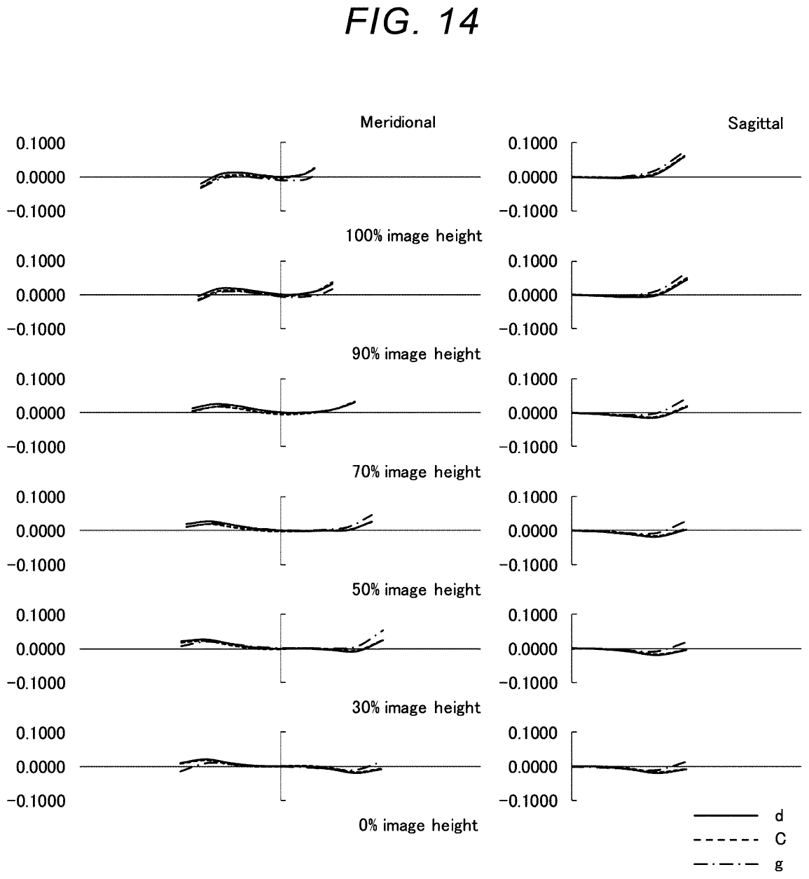

FIG. 15 is a lens configuration diagram according to Example 3 of an imaging optical system of the present invention.

FIG. 16 is a longitudinal aberration diagram of the imaging optical system of Example 3 at an infinite photographing distance.

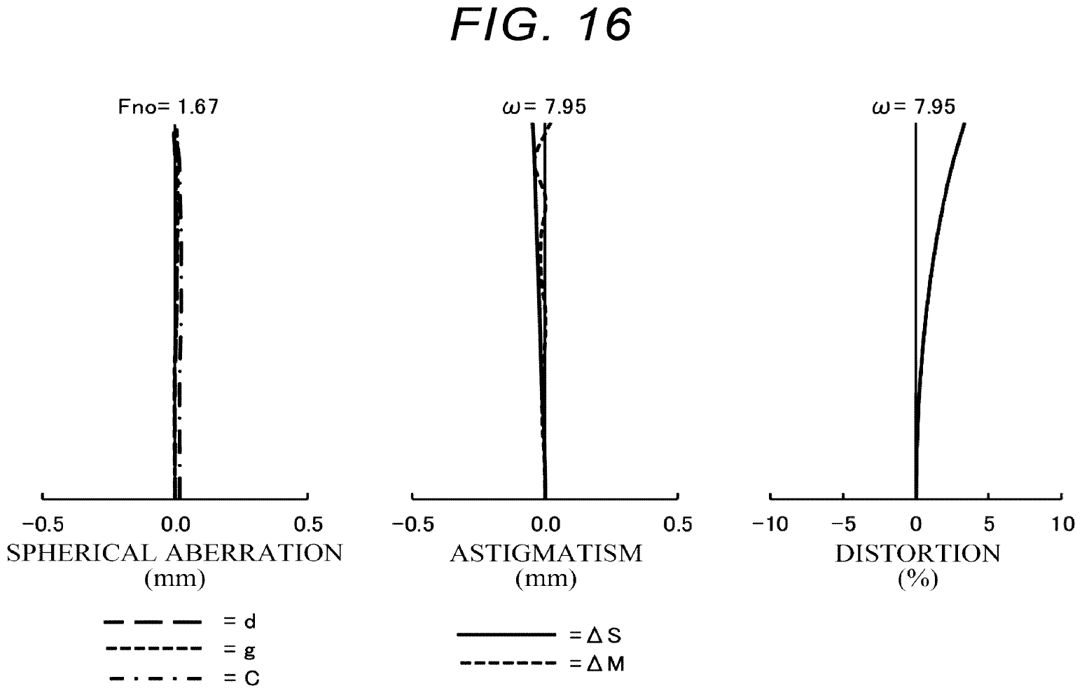

FIG. 17 is a longitudinal aberration diagram of the imaging optical system of Example 3 at a focusing distance of 2.6 m.

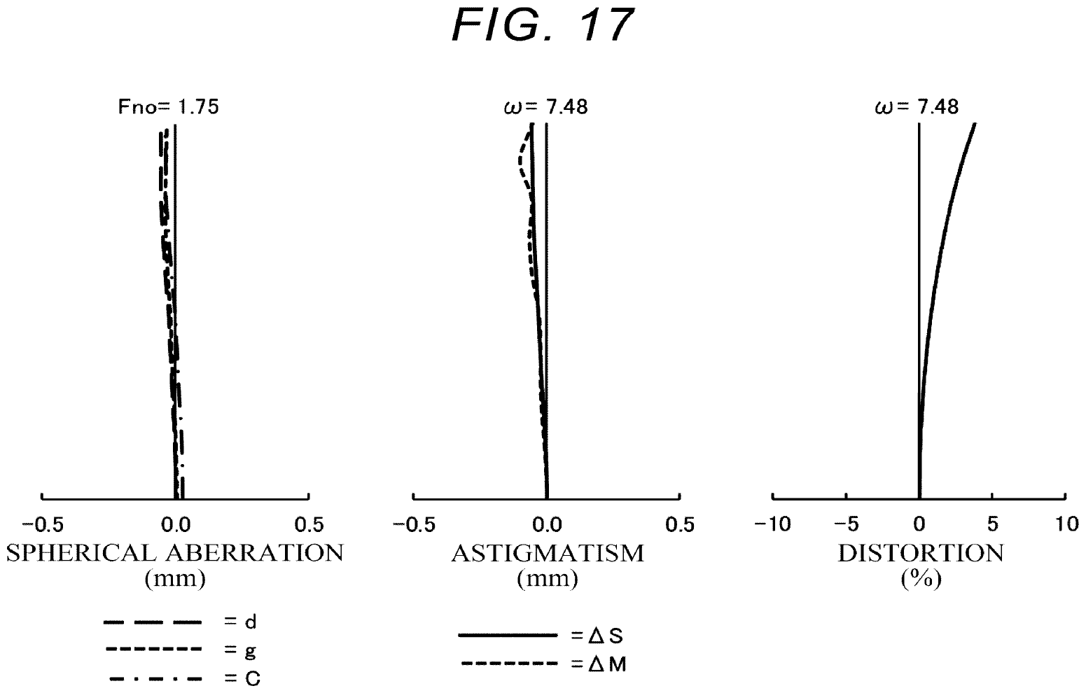

FIG. 18 is a longitudinal aberration diagram of the imaging optical system of Example 3 at a focusing distance of 1.3 m.

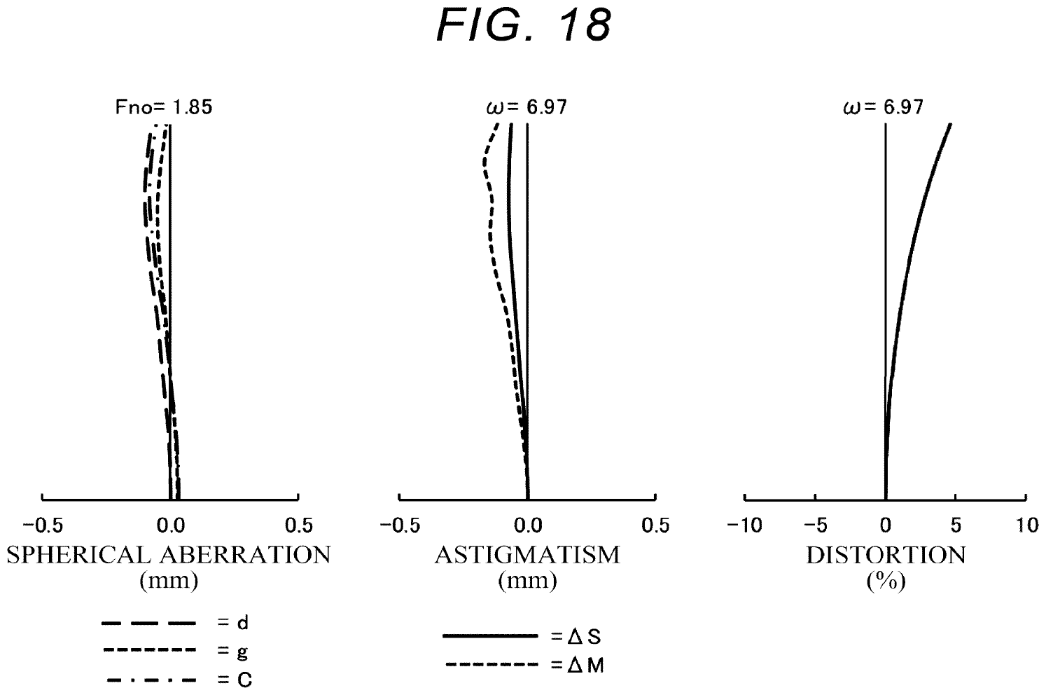

FIG. 19 is a lateral aberration diagram of the imaging optical system of Example 3 at an infinite photographing distance.

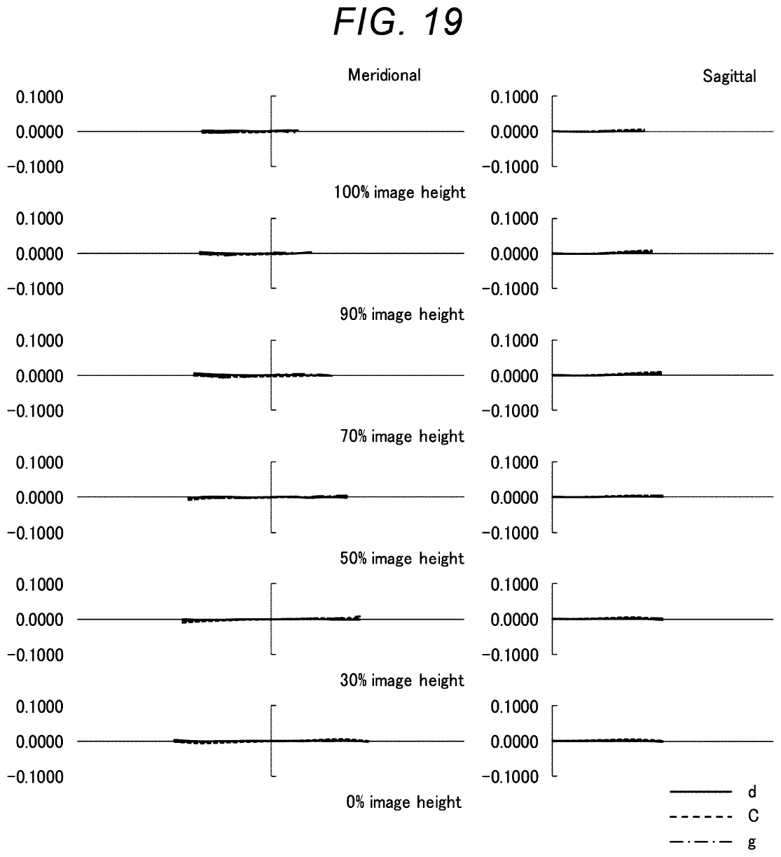

FIG. 20 is a lateral aberration diagram of the imaging optical system of Example 3 at a focusing distance of 2.6 m.

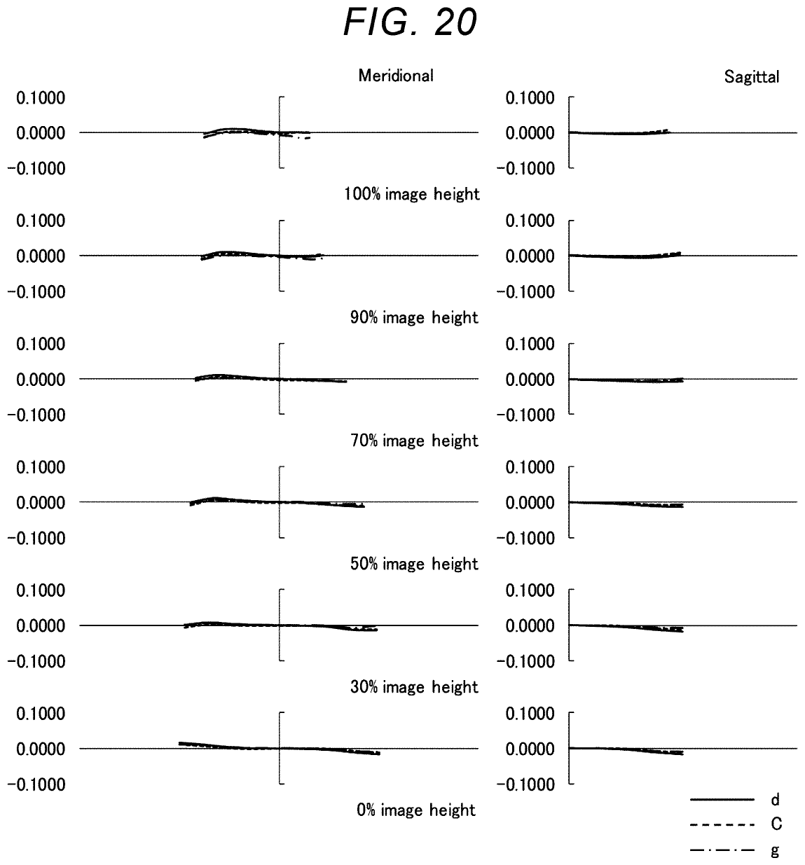

FIG. 21 is a lateral aberration diagram of the imaging optical system of Example 3 at a focusing distance of 1.3 m.

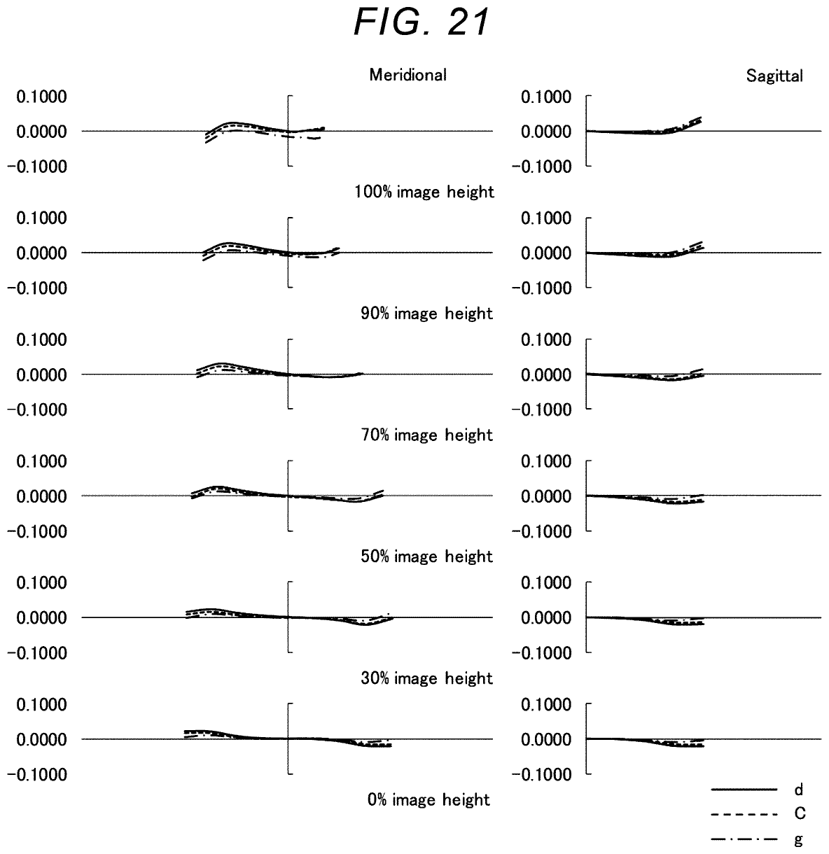

FIG. 22 is a lens configuration diagram according to Example 4 of an imaging optical system of the present invention.

FIG. 23 is a longitudinal aberration diagram of the imaging optical system of Example 4 at an infinite photographing distance.

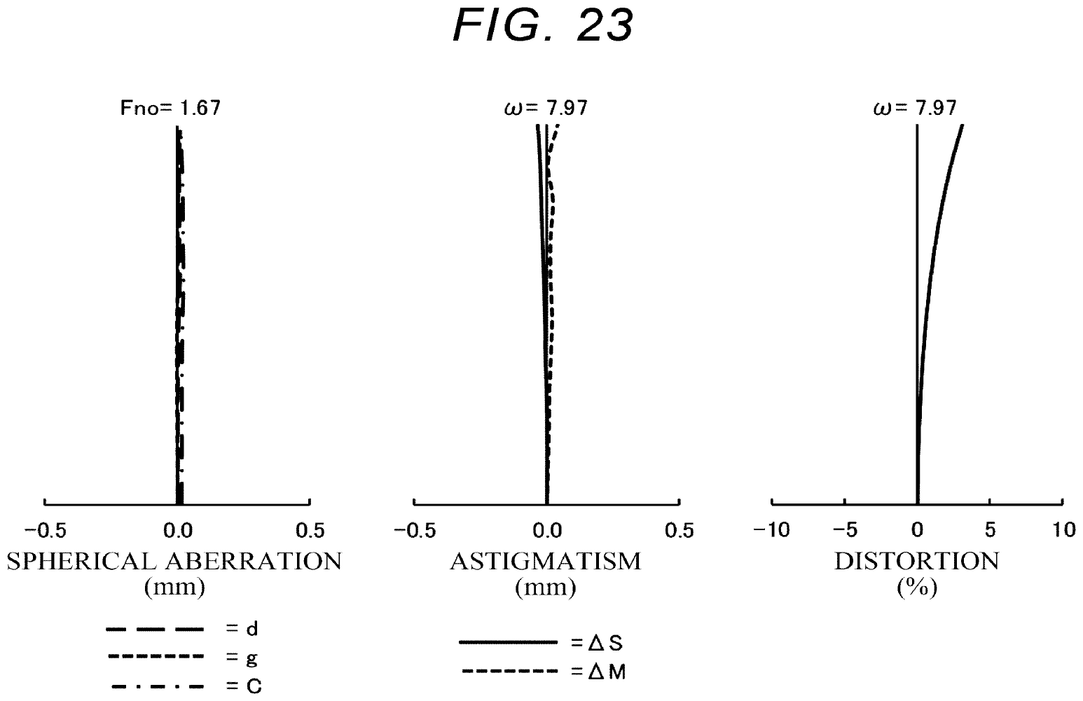

FIG. 24 is a longitudinal aberration diagram of the imaging optical system of Example 4 at a focusing distance of 2.6 m.

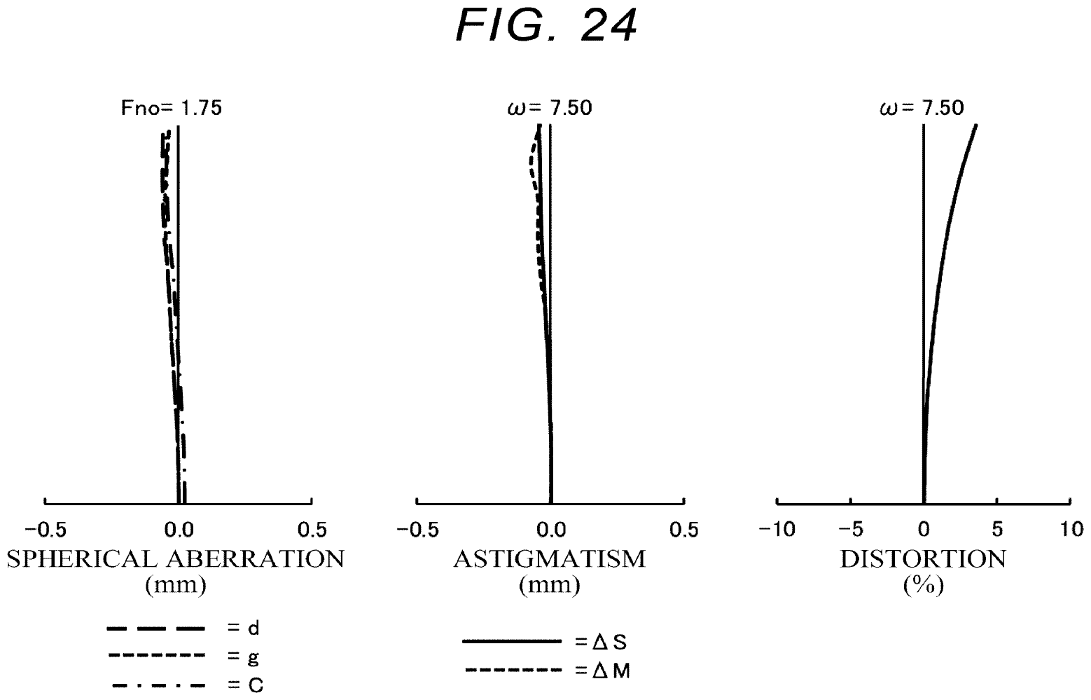

FIG. 25 is a longitudinal aberration diagram of the imaging optical system of Example 4 at a focusing distance of 1.3 m.

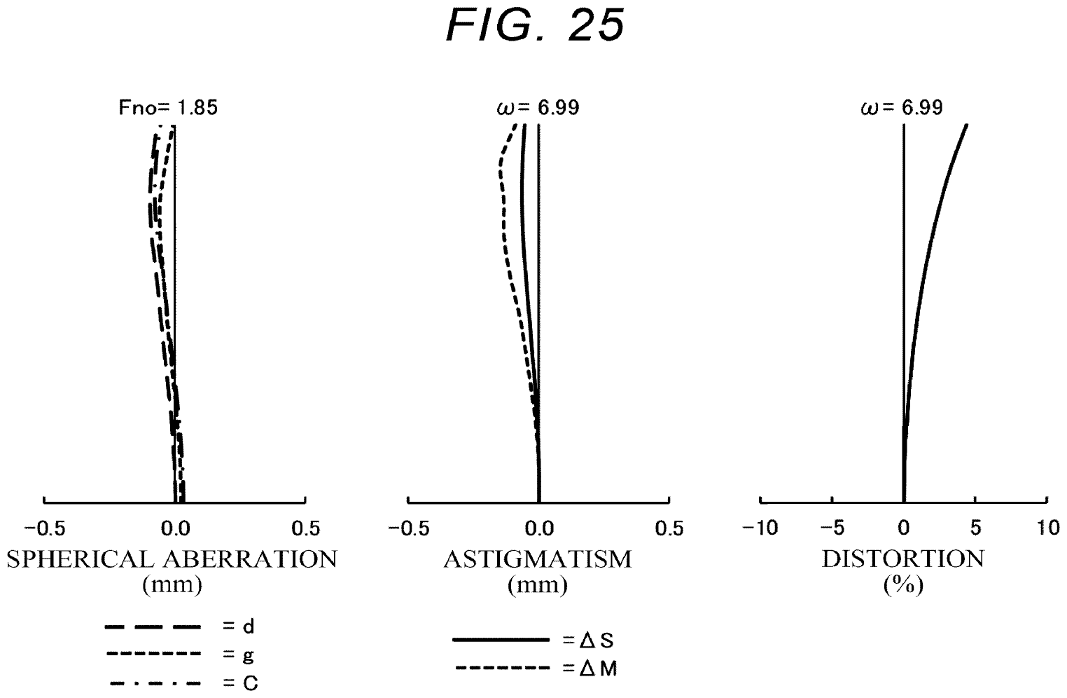

FIG. 26 is a lateral aberration diagram of the imaging optical system of Example 4 at an infinite photographing distance.

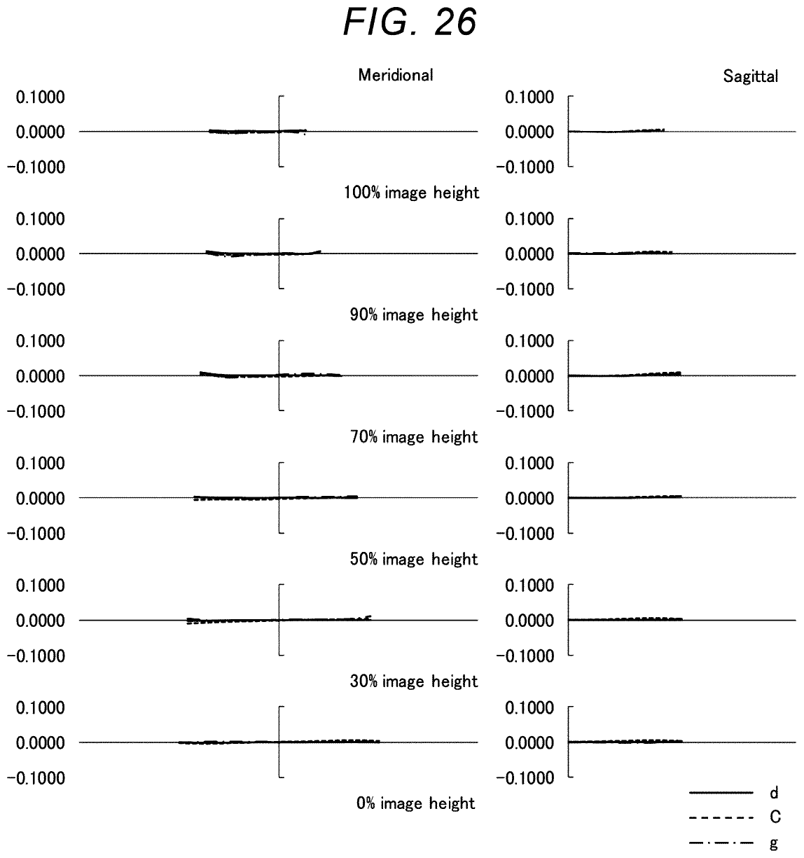

FIG. 27 is a lateral aberration diagram of the imaging optical system of Example 4 at a focusing distance of 2.6 m.

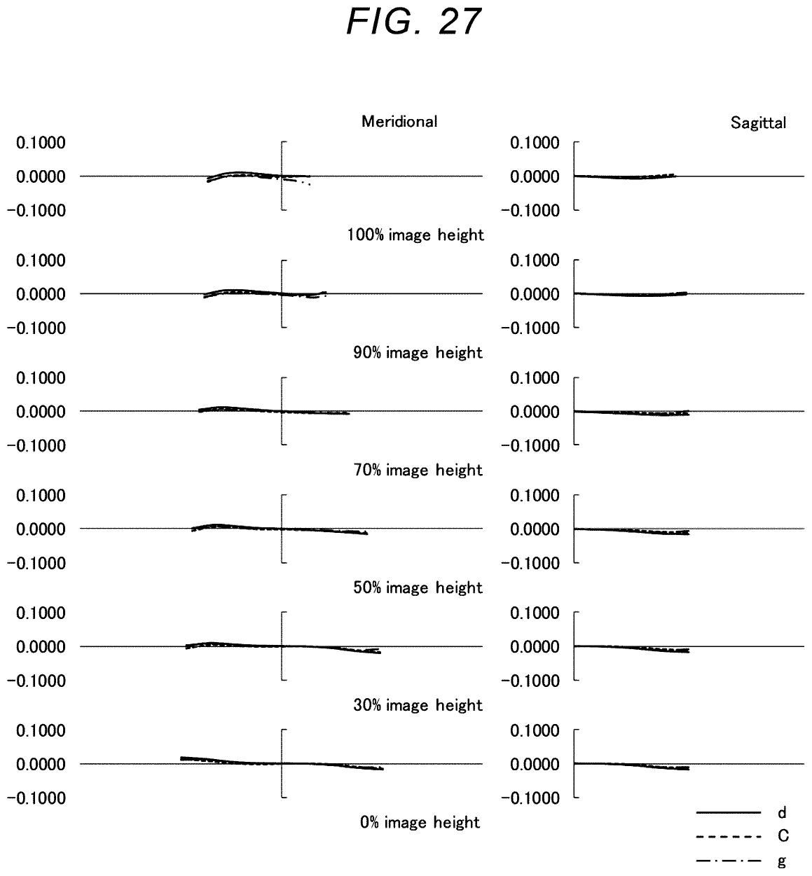

FIG. 28 is a lateral aberration diagram of the imaging optical system of Example 4 at a focusing distance of 1.3 m.

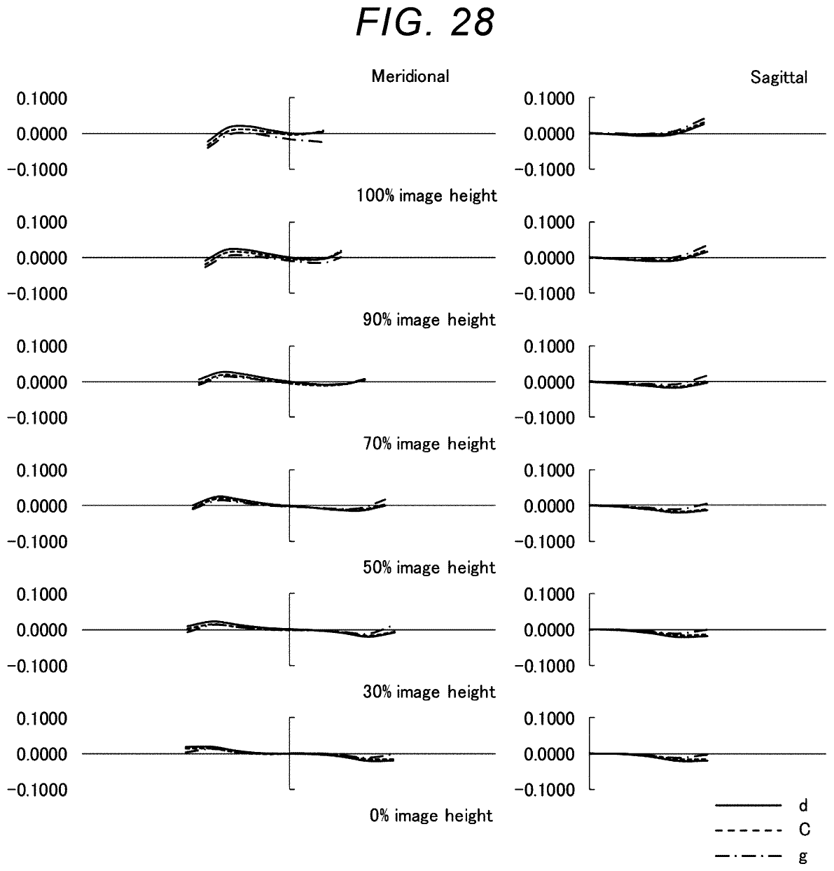

FIG. 29 is a lens configuration diagram according to Example 5 of an imaging optical system of the present invention.

FIG. 30 is a longitudinal aberration diagram of the imaging optical system of Example 5 at an infinite photographing distance.

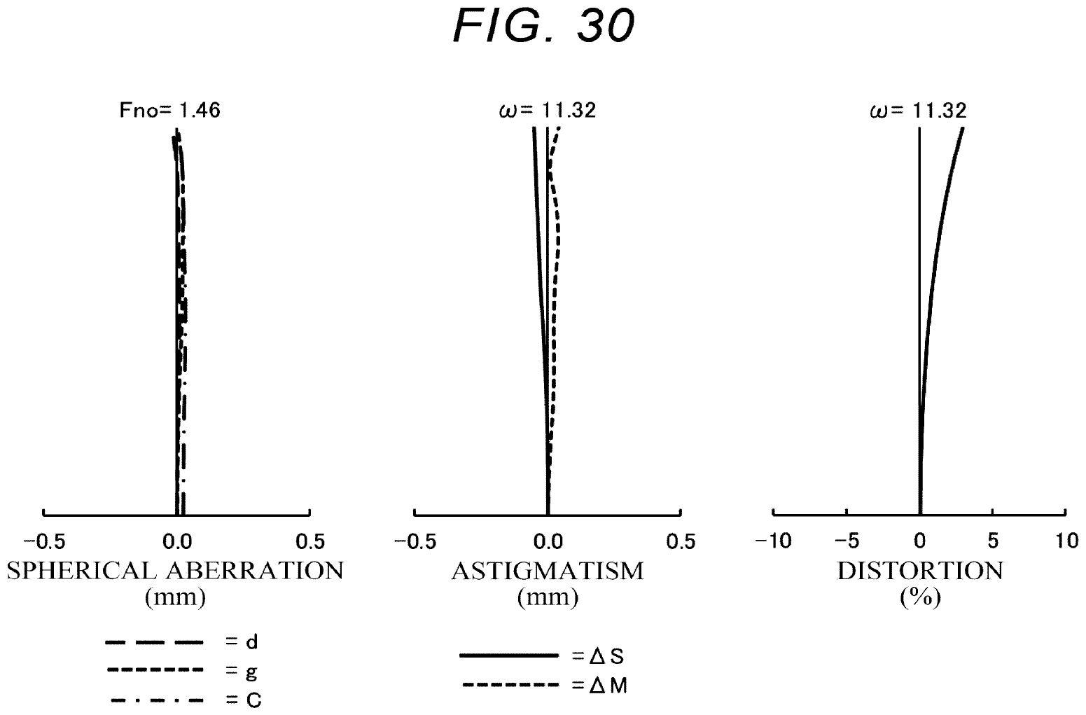

FIG. 31 is a longitudinal aberration diagram of the imaging optical system of Example 5 at a focusing distance of 2.4 m.

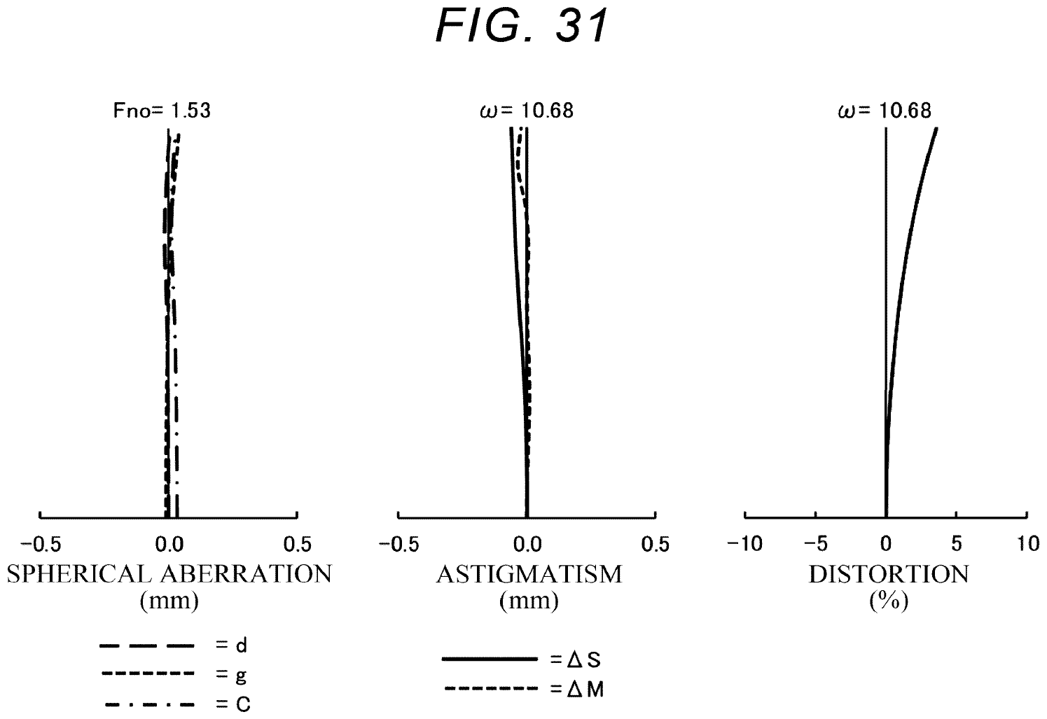

FIG. 32 is a longitudinal aberration diagram of the imaging optical system of Example 5 at a focusing distance of 1.0 m.

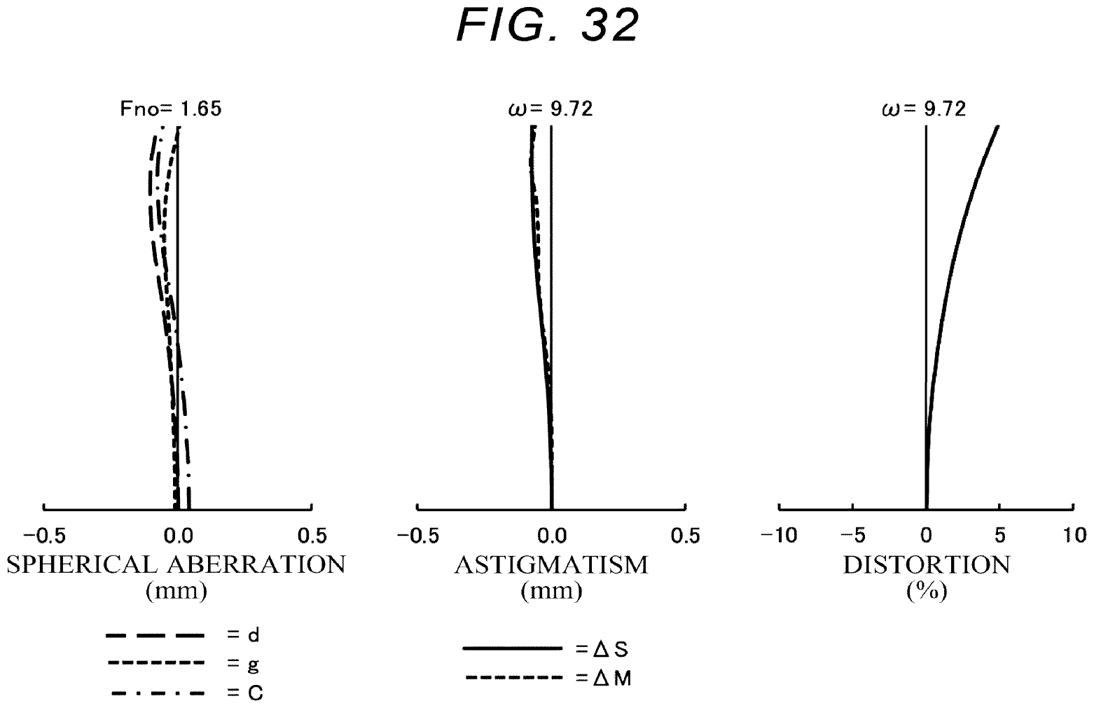

FIG. 33 is a lateral aberration diagram of the imaging optical system of Example 5 at an infinite photographing distance.

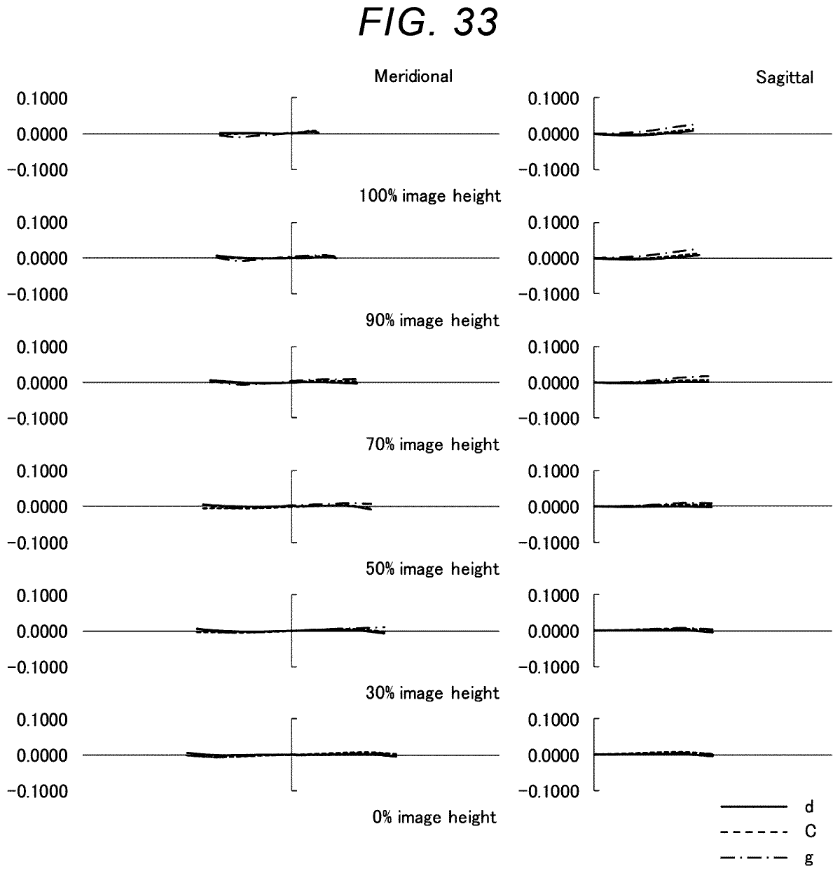

FIG. 34 is a lateral aberration diagram of the imaging optical system of Example 5 at a focusing distance of 2.4 m.

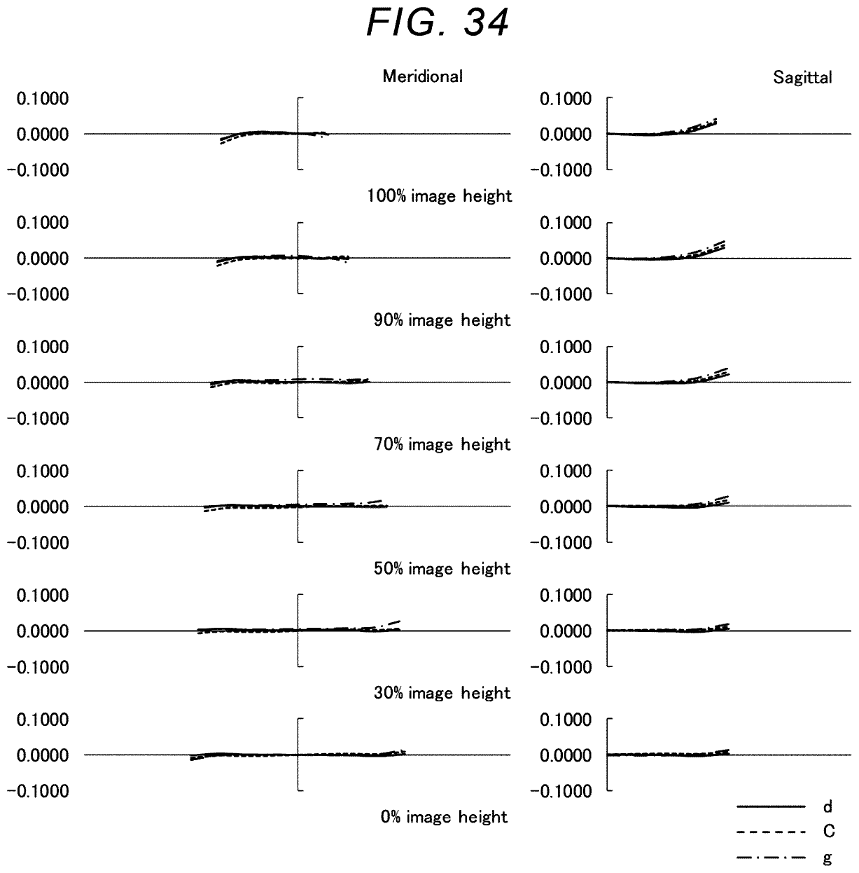

FIG. 35 is a lateral aberration diagram of the imaging optical system of Example 5 at a focusing distance of 1.0 m.

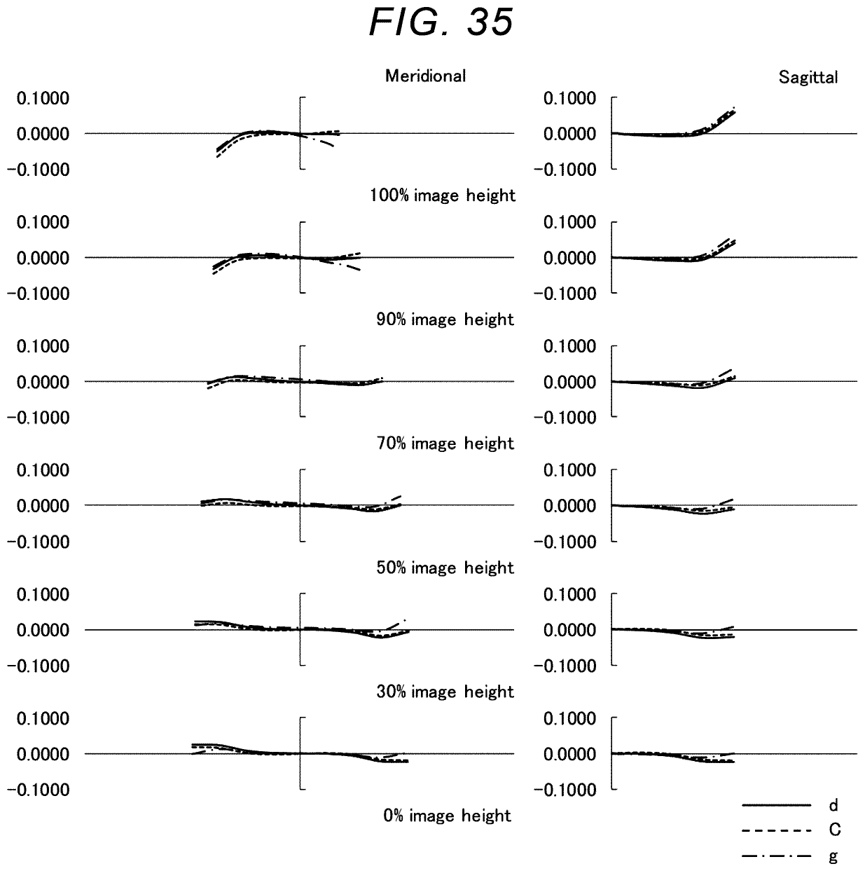

FIG. 36 is a lens configuration diagram according to Example 6 of an imaging optical system of the present invention.

FIG. 37 is a longitudinal aberration diagram of the imaging optical system of Example 6 at an infinite photographing distance.

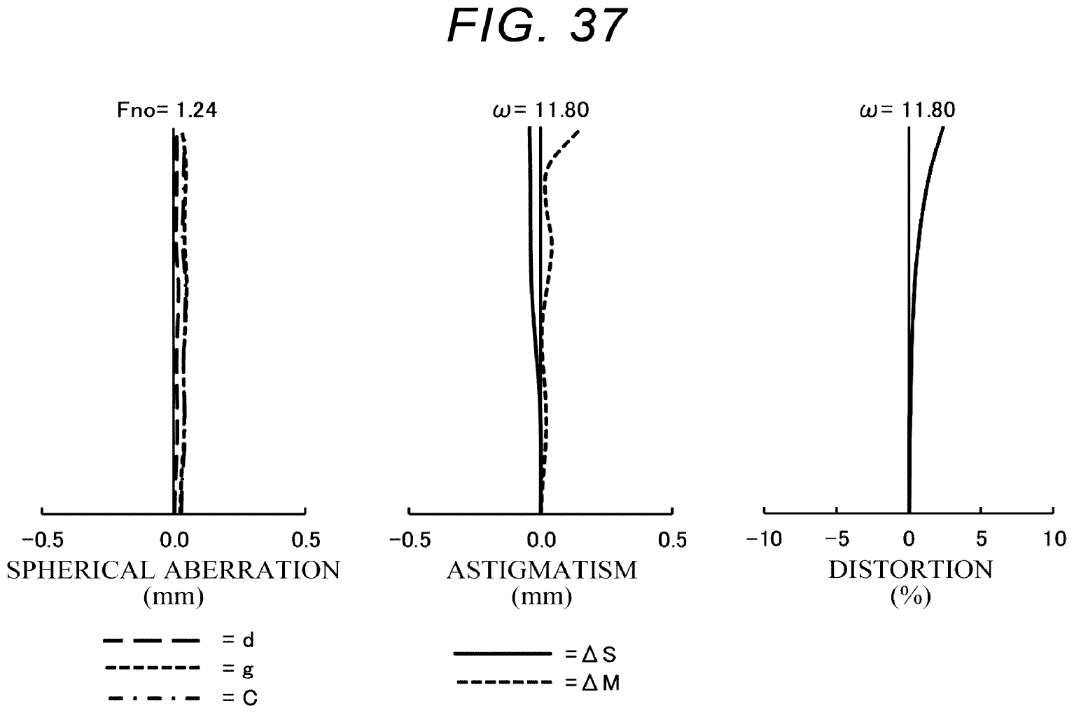

FIG. 38 is a longitudinal aberration diagram of the imaging optical system of Example 6 at a focusing distance of 2.0 m.

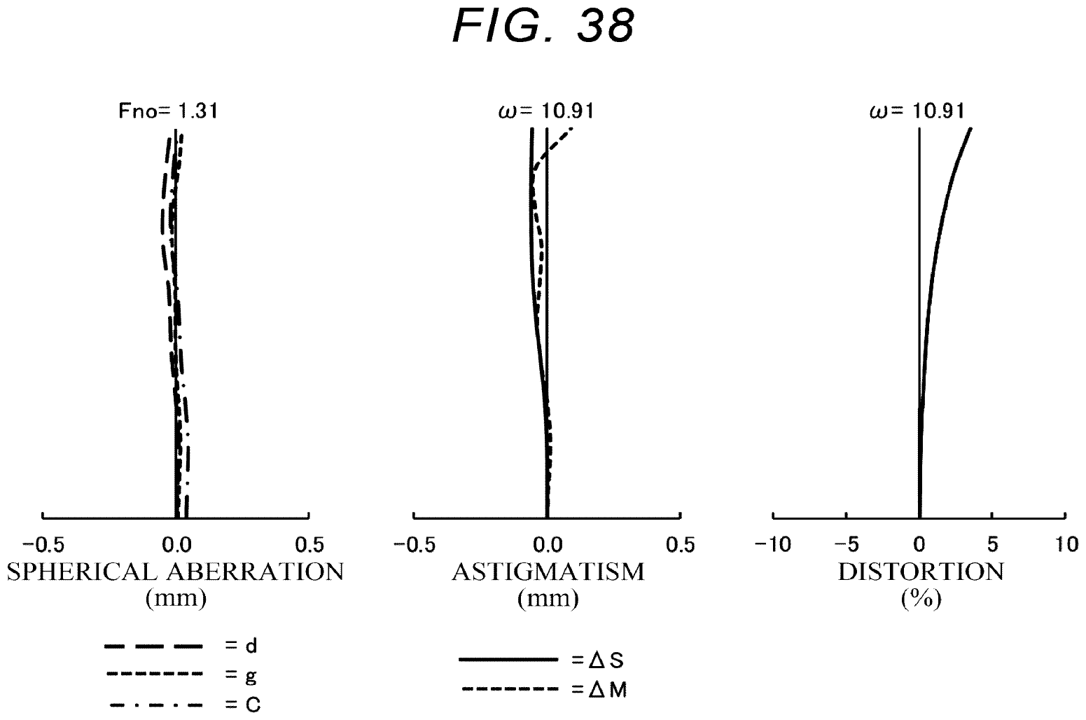

FIG. 39 is a longitudinal aberration diagram of the imaging optical system of Example 6 at a focusing distance of 1.1 m.

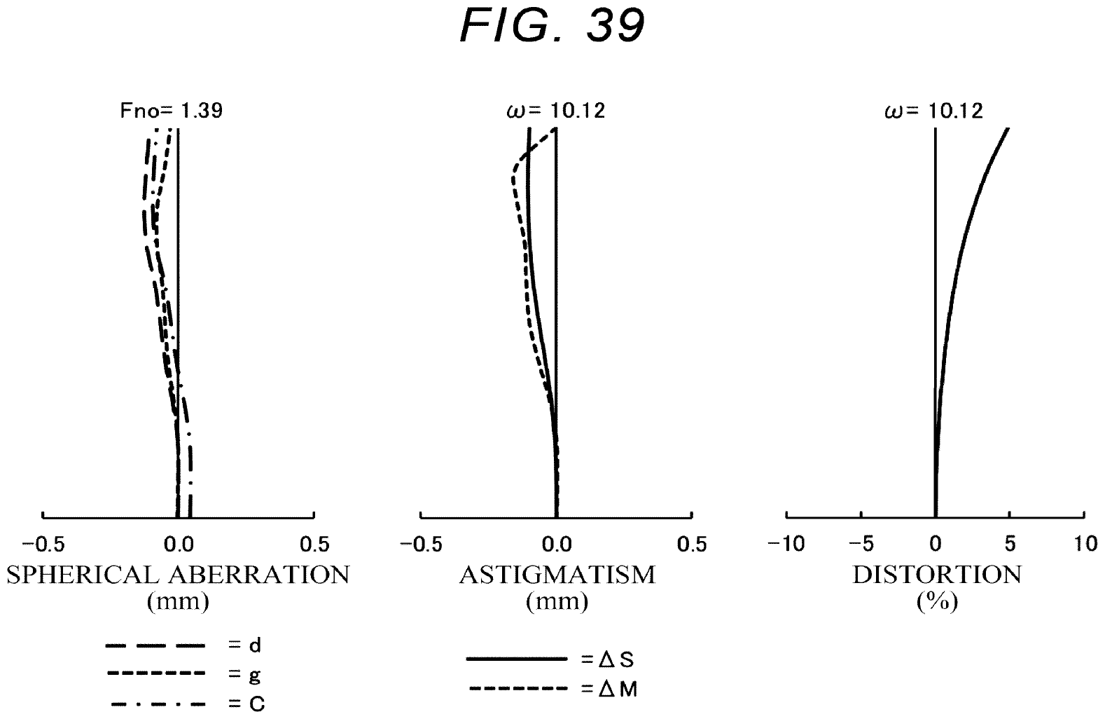

FIG. 40 is a lateral aberration diagram of the imaging optical system of Example 6 at an infinite photographing distance.

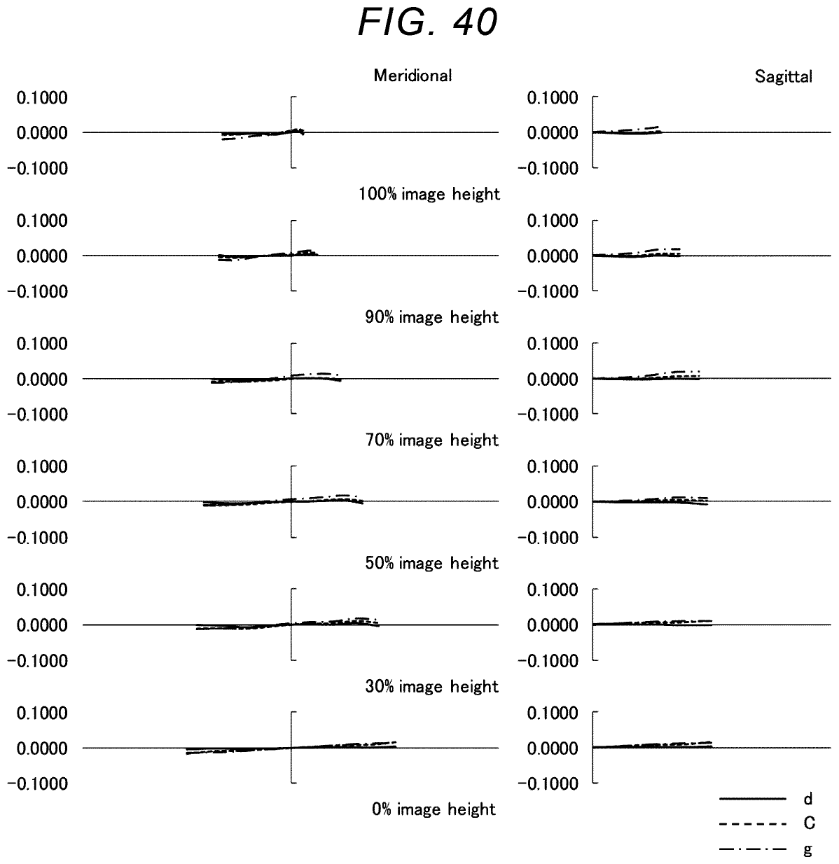

FIG. 41 is a lateral aberration diagram of the imaging optical system of Example 6 at a focusing distance of 2.0 m.

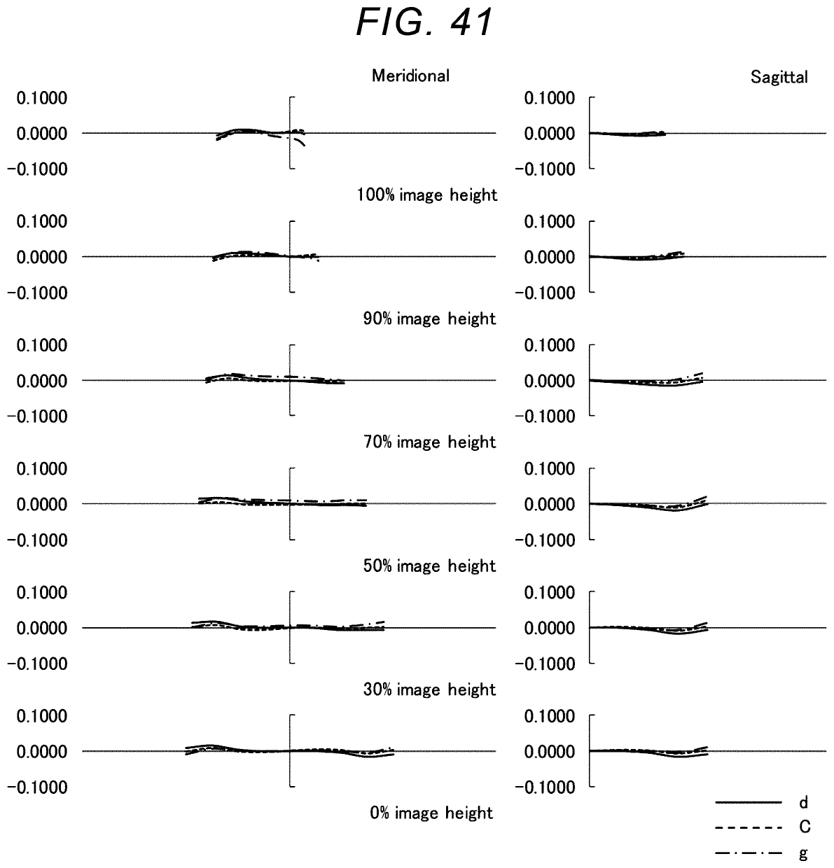

FIG. 42 is a lateral aberration diagram of the imaging optical system of Example 6 at a focusing distance of 1.1 m.

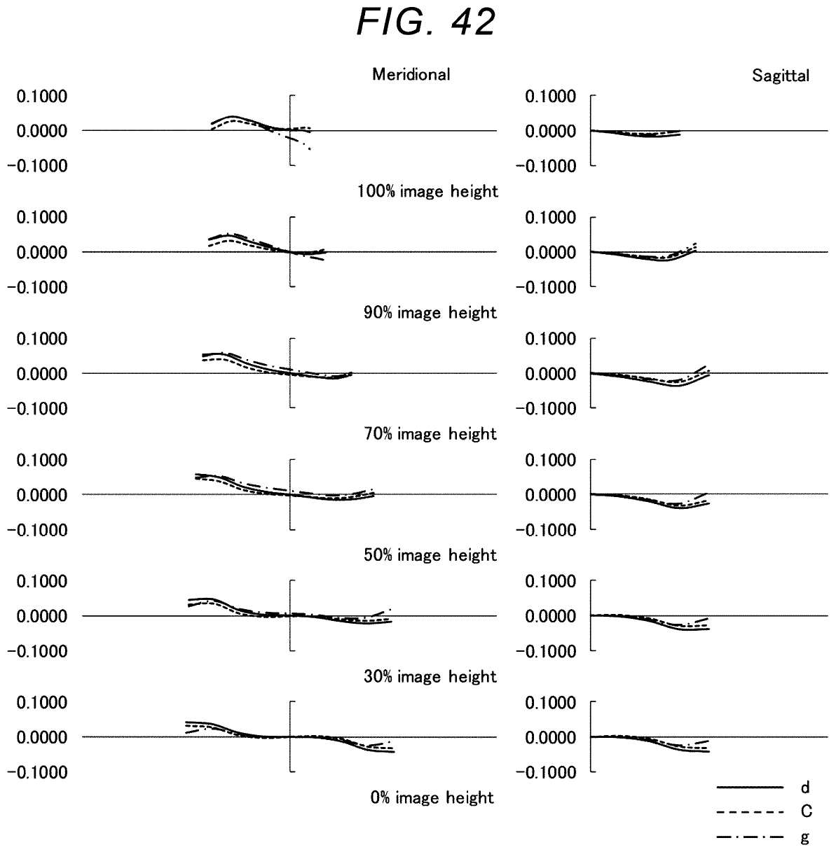

FIG. 43 is a lens configuration diagram according to Example 7 of an imaging optical system of the present invention.

FIG. 44 is a longitudinal aberration diagram of the imaging optical system of Example 7 at an infinite photographing distance.

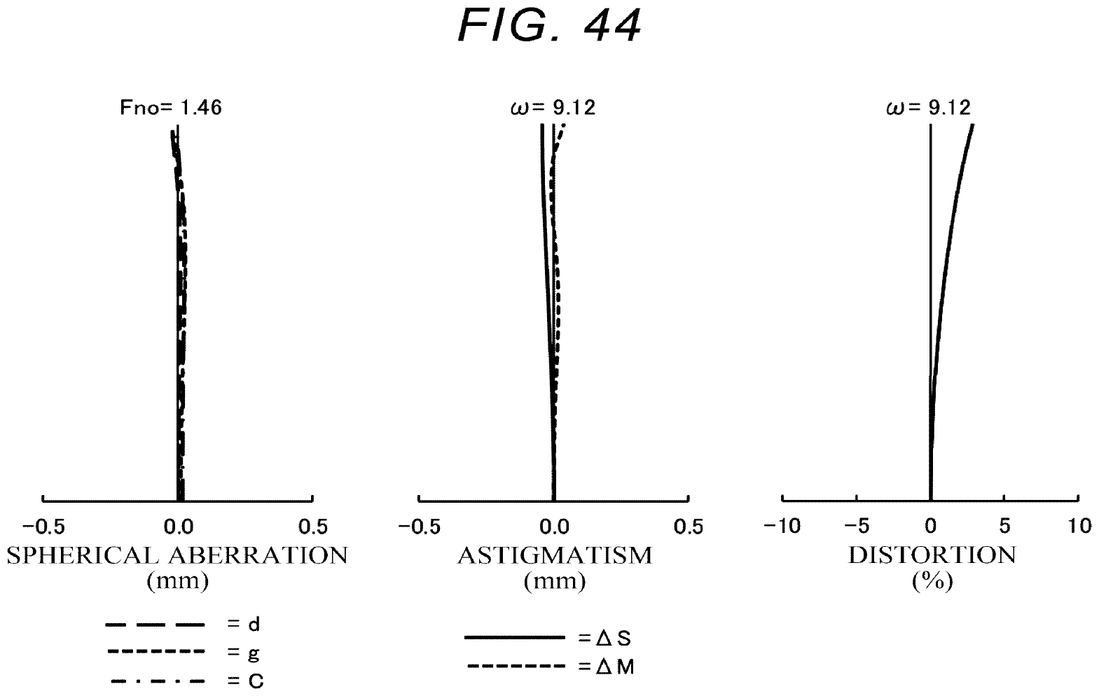

FIG. 45 is a longitudinal aberration diagram of the imaging optical system of Example 7 at a focusing distance of 2.4 m.

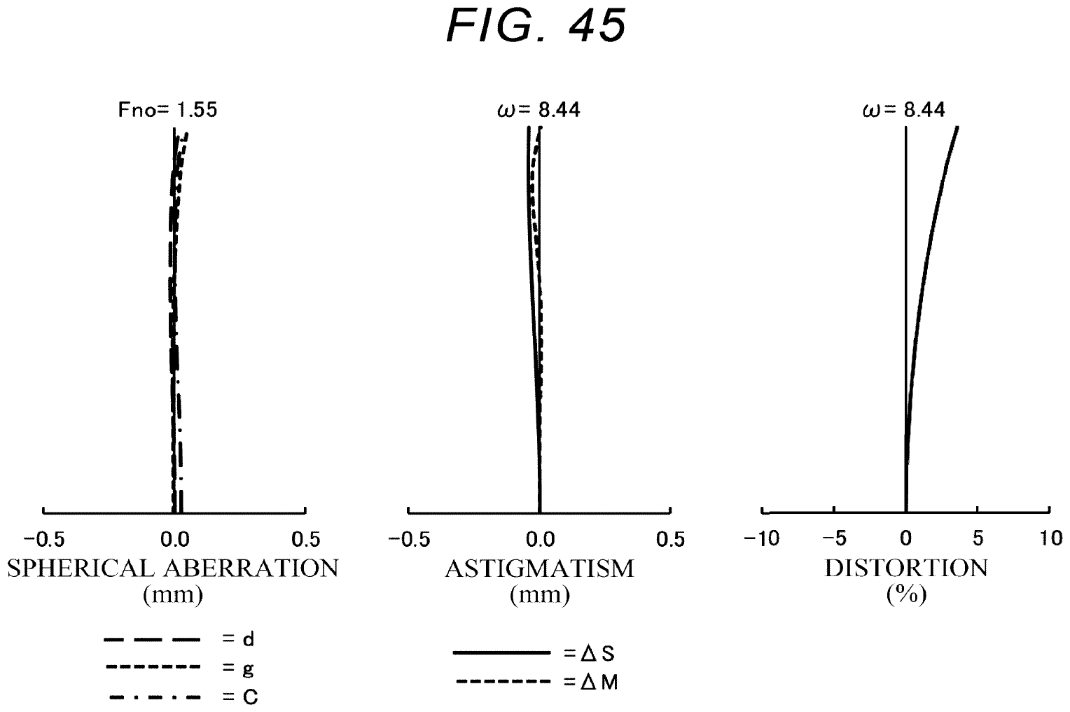

FIG. 46 is a longitudinal aberration diagram of the imaging optical system of Example 7 at a focusing distance of 1.1 m.

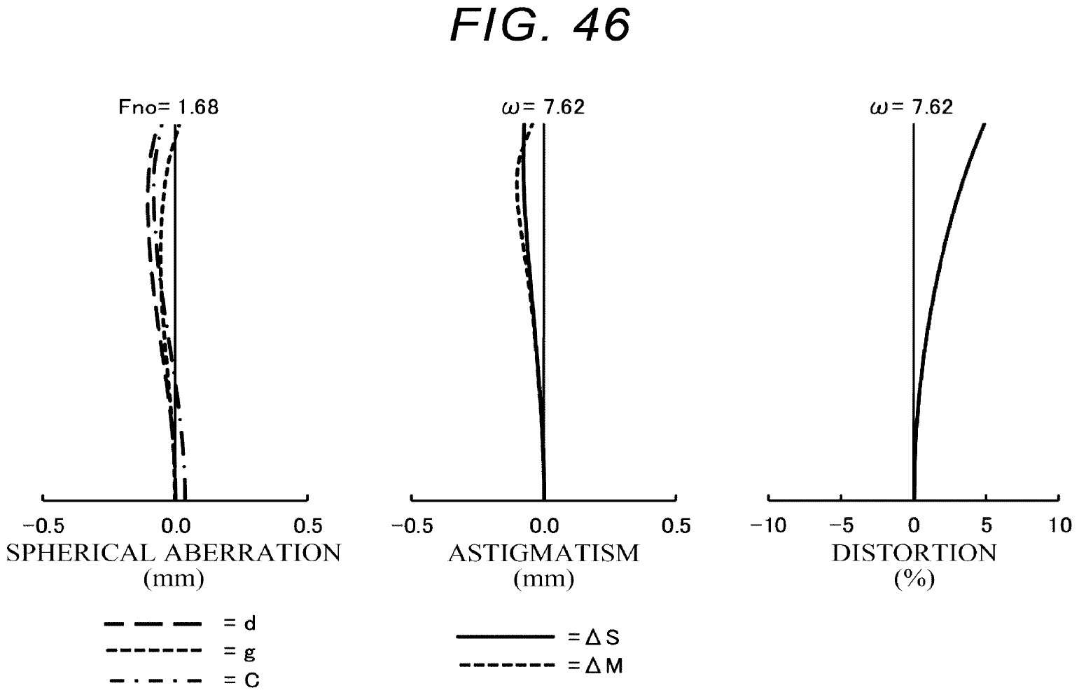

FIG. 47 is a lateral aberration diagram of the imaging optical system of Example 7 at an infinite photographing distance.

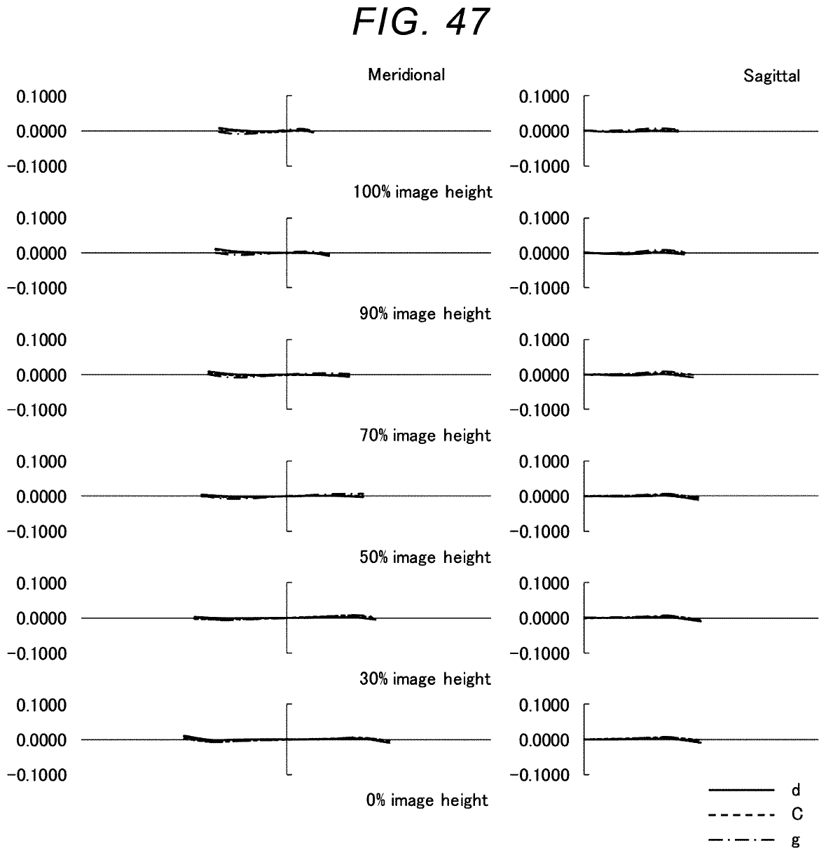

FIG. 48 is a lateral aberration diagram of the imaging optical system of Example 7 at a focusing distance of 2.4 m.

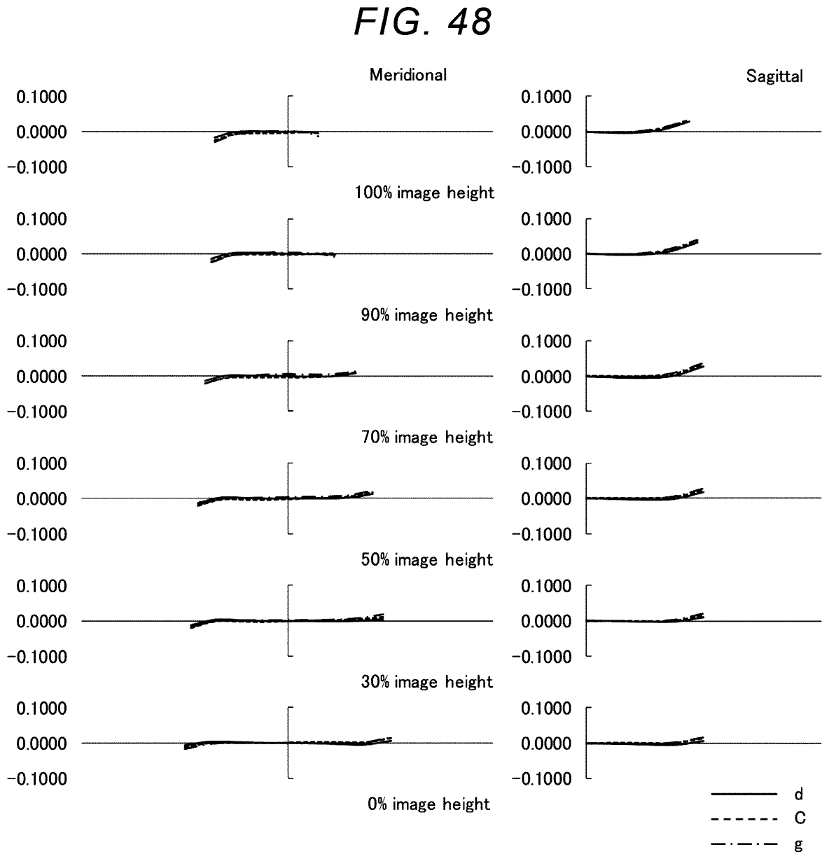

FIG. 49 is a lateral aberration diagram of the imaging optical system of Example 7 at a focusing distance of 1.1 m.

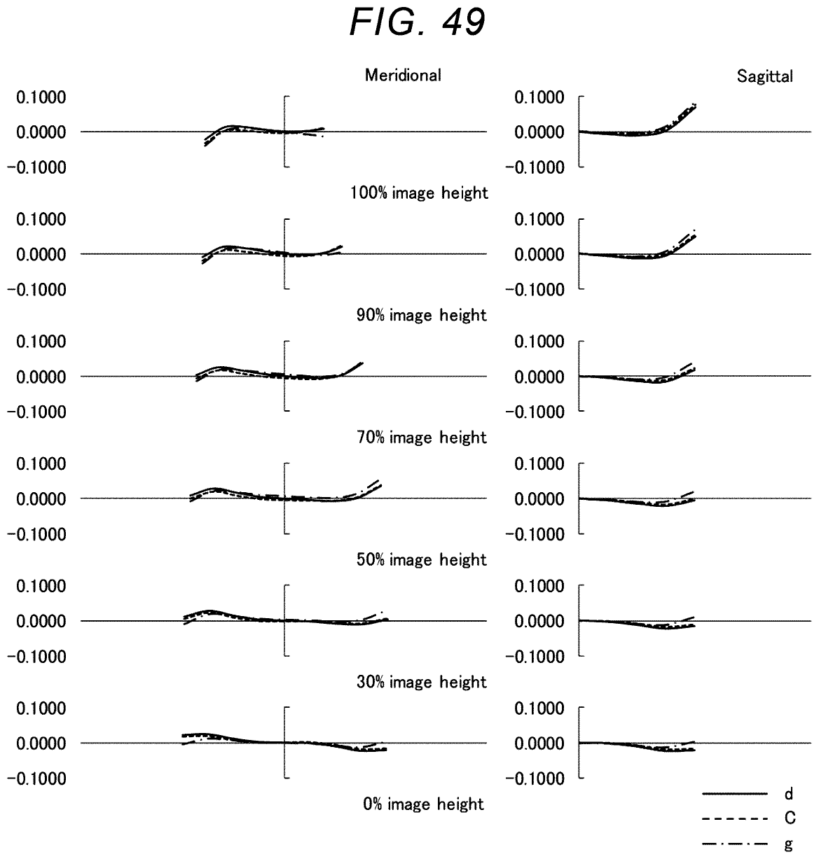

FIG. 50 is a lens configuration diagram according to Example 8 of an imaging optical system of the present invention.

FIG. 51 is a longitudinal aberration diagram of the imaging optical system of Example 8 at an infinite photographing distance.

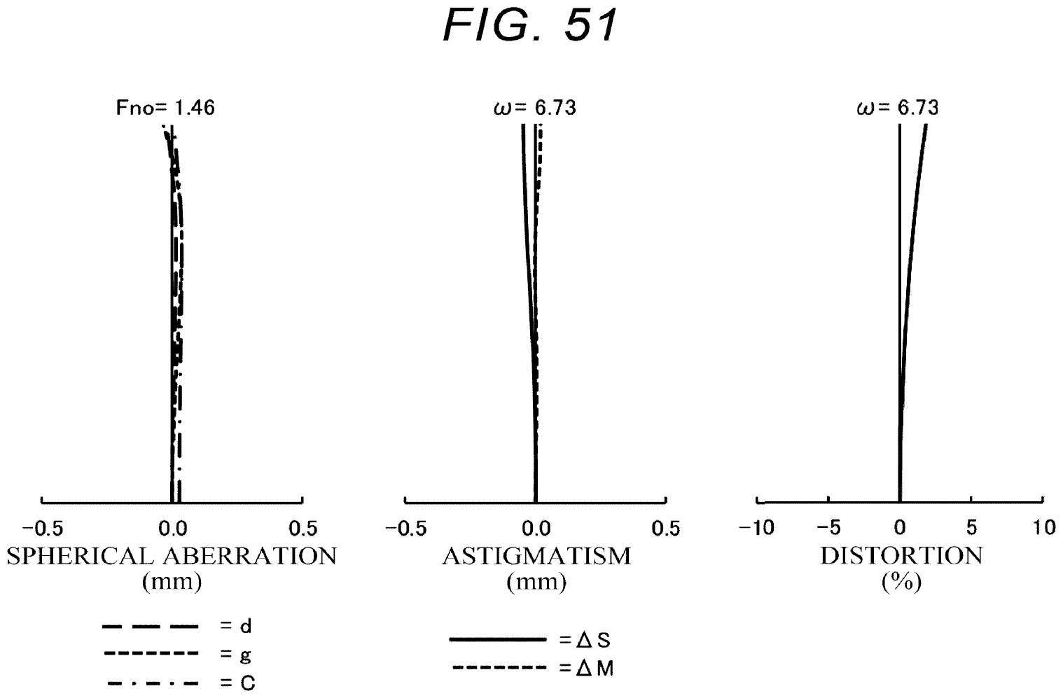

FIG. 52 is a longitudinal aberration diagram of the imaging optical system of Example 8 at a focusing distance of 3.3 m.

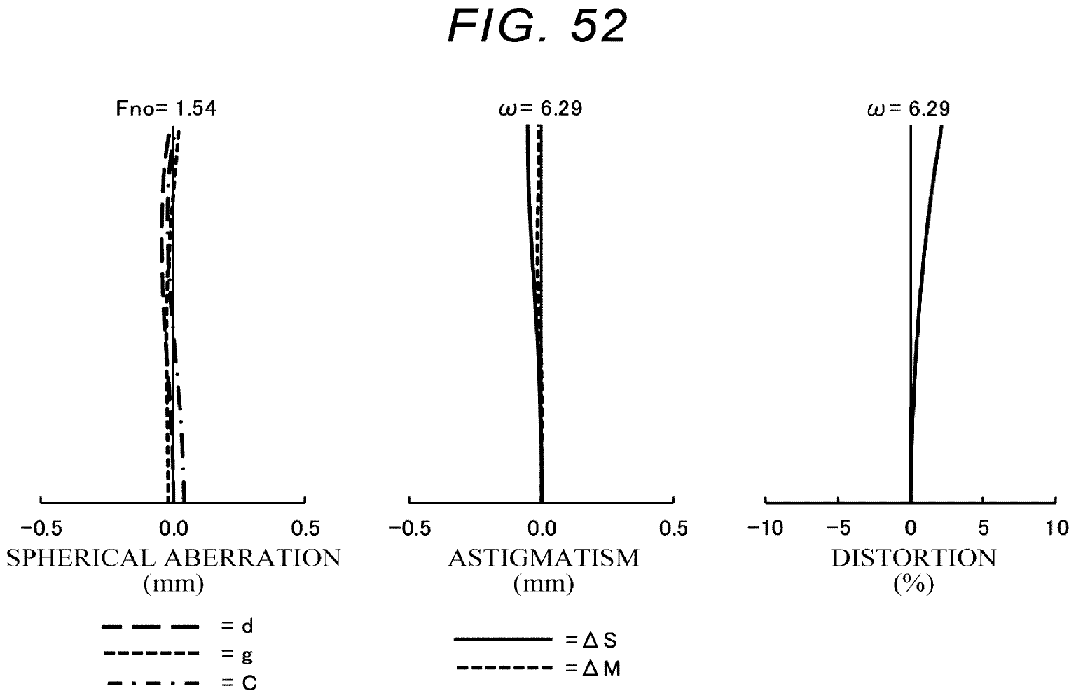

FIG. 53 is a longitudinal aberration diagram of the imaging optical system of Example 8 at a focusing distance of 1.5 m.

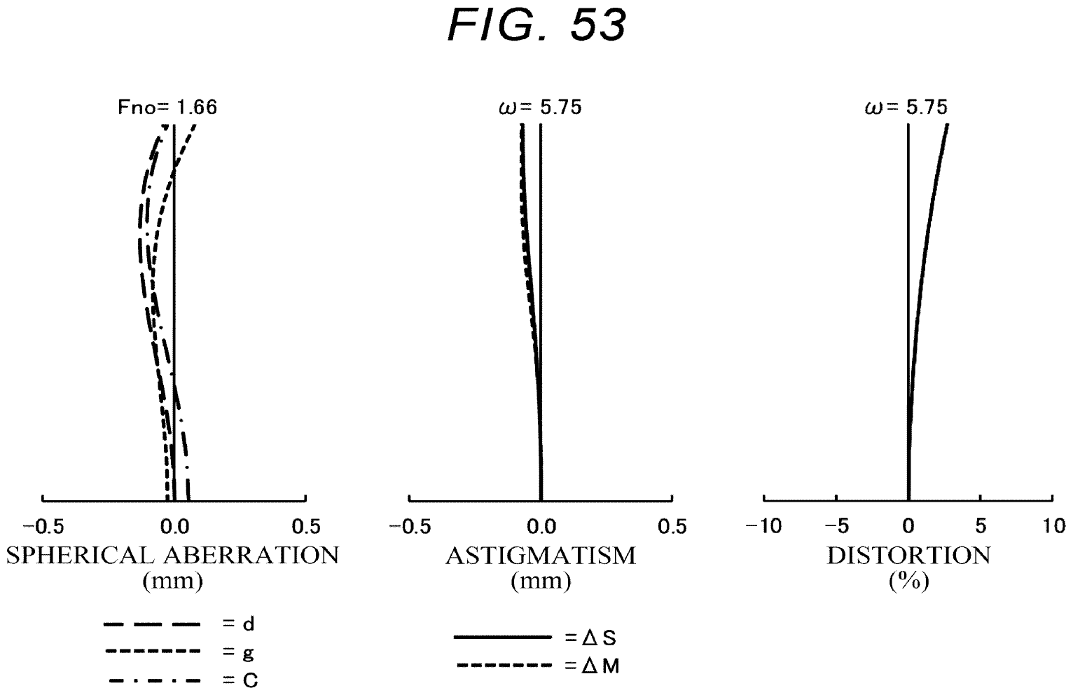

FIG. 54 is a lateral aberration diagram of the imaging optical system of Example 8 at an infinite photographing distance.

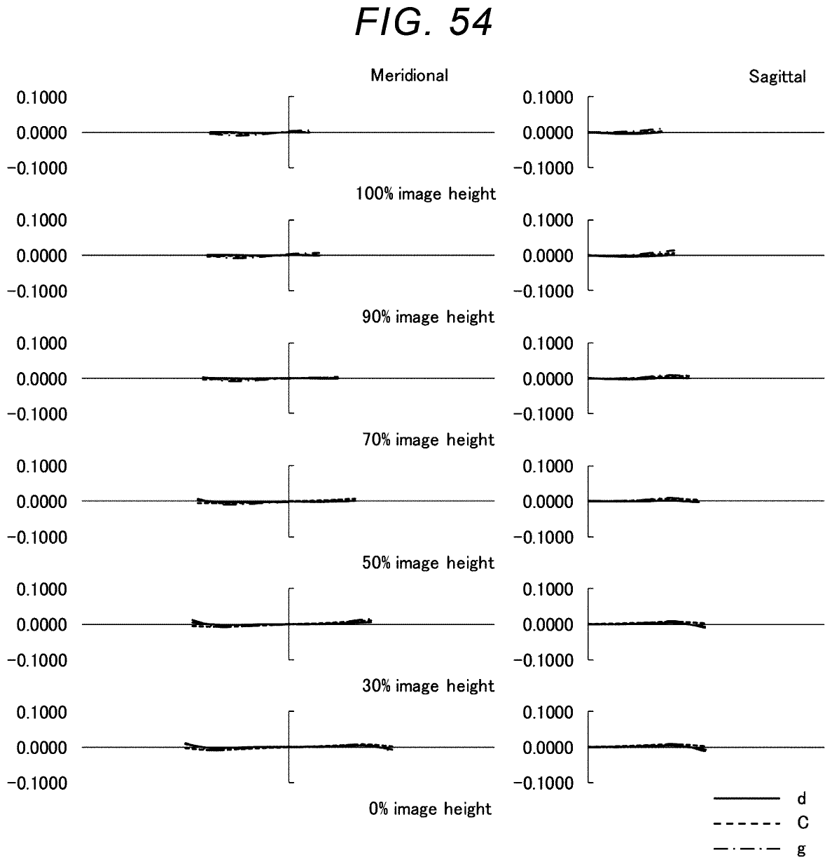

FIG. 55 is a lateral aberration diagram of the imaging optical system of Example 8 at a focusing distance of 3.3 m.

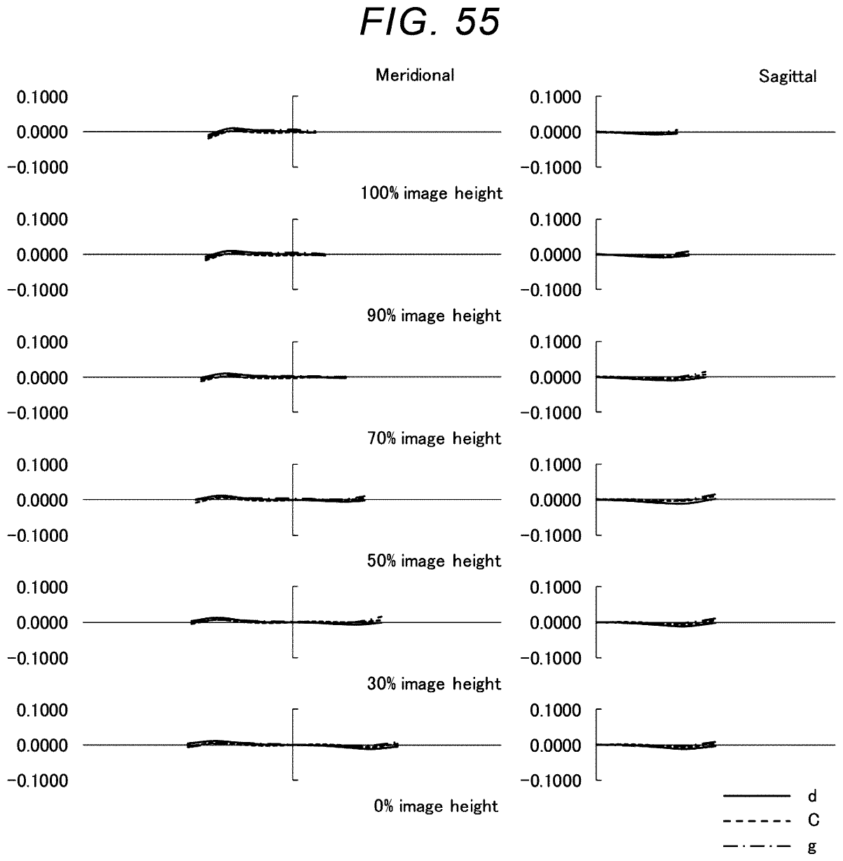

FIG. 56 is a lateral aberration diagram of the imaging optical system of Example 8 at a focusing distance of 1.5 m.

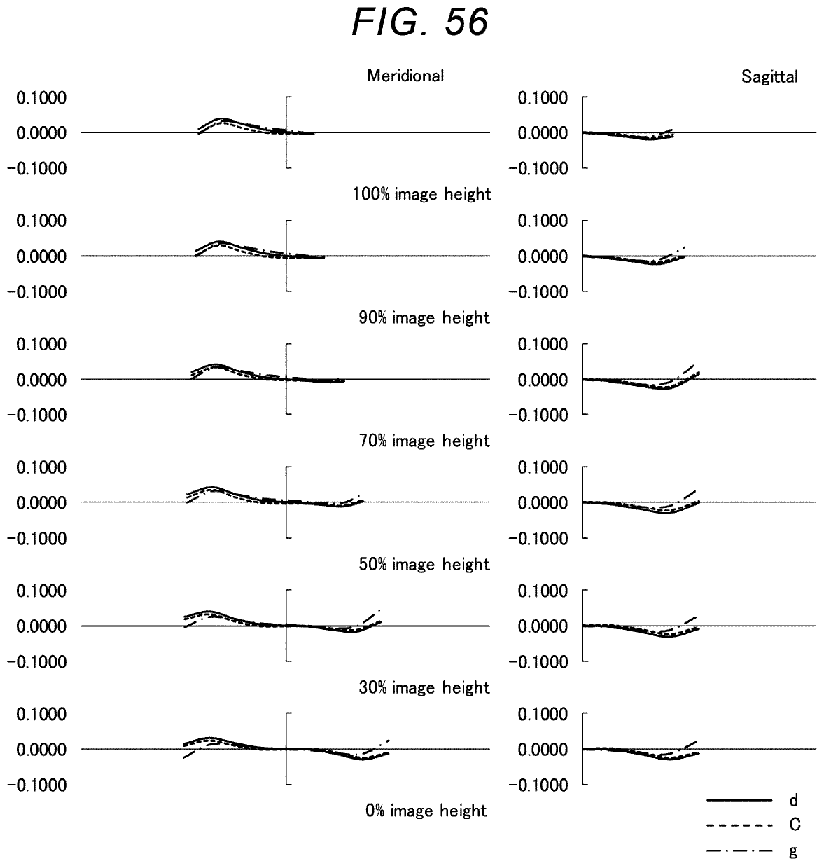

### EMBODIMENTS FOR CARRYING OUT THE INVENTION

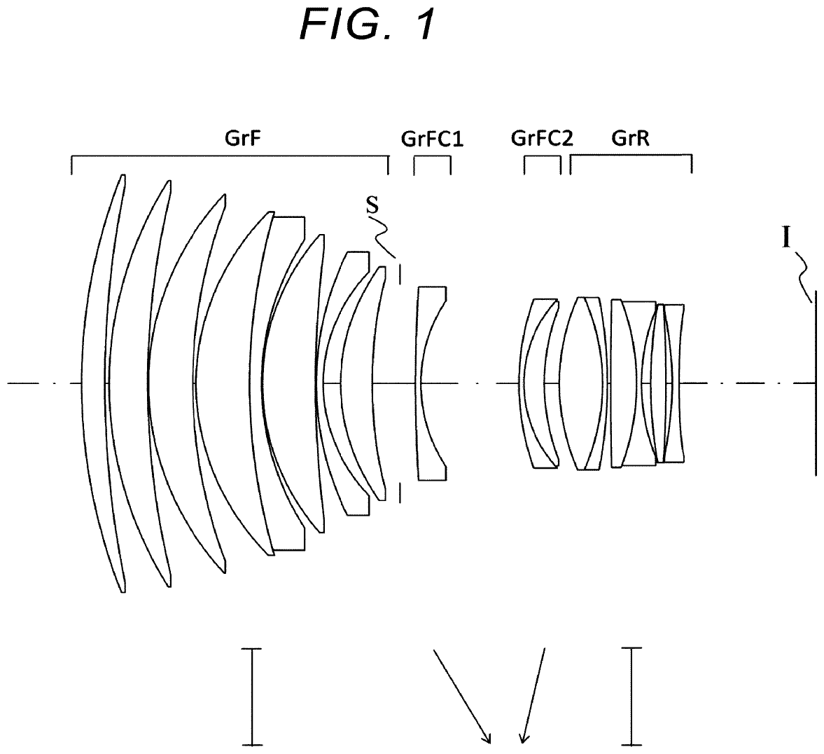

As shown in the lens configuration diagrams of FIGS. 1, 8, 15, 22, 29, 36, 43, and 50, the imaging optical system of the present invention consists of, in order from the object side, a front group GrF having a positive refractive power, a first focus group GrFC1 and a second focus group GrFC2 having a negative refractive power, and a rear group GrR having a positive refractive power. During focusing from infinity to a short distance, the front group GrF and the rear group GrR are fixed with respect to an image surface, the first focus group GrFC1 moves to an image side, and the second focus group GrFC2 moves to an object side.

In the text, the lens component indicates a single lens or a cemented lens in which a plurality of lenses are cemented.

It is necessary to appropriately dispose the lenses in order to satisfactorily correct aberrations of the entire system. The imaging optical system of the present invention has a configuration in which the front group GrF having a positive refractive power, the first focus group GrFC1 having a negative refractive power, the second focus group GrFC2, and the rear group GrR having a positive refractive power are arranged in order from the object side, and the first focus group GrFC1 moves to the image side and the second focus group GrFC2 moves to the object side during focusing. By adopting such a configuration of the group, it is easy to reduce the weight and size of the focus lens group, and it is possible to suppress an increase in size of the entire lens system.

It is preferable that the imaging optical system of the present invention satisfies the following conditional expression.

$$0.20 < LGrF / fF < 1.4 \qquad ( 1 )$$

LGrF: a length of the front group GrF on an optical axis in an infinity-focusing state
fF: a focal length of the front group GrF in the infinity-focusing state

Conditional Expression (1) specifies a ratio of a length of the front group GrF on the optical axis to a focal length in an infinity-focusing state as a preferable condition for suppressing an increase in size of the entire lens system and for correcting aberrations.

In a case where the length of the front group GrF exceeds the upper limit of Conditional Expression (1), it is difficult to reduce the size of the entire system. In a case where the length of the front group GrF is shorter than the lower limit of Conditional Expression (1), there is no space for disposing the lens, the refractive power of each lens in the front group GrF is increased, and it is difficult to correct aberration in a case of increasing the aperture ratio.

Regarding Conditional Expression (1), it is desirable that the lower limit value is set to 0.30, and in a case where the lower limit value is further set to 0.40, the above-described effect can be made more reliable. In addition, it is desirable that the upper limit value is set to 1.10, and in a case where the upper limit value is further set to 0.80, the above-described effect can be made more reliable.

It is preferable that the imaging optical system of the present invention satisfies the following conditional expression.

$$0.42 < f / fFC 2 R < 4.00 \qquad ( 2 )$$

f: a focal length of the entire lens system at focusing on infinity
fFC2R: a total focal length of the second focus group GrFC2 and the rear group GrR during focusing on infinity

Conditional Expression (2) specifies a ratio of a total focal length of the second focus group GrFC2 and the rear group GrR to a focal length of the entire system as a preferable condition for increasing the aperture ratio and correcting aberrations.

In a case where the upper limit of Conditional Expression (2) is exceeded and the total focal length of the second focus group GrFC2 and the rear group GrR decreases, the refractive power increases, it is difficult to correct aberrations such as spherical aberration, and the image circle is reduced due to the convergence of rays. As a result, it is difficult to cope with a large image sensor. In a case where the lower limit of Conditional Expression (2) is not met and the total focal length of the second focus group GrFC2 and the rear group GrR is increased, it becomes difficult to further increase the aperture ratio.

Regarding Conditional Expression (2), it is desirable that the lower limit value is set to 0.80, and in a case where the lower limit value is further set to 1.00, the above-described effect can be made more reliable. In addition, it is desirable that the upper limit value is set to 3.00, and in a case where the upper limit value is further set to 2.50, the above described effect can be made more reliable.

It is preferable that the imaging optical system of the present invention satisfies the following conditional expression.

$$0.15 < LFrFGrR / LALL < 0.5 \qquad ( 3 )$$

LGrFGrR: a length on the optical axis from a surface of the front group GrF closest to the image side to a surface of the rear group GrR closest to the object side in the infinity focusing state
LALL: a length on the optical axis from a surface of the front group GrF closest to the object side to an image surface in the infinity-focusing state

Conditional Expression (3) specifies a ratio of a length of the entire system to a distance between the front group GrF and the rear group GrR in order to secure a space used for focusing in the entire lens system.

It is not preferable that the length of the front group GrF or the rear group GrR is reduced and the arrangement of the lenses required for the aberration correction is difficult because the distance between the front group GrF and the rear group GrR exceeds the upper limit of Conditional Expression (3). In particular, in the front group GrF, in order to reduce the axial ray height with a small number of lenses, the refractive power of each lens is increased, and it is difficult to correct aberration in a case of increasing the aperture ratio. In addition, in order to achieve both the suppression of the increase in off axial ray height and the increase in the aperture ratio in the rear group GrR, the refractive power of each lens is increased, and it is difficult to correct aberration with a small number of lenses. In a case where the lower limit of Conditional Expression (3) is not met and the interval between the front group GrF and the rear group GrR is shortened, the space used for focusing is narrowed. Thus, the shortest focusing distance may be increased, or the fluctuation in aberration during focusing may be increased, which is not preferable.

Regarding Conditional Expression (3), it is desirable that the lower limit value is set to 0.18, and in a case where the lower limit value is further set to 0.22, the above-described effect can be made more reliable. In addition, it is desirable that the upper limit value is set to 0.42, and in a case where the upper limit value is further set to 0.35, the above-described effect can be made more reliable.

It is preferable that the imaging optical system of the present invention satisfies the following conditional expression.

$$50.00 < v dG 24 < 102. \qquad ( 4 )$$

vdG24: a mean value of Abbe numbers of a second positive lens, a third positive lens, and a fourth positive lens of the front group GrF from the object side

$$55. < vdG 24 < 102. \qquad ( 4 ' )$$

vdG24: a mean value of Abbe numbers of a second positive lens, a third positive lens, and a fourth positive lens of the front group GrF from the object side

Conditional Expressions (4) and (4′) specify a mean value of Abbe numbers of a second positive lens, a third positive lens, and a fourth positive lens of the front group GrF from the object side as a condition for correcting chromatic aberration of the entire lens system. As the focal length of the entire system increases, it is difficult to correct chromatic aberration in the rear group GrR. Therefore, it is important to correct chromatic aberration in the front group GrF.

In a case where the upper limit of Conditional Expression (4) is exceeded and the mean value of the Abbe numbers is large, the correction of the chromatic aberration becomes excessive, which is not preferable. In addition, since the refractive index of the material tends to be low, it is difficult to correct various aberrations including spherical aberration. In a case where the lower limit of Conditional Expression (4) is not met and the mean value of the Abbe numbers is small, the correction of the chromatic aberration is insufficient, which is not preferable.

Regarding Conditional Expressions (4) and (4′), it is desirable that the lower limit value is set to 60.00, and in a case where the lower limit value is further set to 70.00, the above-described effect can be made more reliable. In addition, in a case where the upper limit value is set to 96.00, the above-described effect can be made more reliable.

It is preferable that the imaging optical system of the present invention satisfies the following conditional expression.

$$0.0 \; 00 < \vert K 2 \vert < 0.37 \qquad ( 5 )$$

   |K2|: focus sensitivity of the second focus group GrFC2 in the infinity-focusing state

$$\vert K 2 \vert = \vert ( 1 - β FC 2 \hat{} 2 ) * ( β R \hat{} 2 ) \vert$$

ßFC2: lateral magnification of second focus group GrFC2 in the infinity-focusing state
ßR: lateral magnification of the rear group GR in the infinity-focusing state

$$0.0 \; 00 < \vert K 2 \vert < 0.6 \qquad ( 5 ' )$$

   |K2|: focus sensitivity of the second focus group GrFC2 in the infinity-focusing state

$$\vert K 2 \vert = \vert ( 1 - β FC 2 \hat{} 2 ) * ( β R \hat{} 2 ) \vert$$

ßFC2: lateral magnification of second focus group GrFC2 in the infinity-focusing state
ßR: lateral magnification of the rear group GR in the infinity-focusing state

Conditional Expressions (5) and (5′) specify the focus sensitivity of the second focus group GrFC2 as preferable conditions for aberration correction.

In a case where the upper limit of Conditional Expression (5′) is exceeded and the focus sensitivity is increased, it becomes difficult to perform cooperative control for focusing with the first focus group GrFC1, which is not preferable. Furthermore, in a case where the second focus group GrFC2 has a negative refractive power, the amount of movement of the first focus group GrFC1 for focusing increases, and the size of the entire lens system increases, which is not preferable. In addition, in a case where the second focus group GrFC2 has a positive refractive power, the positive refractive power of the rear group GrR is weakened, and the positive distortion of the entire lens system is increased, which is not preferable. In a case where the lower limit of Conditional Expression (5) is not met and the focus sensitivity decreases, the refractive power of the second focus group GrFC2 becomes weaker and the fluctuation of the distortion in a case of focusing is increased, which is not preferable.

In a case where the lower limit value of Conditional Expression (5) is set to 0.010, the above described effect can be made more reliable. In addition, it is desirable that the upper limit value is set to 0.290, and in a case where the upper limit value is further set to 0.200, the above-described effect can be made more reliable.

In a case where the lower limit value of Conditional Expression (5′) is set to 0.010, the above described effect can be made more reliable. In addition, it is desirable that the upper limit value is 0.470. It is more desirable that the upper limit value thereof is 0.370. It is even more desirable that the upper limit value thereof is 0.290. Further, by setting the upper limit value thereof to 0.200, the above-described effect can be made more reliable.

It is preferable that the imaging optical system of the present invention satisfies the following conditional expression.

$$0.1 \; 07 < Δ Gr 1 GrFC 1 / Y max < 1. \qquad ( 6 )$$

ΔGr1GrFC1: a length parallel to optical axis between a position of an axial ray height of a surface of the front group GrF closest to the image side and a position of an axial ray height of a surface of the first focus group GrFC1 closest to the object side in the infinity-focusing state
Ymax: maximum image height

$$0.0 \; 95 < Δ Gr 1 GrFC 1 / Y max < 1. \qquad ( 6 ' )$$

ΔGr1GrFC1: a length parallel to optical axis between a position of an axial ray height of a surface of the front group GrF closest to the image side and a position of an axial ray height of a surface of the first focus group GrFC1 closest to the object side in the infinity-focusing state
Ymax: maximum image height

Conditional Expressions (6) and (6′) specify a ratio between the distance and the maximum image height between the front group GrF and the first focus group GrFC1 as preferable conditions for the disposition of the first focus group GrFC1.

In a case where the upper limit of Conditional Expression (6) is exceeded and the distance from the front group GrF increases, the length of the front group GrF becomes shorter, making it difficult to dispose the lenses required for aberration correction, which is not preferable. In a case where the lower limit of Conditional Expression (6′) is not met and the distance from the front group GrF decreases, the space required for the movement of the focusing is narrowed, which is not preferable.

Regarding Conditional Expressions (6) and (6′), it is desirable that the lower limit value is set to 0.150, and in a case where the lower limit value is further set to 0.180, the above-described effect can be made more reliable. In addition, it is desirable that the upper limit value is set to 0.700, and in a case where the upper limit value is further set to 0.500, the above-described effect can be made more reliable.

In addition, in the imaging optical system according to the present invention, it is desirable that the shapes of the second to fourth positive lenses from the object side among the positive lenses in the front group GrF are positive menisci having a shape of an object side convex surface.

In order to achieve both the increase in aperture ratio and the reduction in size of the entire lens system, it is necessary to achieve both reduction in axial ray height and aberration correction. Since the shapes of the second to fourth positive lenses from the object side among the positive lenses in the front group GrF are positive menisci having a shape of an object side convex surface, it is possible to satisfactorily correct chromatic aberration and comatic aberration in a case of reducing the axial ray height.

In the imaging optical system according to the present invention, it is desirable that the aperture diaphragm S is closer to the object side than the first focus group GrFC1, and the following conditional expression is satisfied.

$$55. < vdG 24 < 102. \qquad ( 4 ' )$$

vdG24: a mean value of Abbe numbers of a second positive lens, a third positive lens, and a fourth positive lens of the front group GrF from the object side

Since the aperture diaphragm S is closer to the object side than the first focus group GrFC1, it is possible to cut the axial ray during focusing by the aperture diaphragm S, and it is possible to omit the driving control of the diaphragm for exposure adjustment.

In addition, since the mechanism of the aperture diaphragm S and the mechanism of the actuator for focusing can be separated, it is possible to avoid an increase in size of the product.

In the imaging optical system according to the present invention, it is desirable that the aperture diaphragm S is adjacent to the image side of the front group GrF, and the following conditional expression is satisfied.

$$0.0 \; 00 < \vert K 2 \vert < 0.6 \qquad ( 5 ' )$$

   |K2|: focus sensitivity of the second focus group GrFC2 in the infinity-focusing state

$$\vert K 2 \vert = \vert ( 1 - β FC 2 \hat{} 2 ) * ( β R \hat{} 2 ) \vert$$

ßFC2: lateral magnification of second focus group GrFC2 in the infinity-focusing state
ßR: lateral magnification of the rear group GR in the infinity-focusing state

Since the aperture diaphragm S is adjacent to the image side of the front group GrF, it is possible to cut the on-axis ray during focusing by the aperture stop S, and it is possible to omit the driving control of the diaphragm for exposure adjustment. In addition, since the front group GrF is configured as one unit, the manufacturing error factor is reduced, and thus the variation in optical performance during manufacturing can be reduced. Furthermore, since there is no lens group between the aperture diaphragm S and the focus group, it is easy to reduce the total optical length.

In the imaging optical system according to the present invention, it is desirable that the second focus group GrFC2 has a negative refractive power.

In a case where the second focus group GrFC2 has a negative refractive power, the focus sensitivity of the first focus group GrFC1 is likely to be increased, and the focus sensitivity of the second focus group GrFC2 is likely to be decreased. Even in a case where an error occurs instantaneously in the cooperative control for focusing due to an external factor such as a shock, it is possible to suppress deterioration in focusing accuracy.

In the imaging optical system according to the present invention, it is desirable that the first focus group GrFC1 consists of one lens.

The first focus group GrFC1 is disposed at a position where the axial ray height is high. Therefore, in a case where the lens group consists of one lens, weight reduction is achieved, and there is an advantage in control related to the speed and accuracy of focusing.

In the imaging optical system according to the present invention, it is desirable that the second focus group GrFC2 consists of one or two lenses.

In the second focus group GrFC2, a smaller number of lenses also contributes to weight reduction, and is advantageous for control related to the speed and accuracy of focusing. In addition, the second focus group GrFC2 is effective in reducing chromatic aberration correction during focusing, and in a case where the number of lenses is two, it is easy to select materials, and the effect is further increased.

In the imaging optical system according to the present invention, it is desirable that the rear group GrR has one or more negative lenses on the image side of the positive lens.

Since the positive lens and the negative lens are arranged in the rear group GrR, a telephoto type effect occurs, and it is easy to achieve both reduction in total lens length and increase in aperture ratio.

It is preferable that the imaging optical system of the present invention satisfies the following conditional expression.

$$0.6 \; 00 < \vert K 1 \vert < 4. \qquad ( 7 )$$

   |K1|: focus sensitivity of the first focus group GrFC1 in the infinity-focusing state

$$\vert K 1 \vert = \vert ( 1 - β FC 1 \hat{} 2 ) ⋆ ( ( β FC 2 * β R ) \hat{} 2 ) \vert$$

ßFC1: lateral magnification of first focus group GrFC1 in the infinity-focusing state
ßFC2: lateral magnification of second focus group GrFC2 in the infinity-focusing state
ßR: lateral magnification of the rear group GR in the infinity-focusing state

Conditional Expression (7) specifies the focus sensitivity of the first focus group GrFC1 as preferable conditions for aberration correction.

In a case where the upper limit of Conditional Expression (7) is exceeded and the focus sensitivity increases, the manufacturing error sensitivity of the first focus group GrFC1 is increased and particularly, the fluctuation in the astigmatism during eccentricity is increased, which is not preferable. In a case where the lower limit of Conditional Expression (7) is not met and the focus sensitivity decreases, the amount of movement of focusing of the first focus group is increased and the size of the entire lens system is increased, which is not preferable.

Regarding Conditional Expression (7), it is desirable that the lower limit value is set to 0.800, and in a case where the lower limit value is further set to 0.900, the above-described effect can be made more reliable. In addition, it is desirable that the upper limit value is set to 3.400, and by further setting the upper limit value to 2.900, the above-described effect can be made more reliable.

It is preferable that the imaging optical system of the present invention satisfies the following conditional expression.

$$0.00 < \vert fFC 12 / fFC 2 \vert < 0.5 \qquad ( 8 )$$

fFC12: a total focal length from the first focus group GrFC1 to the second focus group GrFC2 at focusing on infinity
fFC2: a focal length of the second focus group GrFC2

Conditional Expression (8) specifies a ratio of a total focal length of the first focus group GrFC1 to the second focus group GrFC2 and a focal length of the second focus group GrFC2 as a preferable condition for the focus group.

In a case where the upper limit of Conditional Expression (8) is exceeded and the refractive power of the second focus group GrFC2 is relatively large, it becomes difficult to perform cooperative control for focusing with the first focus group GrFC1, which is not preferable. Furthermore, in a case where the second focus group GrFC2 has a negative refractive power, the amount of movement of the first focus group GrFC1 for focusing increases, and the size of the entire lens system increases, which is not preferable. In addition, in a case where the second focus group GrFC2 has a positive refractive power, the positive refractive power of the rear group GrR is weakened, and the positive distortion of the entire lens system is increased, which is not preferable. In a case where the lower limit of Conditional Expression (8) is not met and the refractive power of the second focus group GrFC2 is relatively small, the fluctuation of the distortion in a case of focusing is increased, which is not preferable.

Regarding Conditional Expression (8), it is desirable that the lower limit value is set to 0.01, and in a case where the lower limit value is further set to 0.03, the above-described effect can be made more reliable. In addition, it is desirable that the upper limit value is set to 0.33, and by further setting the upper limit value to 0.23, the above-described effect can be made more reliable.

It is preferable that the imaging optical system of the present invention satisfies the following conditional expression.

$$0.00 < \vert f / fFC 2 \vert < 1. \qquad ( 9 )$$

f: a focal length of the entire lens system at focusing on infinity
fFC2: a focal length of the second focus group GrFC2

Conditional Expression (9) specifies a ratio of the focal length of the second focus group GrFC2 to the focal length of the entire system as a preferable condition of the focus group.

In a case where the upper limit of Conditional Expression (9) is exceeded and the refractive power of the second focus group GrFC2 is relatively large, it becomes difficult to perform cooperative control for focusing with the first focus group GrFC1, which is not preferable. In addition, in a case where the second focus group has a negative refractive power, the amount of movement of the first focus group for focusing increases, and the size of the entire lens system increases, which is not preferable. In addition, in a case where the second focus group has a positive refractive power, the positive refractive power of the rear group GrR is weakened, and the positive distortion of the entire lens system is increased, which is not preferable. In a case where the lower limit of Conditional Expression (9) is not met and the refractive power of the second focus group GrFC2 is relatively small, the fluctuation of the distortion in a case of focusing is increased, which is not preferable.

Regarding Conditional Expression (9), it is desirable that the lower limit value is set to 0.02, and in a case where the lower limit value is further set to 0.06, the above-described effect can be made more reliable. In addition, it is desirable that the upper limit value is set to 0.90, and by further setting the upper limit value to 0.80, the above-described effect can be made more reliable.

It is preferable that the imaging optical system of the present invention satisfies the following conditional expression.

$$15. < vdGla 1 < 40. \qquad ( 10 )$$

$$0.01 < Δ PgFGla 1 < 0.1 \qquad ( 11 )$$

vdGla1: Abbe number of the positive lens closest to the object side
ΔPgFGla1: ΔPgF of the positive lens closest to the object side

Here,

ΔPgF is an anomalous dispersion between g and F lines, and is represented by the following expression.

$$Δ Pgf = PgF - 0.64833 + 0.0018 vd$$

PgF=(ng−nF)/(nF−nC): a partial dispersion ratio between g and F lines
ng: a refractive index with respect to g line (wavelength λ=435.84 nm)
nF: a refractive index with respect to F line (wavelength λ=486.13 nm)
nC: a refractive index with respect to C line (wavelength λ=656.27 nm)

Conditional Expressions (10) and (11) specify an Abbe number and anomalous dispersion of a positive lens closest to the object side as preferable conditions for chromatic aberration correction.

It is not preferable that the value of the above-described expression exceeds the upper limit of Conditional Expression (10) because the secondary color removal is insufficient. It is not preferable that the result of Conditional Expression (10) is less than the lower limit thereof because the secondary color removal is excessive.

It is not preferable that the result of Conditional Expression (11) is more than the upper limit thereof because the secondary color removal is excessive. It is not preferable that the result of Conditional Expression (11) is less than the lower limit thereof because the secondary color removal is insufficient.

It is desirable that the lower limit value of Conditional Expression (10) is set to 17.0. In addition, it is desirable that the upper limit value is set to 35.00, and by further setting the upper limit value to 30.00, the above-described effect can be made more reliable.

Regarding Conditional Expression (11), it is desirable that the lower limit value is set to 0.015, and in a case where the lower limit value is further set to 0.020, the above-described effect can be made more reliable. In addition, it is desirable that the upper limit value is set to 0.050, and by further setting the upper limit value to 0.040, the above-described effect can be made more reliable.

It is preferable that the imaging optical system of the present invention satisfies the following conditional expression.

$$0.25 < \vert exp / f \vert < 1.5 \qquad ( 12 )$$

exp: a length from the exit pupil position to the image surface
f: a focal length of the entire lens system at focusing on infinity

Conditional Expression (12) specifies a ratio of the exit pupil position to the focal length of the entire system as a preferable condition for the exit pupil position.

In a case where the upper limit of Conditional Expression (12) is exceeded and the exit pupil position is increased, the lens diameter of the lens closer to the image side than the aperture diaphragm S is increased, which is not preferable. In a case where the lower limit of Conditional Expression (12) is not met and the exit pupil position is small, the off-axial ray reaches the image surface at a steep angle, which causes a decrease in sensitivity in a case where the image sensor is used, and thus is not preferable.

Regarding Conditional Expression (12), it is desirable that the lower limit value is set to 0.35, and in a case where the lower limit value is further set to 0.45, the above-described effect can be made more reliable. In addition, it is desirable that the upper limit value is set to 1.20, and by further setting the upper limit value to 1.00, the above-described effect can be made more reliable.

It is preferable that the imaging optical system of the present invention satisfies the following conditional expression.

$$0 \text{.080} < ( Y 1 GrF - Y 2 GrF ) / f < 0.3 \qquad ( 13 )$$

Y1GrF: an axial ray height of a surface of the front group GrF closest to the object side
Y2GrF: an axial ray height of a surface of the front group GrF closest to the image side
f: a focal length of the entire lens system at focusing on infinity

Conditional Expression (13) specifies a ratio of the change in height of the axial ray passing through the front group GrF to the focal length of the entire system as a preferable condition.

In a case where the axial ray in the front group GrF exceeds the upper limit of Conditional Expression (13), the refractive power of the positive lens in the group increases, and thus the spherical aberration increases. As a result, it is difficult to achieve favorable aberration correction of the entire system. In a case where the lower limit of Conditional Expression (13) is not met and the amount of decrease in the axial ray in the front group GrF is small, the lens diameter of the lens closer to the image side than the front group GrF is increased, which is not preferable.

Regarding Conditional Expression (13), it is desirable that the lower limit value is set to 0.090, and in a case where the lower limit value is further set to 0.100, the above-described effect can be made more reliable. In addition, it is desirable that the upper limit value is set to 0.250, and by further setting the upper limit value to 0.200, the above-described effect can be made more reliable.

It is preferable that the imaging optical system of the present invention satisfies the following conditional expression.

$$0.75 < f / fF < 2.50 \qquad ( 14 )$$

f: a focal length of the entire lens system at focusing on infinity
fF: a focal length of the front group GrF in the infinity-focusing state

Conditional Expression (14) specifies a ratio of a focal length of the front group GrF in an infinity focusing state to the focal length of the entire system as a preferable condition for suppressing an increase in size of the entire lens system and for correcting aberrations.

In a case where the focal length of the front group GrF is decreased and exceeds the upper limit of Conditional Expression (14), the refractive power of the front group increases, and it is difficult to correct aberration in a case where the aperture ratio is increased. In a case where the lower limit of Conditional Expression (14) is not met and the focal length of the front group GrF increases, the refractive power of the front group decreases, and it is difficult to reduce the size of the entire lens system.

Regarding Conditional Expression (14), it is desirable that the lower limit value is set to 0.95, and in a case where the lower limit value is further set to 1.00, the above-described effect can be made more reliable. In addition, it is desirable that the upper limit value is set to 2.20, and by further setting the upper limit value to 1.85, the above-described effect can be made more reliable.

It is preferable that the imaging optical system of the present invention satisfies the following conditional expression.

$$0.70 < f / fR < 3.50 \qquad ( 15 )$$

f: a focal length of the entire lens system at focusing on infinity
fR: a focal length of the rear group GrR in the infinity focusing state

Conditional Expression (15) specifies a ratio of a focal length of the rear group GrR in the infinity focusing state to the focal length of the entire system as a preferable condition for increasing the aperture ratio and correcting aberrations.

In a case where the upper limit of Conditional Expression (15) is exceeded and the focal length of the rear group GrR is decreased, the refractive power in the rear group GrR is increased, and it is difficult to correct aberration in a case of increasing the aperture ratio. In a case where the lower limit of Conditional Expression (15) is not met and the focal length of the rear group GrR increases, the refractive power of the rear group GrR decreases, and it is difficult to achieve both an increase in the aperture ratio of the entire lens system and a reduction in size.

It is desirable that the lower limit value of Conditional Expression (15) is set to 0.90, it is more desirable that the lower limit value is set to 1.10, and it is even more desirable that the lower limit value is set to 1.30, so that the above-described effect can be made more reliable. In addition, it is desirable that the upper limit value is 3.10, it is more desirable that the upper limit value is 2.80, and it is even more desirable that the upper limit value is 2.50, whereby the above-described effects can be made more reliable.

It is preferable that the imaging optical system of the present invention satisfies the following conditional expression.

$$1. < \vert f / fFC 1 \vert < 4. \qquad ( 16 )$$

f: a focal length of the entire lens system at focusing on infinity
fFC1: a focal length of the first focus group GrFC1 in the infinity focusing state

Conditional Expression (16) specifies a ratio of the focal length of the first focus group GrFC1 to the focal length of the entire system in the infinity-focusing state as a preferable condition for aberration correction.

In a case where the upper limit of Conditional Expression (16) is exceeded and the focal length of the first focus group GrFC1 decreases, the manufacturing error sensitivity of the first focus group GrFC1 is increased and particularly, the fluctuation in the astigmatism during eccentricity is increased, which is not preferable. In a case where the lower limit of Conditional Expression (16) is not met and the focal length of the first focus group GrFC1 increases, the amount of movement of focusing of the first focus group GrFC1 is increased and the size of the entire lens system is increased, which is not preferable.

Regarding Conditional Expression (16), it is desirable that the lower limit value is set to 1.20, and in a case where the lower limit value is further set to 1.40, the above-described effect can be made more reliable. In addition, it is desirable that the upper limit value is set to 3.70, and by further setting the upper limit value to 3.30, the above-described effect can be made more reliable.

Next, lens configurations of examples according to the imaging optical system of the present invention will be described. In the following description, the lens configuration will be described in order from the object side to the image side.

In [Surface data], the surface number is a number of a lens surface or an aperture diaphragm S counted from the object side, r is a curvature radius of each surface, d is a distance between the surfaces, nd is a refractive index with respect to the d line (wavelength of 587.56 nm), vd is an Abbe number with respect to the d line, and PgF indicates a partial dispersion ratio with respect to the g line (wavelength of 435.8 nm) and the F line (wavelength of 486.1 nm).

An asterisk (*) attached to a surface number indicates that the lens surface shape is an aspherical surface shape. In addition, BF represents a back focus.

The (diaphragm) attached to the surface number indicates that the aperture diaphragm S is located at that position. A curvature radius with respect to the plane or the aperture diaphragm S is denoted by ∞ (infinity).

[Aspherical surface data] shows values of each coefficient for giving the aspherical shape of the lens surface denoted by * in [Surface data]. In a case where a displacement from the optical axis in a direction perpendicular to the optical axis is y, a displacement (sag) from an intersection of the optical axis and the aspherical surface in an optical axis direction is z, a curvature radius of a reference spherical surface is r, a conic coefficient is K, and fourth-order, sixth-order, . . . , and twentieth-order aspherical coefficients are A4, A6, . . . , and A20, respectively, it is assumed that coordinates of the aspherical surface are represented by the following expression.

$$z = \frac{( 1 / r ) {y}^{2}}{1 + \sqrt{1 - ( 1 + k ) {( y / z )}^{2}}} + A 4 {y}^{4} + A 6 {y}^{6} + A 8 {y}^{8} + A 10 {y}^{10} + A 12 {y}^{12} + A 14 {y}^{14} + A 16 {y}^{16} + A 18 {y}^{18} + A 20 {y}^{20} .$$

[Various types of data] indicate values such as a zoom ratio and a focal length in each focal length state.

The [Variable Distance Data] shows the variable distance and the BF value in each focal length state.

The [Lens group data] shows the surface number closest to the object side in each lens group and the total focal length of the entire group.

In addition, in the aberration diagrams corresponding to the respective examples, d, g, and C represent a d-line, a g-line, and a C-line, respectively, and ΔS and ΔM represent a sagittal image surface and a meridional image surface, respectively.

In addition, in all the values of the specifications described below, unless otherwise noted, the units of the focal length f, the curvature radius r, the lens surface distance d, and other lengths are millimeters (mm), but the present invention is not limited thereto since the same optical performance can be obtained in both the proportional magnification and the proportional reduction in the optical system.

In addition, in the lens configuration diagram of each example, an arrow indicates a path of a lens group during focusing from infinity to a short distance, S is an aperture diaphragm, I is an image surface, and a one dot chain line passing through the center is an optical axis.

### Example 1

FIG. 1 is a lens configuration diagram of an imaging optical system of Example 1 of the present invention.

The imaging optical system consists of, in order from an object side, a front group GrF having a positive refractive power, a first focus group GrFC1 having a negative refractive power, a second focus group GrFC2 having a negative refractive power, and a rear group GrR having a positive refractive power. During focusing from infinity to a short distance, the front group GrF and the rear group GrR are fixed with respect to an image surface, the first focus group GrFC1 moves to the image side, and the second focus group GrFC2 moves to the object side. The aperture diaphragm S is closer to the object side than the first focus group GrFC1 and is adjacent to the image side of the front group GrF.

The front group GrF consists of: a positive meniscus lens having a convex surface facing the object side, a positive meniscus lens having a convex surface facing the object side, a positive meniscus lens having a convex surface facing the object side, a cemented lens consisting of a positive meniscus lens having a convex surface facing the object side and a negative meniscus lens having a convex surface facing the object side, a positive meniscus lens having a convex surface facing the object side, a negative meniscus lens having a convex surface facing the object side, and a positive meniscus lens having a convex surface facing the object side with both surfaces being aspherical.

The first focus group GrFC1 consists of a negative meniscus lens having a convex surface facing the object side. The second focus group GrFC2 consists of a cemented lens consisting of a negative meniscus lens having a convex surface facing the object side and a positive meniscus lens having a convex surface facing the object side.

The rear group GrR consists of: a cemented lens consisting of a biconvex lens and a negative meniscus lens having a concave surface facing the object side, a cemented lens consisting of a biconvex lens and a biconcave lens, a biconvex lens, and a biconcave lens with both surfaces being aspherical.

The specification values of the imaging optical system of Example 1 are shown below.

### Numerical Example 1

Unit: mm
[Surface data]

| Surface number | r | d | nd | vd | PgF |
|---|---|---|---|---|---|
| Object surface | ∞ | (d0) | | | |
| 1 | 139.1088 | 4.8329 | 1.86966 | 20.02 | 0.6435 |
| 2 | 242.8613 | 0.9000 | | | |
| 3 | 92.4653 | 8.0166 | 1.43700 | 95.10 | 0.5336 |
| 4 | 199.2979 | 0.1500 | | | |
| 5 | 66.2231 | 9.2418 | 1.43700 | 95.10 | 0.5336 |
| 6 | 123.1719 | 0.7000 | | | |
| 7 | 57.9228 | 11.0967 | 1.43875 | 94.93 | 0.5340 |
| 8 | 149.8268 | 2.4925 | 1.90043 | 37.37 | 0.5767 |
| 9 | 64.5442 | 0.1500 | | | |
| 10 | 53.9493 | 10.9955 | 1.43875 | 94.93 | 0.5340 |
| 11 | 267.3073 | 0.1500 | | | |
| 12 | 71.7755 | 1.4510 | 1.85451 | 25.15 | 0.6103 |
| 13 | 38.5925 | 3.6698 | | | |
| 14* | 47.4008 | 6.5576 | 1.58313 | 59.46 | 0.5405 |
| 15* | 122.7395 | 5.7746 | | | |
| 16 (Diaphragm) | ∞ | (d16) | | | |
| 17 | 402.5829 | 1.0830 | 1.75500 | 52.32 | 0.5473 |
| 18 | 36.5722 | (d18) | | | |
| 19 | 61.6251 | 1.0000 | 1.84666 | 23.78 | 0.6192 |
| 20 | 29.6300 | 4.2961 | 1.72916 | 54.54 | 0.5453 |
| 21 | 50.7374 | (d21) | | | |
| 22 | 52.1881 | 8.9390 | 1.88100 | 40.14 | 0.5700 |
| 23 | −52.1881 | 1.0000 | 1.76634 | 35.82 | 0.5792 |
| 24 | −109.5737 | 0.7000 | | | |
| 25 | 1000.0000 | 5.3636 | 1.94594 | 17.98 | 0.6546 |
| 26 | −57.6051 | 1.0000 | 1.76182 | 26.61 | 0.6123 |
| 27 | 48.5100 | 1.9463 | | | |
| 28 | 116.6417 | 3.1455 | 2.00069 | 25.46 | 0.6136 |
| 29 | −283.4942 | 1.2989 | | | |
| 30* | −72.1371 | 1.4004 | 1.58313 | 59.46 | 0.5405 |
| 31* | 250.0000 | 28.4437 | | | |
| 32 | ∞ | (BF) | | | |
| Image surface | ∞ | | | | |

[Aspherical surface data]

| | Surface 14 | Surface 15 | Surface 30 | Surface 31 |
|---|---|---|---|---|
| K | 1.31969 | −0.49418 | −9.33638 | 3.00773 |
| A4 | −1.74600E−06 | 8.00700E−07 | 1.40182E−06 | 5.97410E−06 |
| A6 | −2.74822E−10 | 1.89969E−09 | 6.12079E−09 | 5.19546E−09 |
| A8 | −5.27433E−12 | −1.05116E−11 | −1.36953E−10 | −1.40827E−10 |
| A10 | 1.14794E−14 | 3.73574E−14 | 1.20007E−12 | 1.36630E−12 |
| A12 | −1.96123E−17 | −7.53480E−17 | −5.23473E−15 | −6.38593E−15 |
| A14 | 1.81911E−20 | 8.48844E−20 | 1.15364E−17 | 1.58507E−17 |
| A16 | −1.23654E−23 | −4.45989E−23 | −8.53231E−21 | −1.69005E−20 |
| A18 | 2.16244E−27 | −6.26134E−27 | −9.90443E−24 | −3.43479E−24 |
| A20 | −6.33221E−31 | 1.29953E−29 | 1.46825E−26 | 1.53859E−26 |

| | | |
|---|---|---|
| INF | 2407 mm | 1104 mm |

[Various types of data]

| | | | |
|---|---|---|---|
| Focal length | 131.00 | 127.10 | 118.92 |
| F number | 1.46 | 1.55 | 1.67 |
| Total angle of view 2ω | 18.16 | 16.90 | 15.35 |
| Image height Y | 21.63 | 21.63 | 21.63 |
| Total lens length | 152.55 | 152.55 | 152.55 |

[Variable distance data]

| | | | |
|---|---|---|---|
| d0 | ∞ | 2254.5496 | 951.4780 |
| d16 | 3.2297 | 7.6457 | 14.4546 |
| d18 | 20.3908 | 15.1920 | 7.0477 |
| d21 | 3.1336 | 3.9164 | 5.2518 |
| BF | 0.0000 | 0.0000 | 0.0000 |

[Lens group data]

| Group | Starting surface | Focal length |
|---|---|---|
| G1 | 1 | 93.78 |
| G2 | 17 | −53.35 |
| G3 | 19 | −243.22 |
| G4 | 22 | 55.42 |

### Example 2

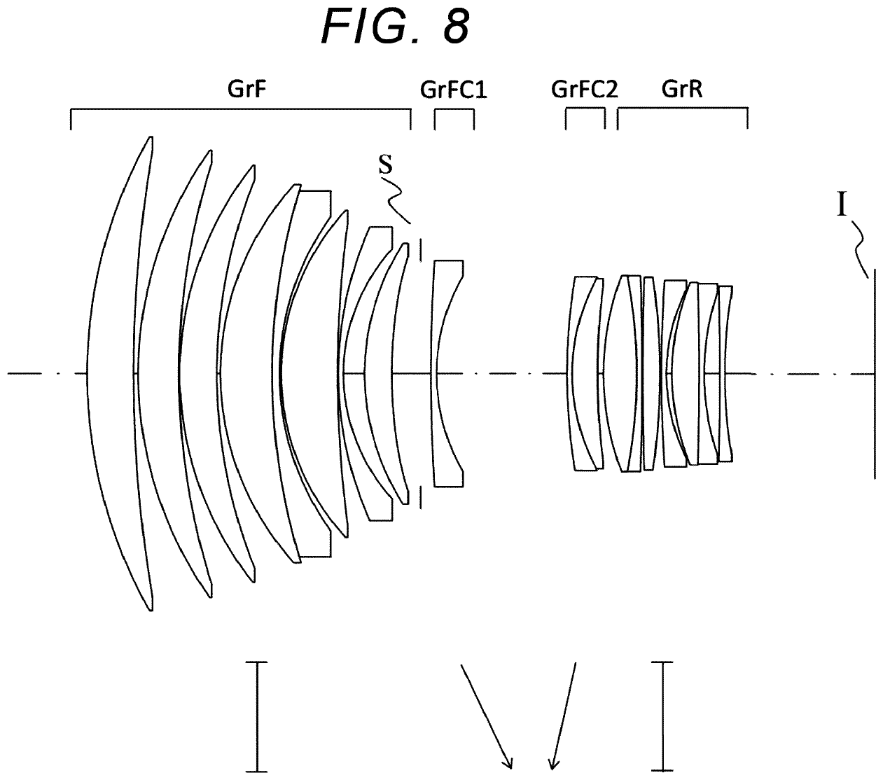

FIG. 8 is a lens configuration diagram of an imaging optical system of Example 2 of the present invention.

The imaging optical system consists of, in order from an object side, a front group GrF having a positive refractive power, a first focus group GrFC1 having a negative refractive power, a second focus group GrFC2 having a negative refractive power, and a rear group GrR having a positive refractive power. During focusing from infinity to a short distance, the front group GrF and the rear group GrR are fixed with respect to an image surface, the first focus group GrFC1 moves to the image side, and the second focus group GrFC2 moves to the object side. The aperture diaphragm S is closer to the object side than the first focus group GrFC1 and is adjacent to the image side of the front group GrF.

The front group GrF consists of: a positive meniscus lens having a convex surface facing the object side, a positive meniscus lens having a convex surface facing the object side, a positive meniscus lens having a convex surface facing the object side, a cemented lens consisting of a positive meniscus lens having a convex surface facing the object side and a negative meniscus lens having a convex surface facing the object side, a positive meniscus lens having a convex surface facing the object side, a negative meniscus lens having a convex surface facing the object side, and a positive meniscus lens having a convex surface facing the object side of which the image side is aspherical.

The first focus group GrFC1 consists of a negative meniscus lens having a convex surface facing the object side. The second focus group GrFC2 consists of a cemented lens consisting of a negative meniscus lens having a convex surface facing the object side and a positive meniscus lens having a convex surface facing the object side.

The rear group GrR consists of: a cemented lens consisting of a biconvex lens and a negative meniscus lens having a concave surface facing the object side, a biconvex lens, a negative meniscus lens having a convex surface facing the object side, a cemented lens consisting of a biconvex lens and a biconcave lens, and a biconcave lens with both surfaces being aspherical.

The specification values of the imaging optical system of Example 2 are shown below.

### Numerical Example 2

Unit: mm
[Surface data]

| Surface number | r | d | nd | vd | PgF |
|---|---|---|---|---|---|
| Object surface | ∞ | (d0) | | | |
| 1 | 99.0044 | 8.9895 | 1.66382 | 27.35 | 0.6319 |
| 2 | 275.8199 | 0.9000 | | | |
| 3 | 79.2910 | 7.8614 | 1.43875 | 94.93 | 0.5340 |
| 4 | 143.0933 | 0.1500 | | | |
| 5 | 68.2459 | 7.2074 | 1.43875 | 94.93 | 0.5340 |
| 6 | 106.3373 | 0.7000 | | | |
| 7 | 57.2459 | 10.0194 | 1.43875 | 94.93 | 0.5340 |
| 8 | 130.9629 | 1.4000 | 1.85451 | 25.15 | 0.6103 |
| 9 | 54.6789 | 0.3469 | | | |
| 10 | 49.1982 | 10.8741 | 1.41390 | 101.00 | 0.5340 |
| 11 | 230.5091 | 0.1500 | | | |
| 12 | 73.5987 | 1.0000 | 1.61396 | 44.29 | 0.5632 |
| 13 | 37.8249 | 4.1109 | | | |
| 14 | 49.3591 | 5.2521 | 1.51633 | 64.06 | 0.5333 |
| 15* | 102.8497 | 5.6239 | | | |
| 16 (Diaphragm) | ∞ | (d16) | | | |
| 17 | 358.7567 | 1.1495 | 1.79450 | 45.39 | 0.5573 |
| 18 | 39.7918 | (d18) | | | |
| 19 | 121.1107 | 1.0000 | 1.85451 | 25.15 | 0.6103 |
| 20 | 40.4772 | 4.9578 | 1.73400 | 51.05 | 0.5500 |
| 21 | 147.3183 | (d21) | | | |
| 22 | 56.8875 | 6.4330 | 1.83481 | 42.74 | 0.5648 |
| 23 | −105.7080 | 1.0000 | 1.64769 | 33.84 | 0.5924 |
| 24 | −614.3093 | 0.1500 | | | |
| 25 | 710.6759 | 3.2898 | 1.75575 | 24.71 | 0.6291 |
| 26 | −140.2399 | 0.3009 | | | |
| 27 | 281.0978 | 1.0000 | 1.77047 | 29.74 | 0.5951 |
| 28 | 39.1480 | 1.0628 | | | |
| 29 | 48.9433 | 5.2291 | 2.00069 | 25.46 | 0.6136 |
| 30 | −602.4094 | 1.0000 | 1.55298 | 55.07 | 0.5447 |
| 31 | 53.4794 | 3.0188 | | | |
| 32 | −610.0402 | 1.0000 | 1.61881 | 63.85 | 0.5417 |
| 33* | 118.7678 | 29.0427 | | | |
| 34 | ∞ | (BF) | | | |
| Image surface | ∞ | | | | |

[Aspherical surface data]

| | Surface 15 | Surface 33 |
|---|---|---|
| K | −0.03770 | 0.64143 |
| A4 | 1.27138E−06 | 2.34001E−06 |
| A6 | 1.65256E−10 | 1.77383E−08 |
| A8 | 7.40117E−13 | −4.98759E−10 |
| A10 | 1.25184E−15 | 7.32541E−12 |
| A12 | −2.49360E−17 | −6.11841E−14 |
| A14 | 1.18756E−19 | 3.06966E−16 |
| A16 | −2.74692E−22 | −9.14836E−19 |
| A18 | 3.16561E−25 | 1.49266E−21 |
| A20 | −1.45036E−28 | −1.02623E−24 |

| | | |
|---|---|---|
| INF | 2416 mm | 1116 mm |

[Various types of data]

| | | | |
|---|---|---|---|
| Focal length | 131.01 | 127.63 | 120.17 |
| F number | 1.46 | 1.55 | 1.69 |
| Total angle of view 2ω | 18.18 | 16.85 | 15.24 |
| Image height Y | 21.63 | 21.63 | 21.63 |
| Total lens length | 152.52 | 152.52 | 152.52 |

[Variable distance data]

| | | | |
|---|---|---|---|
| d0 | ∞ | 2263.9811 | 963.8435 |
| d16 | 1.9171 | 6.5360 | 13.5680 |
| d18 | 25.2309 | 17.4773 | 5.6327 |
| d21 | 1.1500 | 4.2847 | 9.0973 |
| BF | 0.0000 | 0.0000 | 0.0000 |

[Lens group data]

| Group | Starting surface | Focal length |
|---|---|---|
| G1 | 1 | 96.15 |
| G2 | 17 | −56.42 |
| G3 | 19 | −1226.37 |
| G4 | 22 | 70.77 |

### Example 3

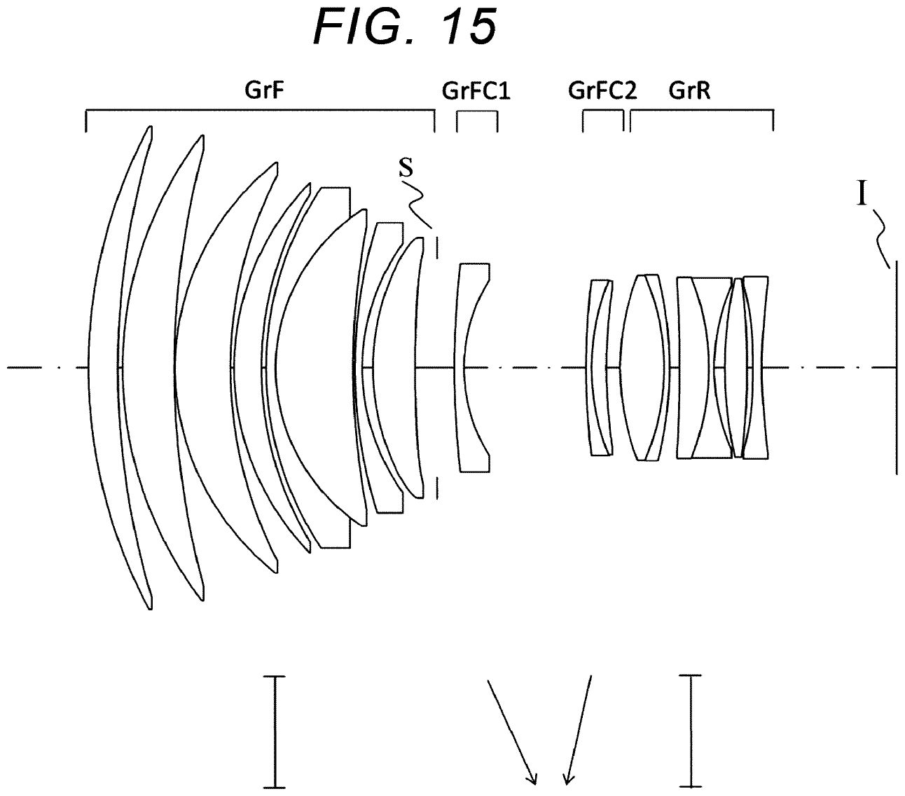

FIG. 15 is a lens configuration diagram of the imaging optical system of Example 3 of the present invention.

The imaging optical system consists of, in order from an object side, a front group GrF having a positive refractive power, a first focus group GrFC1 having a negative refractive power, a second focus group GrFC2 having a negative refractive power, and a rear group GrR having a positive refractive power. During focusing from infinity to a short distance, the front group GrF and the rear group GrR are fixed with respect to an image surface, the first focus group GrFC1 moves to the image side, and the second focus group GrFC2 moves to the object side. The aperture diaphragm S is closer to the object side than the first focus group GrFC1 and is adjacent to the image side of the front group GrF.

The front group GrF consists of: a positive meniscus lens having a convex surface facing the object side, a positive meniscus lens having a convex surface facing the object side, a positive meniscus lens having a convex surface facing the object side, a positive meniscus lens having a convex surface facing the object side, a cemented lens consisting of a negative meniscus lens having a convex surface facing the object side and a positive meniscus lens having a convex surface facing the object side, a negative meniscus lens having a convex surface facing the object side, and a positive meniscus lens having a convex surface facing the object side with both surfaces being aspherical.

The first focus group GrFC1 consists of a negative meniscus lens having a convex surface facing the object side. The second focus group GrFC2 consists of a cemented lens consisting of a negative meniscus lens having a convex surface facing the object side and a positive meniscus lens having a convex surface facing the object side.

The rear group GrR consists of: a cemented lens consisting of a biconvex lens and a negative meniscus lens having a concave surface facing the object side, a cemented lens consisting of a positive meniscus lens having a concave surface facing the object side and a biconcave lens, a biconvex lens, and a biconcave lens with both surfaces being aspherical.

The specification values of the imaging optical system of Example 3 are shown below.

### Numerical Example 3

Unit: mm
[Surface data]

| Surface number | r | d | nd | vd | PgF |
|---|---|---|---|---|---|
| Object surface | ∞ | (d0) | | | |
| 1 | 103.3435 | 5.5538 | 1.92286 | 20.88 | 0.6390 |
| 2 | 161.0655 | 0.9000 | | | |
| 3 | 77.0591 | 9.7648 | 1.43700 | 95.10 | 0.5336 |
| 4 | 168.4322 | 0.1500 | | | |
| 5 | 52.0438 | 10.4235 | 1.43700 | 95.10 | 0.5336 |
| 6 | 84.8612 | 0.7000 | | | |
| 7 | 53.1002 | 5.1440 | 1.43700 | 95.10 | 0.5336 |
| 8 | 67.7652 | 0.9117 | | | |
| 9 | 64.9764 | 1.7957 | 1.91082 | 35.25 | 0.5822 |
| 10 | 37.5703 | 14.6524 | 1.43700 | 95.10 | 0.5336 |
| 11 | 150.4466 | 0.3510 | | | |
| 12 | 97.9636 | 1.3856 | 1.85451 | 25.15 | 0.6103 |
| 13 | 42.5866 | 2.0107 | | | |
| 14* | 46.2188 | 8.0354 | 1.58313 | 59.46 | 0.5405 |
| 15* | 310.7091 | 4.1034 | | | |
| 16 (Diaphragm) | ∞ | (d16) | | | |
| 17 | 184.7642 | 1.8204 | 1.80420 | 46.50 | 0.5573 |
| 18 | 33.2414 | (d18) | | | |
| 19 | 152.5868 | 1.0000 | 1.85451 | 25.15 | 0.6103 |
| 20 | 46.7545 | 2.7991 | 1.69560 | 59.05 | 0.5433 |
| 21 | 109.1983 | (d21) | | | |
| 22 | 51.0087 | 8.3471 | 1.78800 | 47.37 | 0.5559 |
| 23 | −46.7892 | 1.0000 | 1.94594 | 17.98 | 0.6546 |
| 24 | −76.7937 | 1.9277 | | | |
| 25 | −277.9678 | 5.4917 | 1.86966 | 20.02 | 0.6435 |
| 26 | −48.6253 | 1.0000 | 1.6956 | 59.05 | 0.5433 |
| 27 | 41.2579 | 2.0306 | | | |
| 28 | 83.1598 | 4.1749 | 1.84666 | 23.78 | 0.6192 |
| 29 | −145.9364 | 1.0622 | | | |
| 30* | −250.0000 | 1.6475 | 1.58313 | 59.46 | 0.5405 |
| 31* | 61.2381 | 25.5768 | | | |
| 32 | ∞ | (BF) | | | |
| Image surface | ∞ | | | | |

[Aspherical surface data]

| | Surface 14 | Surface 15 | Surface 30 | Surface 31 |
|---|---|---|---|---|
| K | 2.02860 | −10.00000 | −10.00000 | 0.42030 |
| A4 | −3.23272E−06 | 1.21155E−06 | −5.09210E−05 | −5.12445E−05 |
| A6 | −5.55679E−09 | −5.90760E−09 | 3.05654E−07 | 3.22572E−07 |
| A8 | 2.84738E−11 | 8.73348E−11 | −1.31062E−09 | −1.30463E−09 |
| A10 | −1.60092E−13 | −6.26656E−13 | 4.27910E−12 | 1.60004E−12 |
| A12 | 4.89429E−16 | 2.77445E−15 | −1.75667E−14 | 1.92847E−14 |
| A14 | −8.87246E−19 | −7.59718E−18 | 1.02520E−16 | −1.40639E−16 |
| A16 | 8.78396E−22 | 1.27144E−20 | −4.33916E−19 | 4.48114E−19 |
| A18 | −3.76714E−25 | −1.19226E−23 | 9.77391E−22 | −7.12996E−22 |
| A20 | 5.71335E−30 | 4.85129E−27 | −8.91100E−25 | 4.51224E−25 |

| | | |
|---|---|---|
| INF | 2613 mm | 1264 mm |

[Various types of data]

| | | | |
|---|---|---|---|
| Focal length | 149.94 | 140.86 | 129.11 |
| F number | 1.67 | 1.75 | 1.85 |
| Total angle of view 2ω | 15.89 | 14.96 | 13.94 |
| Image height Y | 21.63 | 21.63 | 21.63 |
| Total lens length | 152.70 | 152.70 | 152.70 |

[Variable distance data]

| | | | |
|---|---|---|---|
| d0 | ∞ | 2460.4445 | 1110.9642 |
| d16 | 3.2316 | 7.1273 | 12.3538 |
| d18 | 23.0966 | 16.9897 | 9.1058 |
| d21 | 2.6077 | 4.8189 | 7.4763 |
| BF | 0.0000 | 0.0000 | 0.0000 |

[Lens group data]

| Group | Starting surface | Focal length |
|---|---|---|
| G1 | 1 | 89.53 |
| G2 | 17 | −50.67 |
| G3 | 19 | −242.96 |
| G4 | 22 | 69.90 |

### Example 4

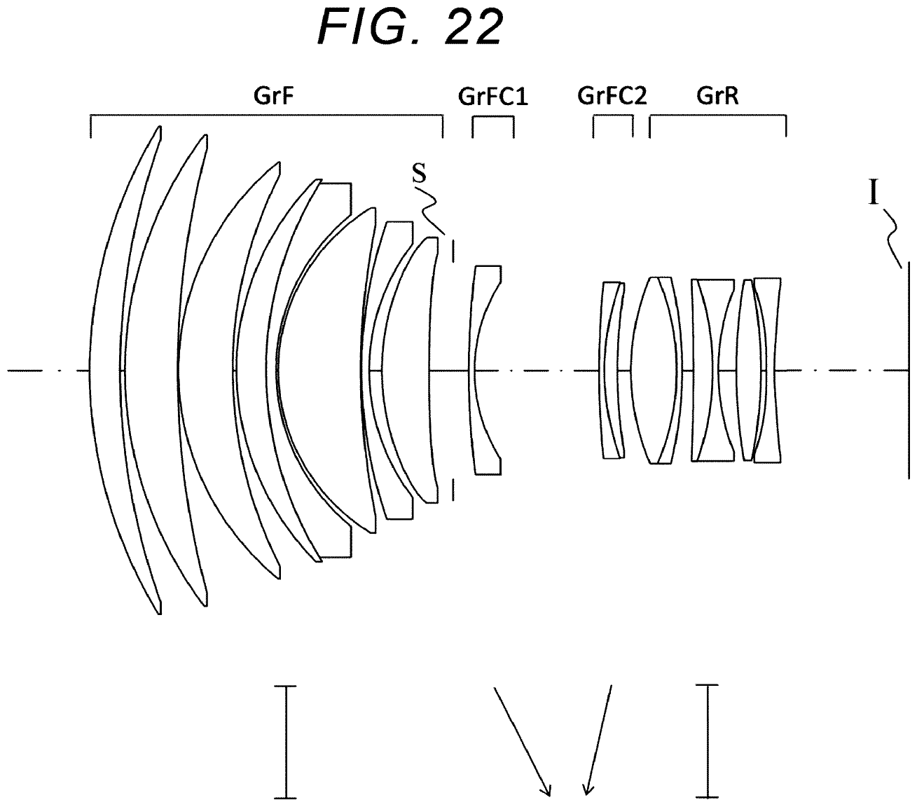

FIG. 22 is a lens configuration diagram of the imaging optical system of Example 4 of the present invention.

The imaging optical system consists of, in order from an object side, a front group GrF having a positive refractive power, a first focus group GrFC1 having a negative refractive power, a second focus group GrFC2 having a negative refractive power, and a rear group GrR having a positive refractive power. During focusing from infinity to a short distance, the front group GrF and the rear group GrR are fixed with respect to an image surface, the first focus group GrFC1 moves to the image side, and the second focus group GrFC2 moves to the object side. The aperture diaphragm S is closer to the object side than the first focus group GrFC1 and is adjacent to the image side of the front group GrF.

The front group GrF consists of: a positive meniscus lens having a convex surface facing the object side, a positive meniscus lens having a convex surface facing the object side, a positive meniscus lens having a convex surface facing the object side, a cemented lens consisting of a positive meniscus lens having a convex surface facing the object side and a negative meniscus lens having a convex surface facing the object side, a positive meniscus lens having a convex surface facing the object side, a negative meniscus lens having a convex surface facing the object side, and a positive meniscus lens having a convex surface facing the object side with both surfaces being aspherical.

The first focus group GrFC1 consists of a negative meniscus lens having a convex surface facing the object side. The second focus group GrFC2 consists of a cemented lens consisting of a negative meniscus lens having a convex surface facing the object side and a positive meniscus lens having a convex surface facing the object side.

The rear group GrR consists of: a cemented lens of a biconvex lens and a negative meniscus lens having a concave surface facing the object side, a cemented lens of a positive meniscus lens having a concave surface facing the object side and a biconcave lens, a biconvex lens, and a biconcave lens with both surfaces being aspherical.

The specification values of the imaging optical system of Example 4 are shown below.

### Numerical Example 4

Unit: mm
[Surface data]

| Surface number | r | d | nd | vd | PgF |
|---|---|---|---|---|---|
| Object surface | ∞ | (d0) | | | |
| 1 | 93.5994 | 5.6231 | 1.92286 | 20.88 | 0.6390 |
| 2 | 137.1048 | 0.9000 | | | |
| 3 | 78.0596 | 9.7674 | 1.43700 | 95.10 | 0.5336 |
| 4 | 173.1160 | 0.1500 | | | |
| 5 | 53.1074 | 10.0819 | 1.43700 | 95.10 | 0.5336 |
| 6 | 86.1298 | 0.7000 | | | |
| 7 | 53.8322 | 5.5180 | 1.43700 | 95.10 | 0.5336 |
| 8 | 70.9567 | 1.8385 | 1.91082 | 35.25 | 0.5822 |
| 9 | 39.6300 | 0.4210 | | | |
| 10 | 37.3994 | 15.3049 | 1.43700 | 95.10 | 0.5336 |
| 11 | 144.0812 | 0.1500 | | | |
| 12 | 90.4927 | 1.4011 | 1.85451 | 25.15 | 0.6103 |
| 13 | 41.2699 | 2.3601 | | | |
| 14* | 45.6988 | 8.7810 | 1.58313 | 59.46 | 0.5405 |
| 15* | 304.0931 | 4.4944 | | | |
| 16 (Diaphragm) | ∞ | (d16) | | | |
| 17 | 174.1348 | 1.0000 | 1.78800 | 47.49 | 0.5538 |
| 18 | 32.5156 | (d18) | | | |
| 19 | 177.5661 | 1.0000 | 1.85451 | 25.15 | 0.6103 |
| 20 | 49.9043 | 2.4637 | 1.72916 | 54.67 | 0.5453 |
| 21 | 101.5570 | (d21) | | | |
| 22 | 47.5761 | 8.4813 | 1.78800 | 47.37 | 0.5559 |
| 23 | −47.5761 | 1.0000 | 1.94594 | 17.98 | 0.6546 |
| 24 | −79.1616 | 2.0723 | | | |
| 25 | −431.8297 | 3.6105 | 1.86966 | 20.02 | 0.6435 |
| 26 | −54.7382 | 1.0000 | 1.72916 | 54.09 | 0.5448 |
| 27 | 43.7207 | 3.3767 | | | |
| 28 | 105.8545 | 4.5374 | 1.84666 | 23.78 | 0.6192 |
| 29 | −88.5583 | 1.0500 | | | |
| 30* | −250.0000 | 1.4272 | 1.58313 | 59.46 | 0.5405 |
| 31* | 49.5458 | 25.0127 | | | |
| 32 | ∞ | (BF) | | | |
| Image surface | ∞ | | | | |

[Aspherical surface data]

| | Surface 14 | Surface 15 | Surface 30 | Surface 31 |
|---|---|---|---|---|
| K | 1.79750 | −2.36320 | −7.77100 | −3.04810 |
| A4 | −3.52121E−06 | 8.98550E−07 | −9.48206E−05 | −9.25107E−05 |
| A6 | −1.67709E−09 | 2.36341E−09 | 8.34231E−07 | 8.62111E−07 |
| A8 | −4.93188E−12 | −1.10409E−11 | −5.78560E−09 | −6.04752E−09 |
| A10 | 1.34466E−14 | 7.84706E−14 | 3.06961E−11 | 3.21599E−11 |
| A12 | −2.77961E−17 | −2.91780E−16 | −1.17040E−13 | −1.20295E−13 |
| A14 | 2.16525E−20 | 6.86137E−19 | 2.95287E−16 | 2.91816E−16 |
| A16 | 1.56068E−23 | −8.53334E−22 | −4.31117E−19 | −4.02949E−19 |
| A18 | −3.41168E−26 | 4.33770E−25 | 2.61097E−22 | 2.29755E−22 |
| A20 | 1.18147E−29 | 4.23642E−29 | 2.48386E−26 | 1.55147E−26 |

| | | |
|---|---|---|
| INF | 2613 mm | 1260 mm |

[Various types of data]

| | | | |
|---|---|---|---|
| Focal length | 149.90 | 140.65 | 128.85 |
| F number | 1.67 | 1.75 | 1.85 |
| Total angle of view 2ω | 15.94 | 15.00 | 13.97 |
| Image height Y | 21.63 | 21.63 | 21.63 |
| Total lens length | 152.00 | 152.00 | 152.00 |

[Variable distance data]

| | | | |
|---|---|---|---|
| d0 | ∞ | 2461.5020 | 1107.8887 |
| d16 | 2.9010 | 6.7822 | 12.0106 |
| d18 | 23.0721 | 16.9963 | 9.1708 |
| d21 | 2.5000 | 4.6946 | 7.2917 |
| BF | 0.0000 | 0.0000 | 0.0000 |

[Lens group data]

| Group | Starting surface | Focal length |
|---|---|---|
| G1 | 1 | 88.95 |
| G2 | 17 | −50.90 |
| G3 | 19 | −207.02 |
| G4 | 22 | 67.52 |

### Example 51

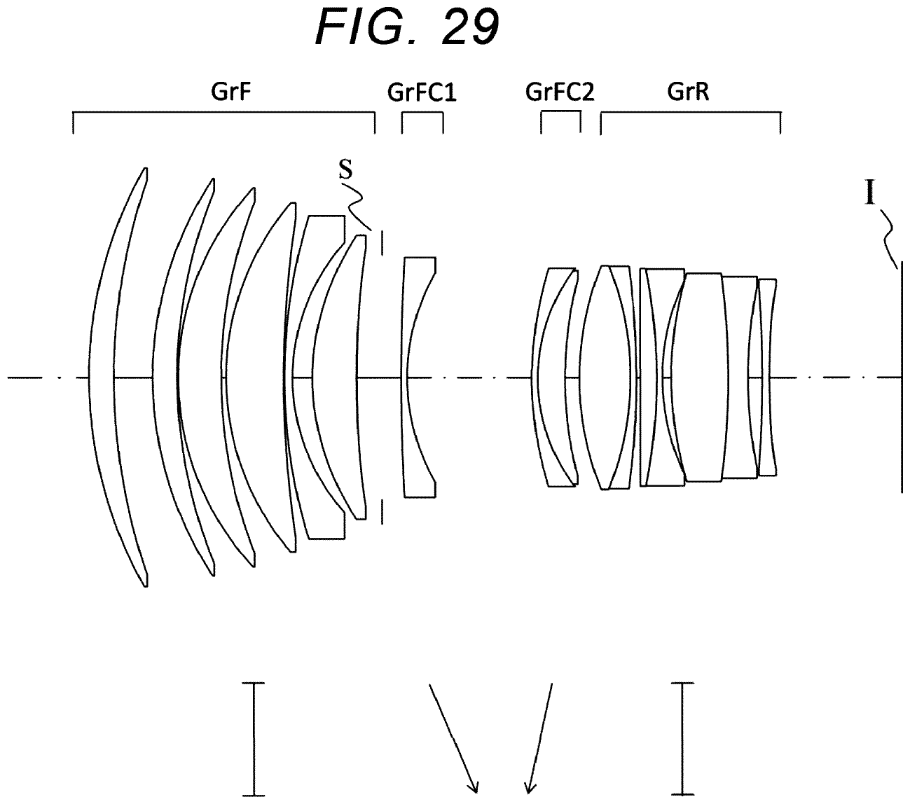

FIG. 29 is a lens configuration diagram of the imaging optical system of Example 5 of the present invention.

The imaging optical system consists of, in order from an object side, a front group GrF having a positive refractive power, a first focus group GrFC1 having a negative refractive power, a second focus group GrFC2 having a negative refractive power, and a rear group GrR having a positive refractive power. During focusing from infinity to a short distance, the front group GrF and the rear group GrR are fixed with respect to an image surface, the first focus group GrFC1 moves to the image side, and the second focus group GrFC2 moves to the object side. The aperture diaphragm S is closer to the object side than the first focus group GrFC1 and is adjacent to the image side of the front group GrF.

The front group GrF consists of: a positive meniscus lens having a convex surface facing the object side, a positive meniscus lens having a convex surface facing the object side, a positive meniscus lens having a convex surface facing the object side, a positive meniscus lens having a convex surface facing the object side, a negative meniscus lens having a convex surface facing the object side, and a positive meniscus lens having a convex surface facing the object side with both surfaces being aspherical.

The first focus group GrFC1 consists of a negative meniscus lens having a convex surface facing the object side. The second focus group GrFC2 consists of a cemented lens consisting of a negative meniscus lens having a convex surface facing the object side and a positive meniscus lens having a convex surface facing the object side.

The rear group GrR consists of: a cemented lens consisting of a biconvex lens and a negative meniscus lens having a concave surface facing the object side, a cemented lens consisting of a plano convex lens having a plane surface on the object side and a biconcave lens, a cemented lens consisting of a biconvex lens and a biconcave lens, and a biconcave lens with both surfaces being aspherical.

The specification values of the imaging optical system of Example 5 are shown below.

### Numerical Example 5

Unit: mm
[Surface data]

| Surface number | r | d | nd | vd | PgF |
|---|---|---|---|---|---|
| Object surface | ∞ | (d0) | | | |
| 1 | 79.2829 | 4.3754 | 1.86966 | 20.02 | 0.6435 |
| 2 | 113.1682 | 6.8230 | | | |
| 3 | 66.9474 | 4.3006 | 1.43700 | 95.10 | 0.5336 |
| 4 | 91.0285 | 0.1500 | | | |
| 5 | 51.4425 | 7.5633 | 1.43700 | 95.10 | 0.5336 |
| 6 | 88.8321 | 0.8857 | | | |
| 7 | 49.9466 | 10.1229 | 1.43700 | 95.10 | 0.5336 |
| 8 | 195.6781 | 0.1500 | | | |
| 9 | 102.7611 | 1.4307 | 1.85451 | 25.15 | 0.6103 |
| 10 | 37.5345 | 3.4927 | | | |
| 11* | 45.3817 | 7.7806 | 1.58313 | 59.46 | 0.5405 |
| 12* | 213.6895 | 4.4492 | | | |
| 13 (Diaphragm) | ∞ | (d13) | | | |
| 14 | 397.0747 | 1.0723 | 1.75500 | 52.32 | 0.5473 |
| 15 | 39.1975 | (d15) | | | |
| 16 | 68.2668 | 1.0000 | 1.85451 | 25.15 | 0.6103 |
| 17 | 33.1111 | 4.8280 | 1.72916 | 54.54 | 0.5453 |
| 18 | 73.6553 | (d18) | | | |
| 19 | 55.4502 | 9.0071 | 1.88300 | 40.81 | 0.5656 |
| 20 | −55.4502 | 1.0000 | 1.76634 | 35.82 | 0.5792 |
| 21 | −163.5595 | 0.7000 | | | |
| 22 | ∞ | 2.8973 | 1.94594 | 17.98 | 0.6546 |
| 23 | 102.8618 | 1.0000 | 1.62004 | 36.30 | 0.5873 |
| 24 | 41.8335 | 1.5778 | | | |
| 25 | 67.5281 | 10.0004 | 2.00100 | 29.13 | 0.5995 |
| 26 | −141.9230 | 3.4754 | 1.85451 | 25.15 | 0.6103 |
| 27 | 88.5197 | 2.4835 | | | |
| 28* | −250.0000 | 1.3000 | 1.58313 | 59.46 | 0.5405 |
| 29* | 175.4586 | 23.3421 | | | |
| 30 | ∞ | (BF) | | | |
| Image surface | ∞ | | | | |

[Aspherical surface data]

| | Surface 11 | Surface 12 | Surface 28 | Surface 29 |
|---|---|---|---|---|
| K | 1.00180 | 8.09720 | 10.00000 | −10.00000 |
| A4 | −1.77279E−06 | 8.26044E−07 | −1.26766E−06 | 2.93105E−06 |
| A6 | −9.23350E−10 | 4.54775E−10 | −4.47789E−08 | −4.36900E−08 |
| A8 | −7.82234E−13 | −3.20674E−13 | 8.52528E−10 | 7.93111E−10 |
| A10 | −4.95720E−15 | −9.69925E−15 | −7.05140E−12 | −5.91265E−12 |
| A12 | 1.70226E−17 | 4.98971E−17 | 3.34772E−14 | 2.53749E−14 |
| A14 | −3.51790E−20 | −1.13255E−19 | −9.26558E−17 | −6.33552E−17 |
| A16 | 4.11257E−23 | 1.33337E−22 | 1.34406E−19 | 8.24720E−20 |
| A18 | −3.13486E−26 | −8.12482E−26 | −6.81711E−23 | −3.48857E−23 |
| A20 | 1.07545E−29 | 2.09172E−29 | −2.06887E−26 | −1.54335E−26 |

| | | |
|---|---|---|
| INF | 2402 mm | 1000 mm |

[Various types of data]

| | | | |
|---|---|---|---|
| Focal length | 105.01 | 103.34 | 98.78 |
| F number | 1.46 | 1.53 | 1.65 |
| Total angle of view 2ω | 22.63 | 21.36 | 19.44 |
| Image height Y | 21.63 | 21.63 | 21.63 |
| Total lens length | 143.06 | 143.06 | 143.06 |

[Variable distance data]

| | | | |
|---|---|---|---|
| d0 | ∞ | 2258.8035 | 856.9770 |
| d13 | 3.4250 | 6.9548 | 13.3690 |
| d15 | 21.9305 | 16.8372 | 6.9610 |
| d18 | 2.5000 | 4.0635 | 7.5255 |
| BF | 0.0001 | 0.0000 | 0.0000 |

[Lens group data]

| Group | Starting surface | Focal length |
|---|---|---|
| G1 | 1 | 85.30 |
| G2 | 14 | −57.68 |
| G3 | 16 | −1199.53 |
| G4 | 19 | 64.33 |

### Example 6

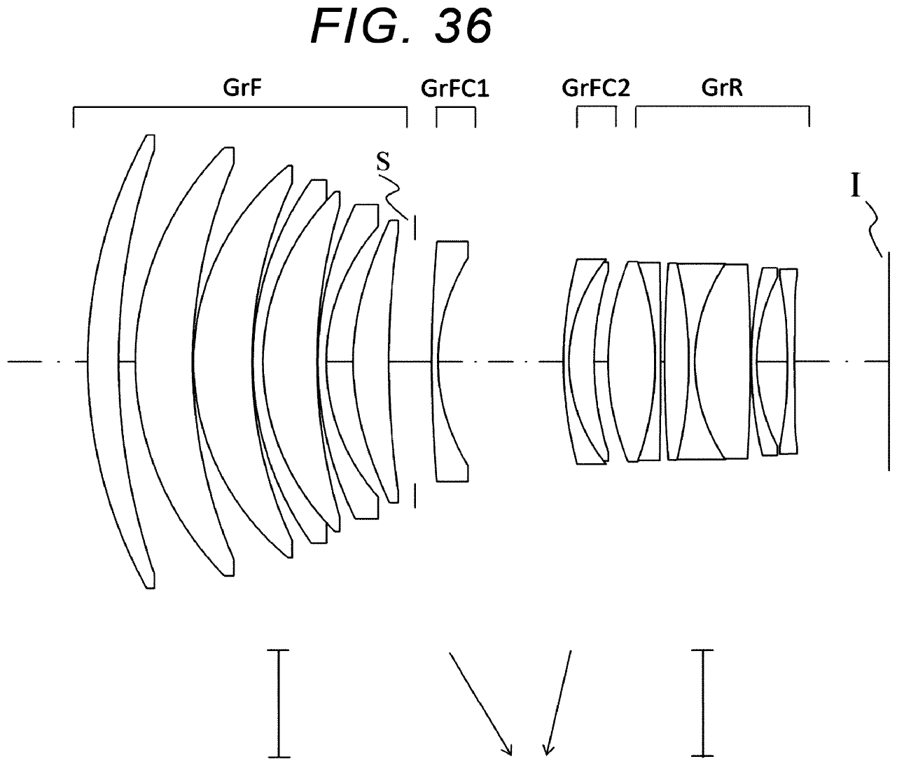

FIG. 36 is a lens configuration diagram of the imaging optical system of Example 6 of the present invention.

The imaging optical system consists of, in order from an object side, a front group GrF having a positive refractive power, a first focus group GrFC1 having a negative refractive power, a second focus group GrFC2 having a negative refractive power, and a rear group GrR having a positive refractive power. During focusing from infinity to a short distance, the front group GrF and the rear group GrR are fixed with respect to an image surface, the first focus group GrFC1 moves to the image side, and the second focus group GrFC2 moves to the object side. The aperture diaphragm S is closer to the object side than the first focus group GrFC1 and is adjacent to the image side of the front group GrF.

The front group GrF consists of: a positive meniscus lens having a convex surface facing the object side, a positive meniscus lens having a convex surface facing the object side, a positive meniscus lens having a convex surface facing the object side, a cemented lens consisting of a negative meniscus lens having a convex surface facing the object side and a positive meniscus lens having a convex surface facing the object side, a negative meniscus lens having a convex surface facing the object side, and a positive meniscus lens having a convex surface facing the object side with both surfaces being aspherical.

The first focus group GrFC1 consists of a negative meniscus lens having a convex surface facing the object side. The second focus group GrFC2 consists of a cemented lens consisting of a negative meniscus lens having a convex surface facing the object side and a positive meniscus lens having a convex surface facing the object side.

The rear group GrR consists of: a cemented lens consisting of a biconvex lens and a negative meniscus lens having a concave surface facing the object side, a three-element cemented lens consisting of a biconvex lens, a biconcave lens, and a biconvex lens, a negative meniscus lens having a convex surface facing the object side, and a biconcave lens with both surfaces being aspherical.

The specification values of the imaging optical system of Example 6 are shown below.

### Numerical Example 6

Unit: mm
[Surface data]

| Surface number | r | d | nd | vd | PgF |
|---|---|---|---|---|---|
| Object surface | ∞ | (d0) | | | |
| 1 | 95.4797 | 5.5344 | 1.86966 | 20.02 | 0.6435 |
| 2 | 133.2202 | 3.0336 | | | |
| 3 | 61.2721 | 10.3208 | 1.43875 | 94.93 | 0.5340 |
| 4 | 102.0569 | 0.1500 | | | |
| 5 | 50.4753 | 10.5422 | 1.43875 | 94.93 | 0.5340 |
| 6 | 85.7739 | 0.1500 | | | |
| 7 | 63.3681 | 1.8348 | 1.85451 | 25.15 | 0.6103 |
| 8 | 47.8997 | 9.7545 | 1.48071 | 85.29 | 0.5362 |
| 9 | 111.7931 | 0.1500 | | | |
| 10 | 71.4948 | 1.5001 | 1.85451 | 25.15 | 0.6103 |
| 11 | 41.0099 | 4.8621 | | | |
| 12* | 51.5620 | 6.442 | 1.58313 | 59.46 | 0.5405 |
| 13* | 173.4270 | 4.7640 | | | |
| 14 (Diaphragm) | ∞ | (d14) | | | |
| 15 | 282.9460 | 1.1353 | 1.72916 | 54.54 | 0.5453 |
| 16 | 39.6021 | (d16) | | | |
| 17 | 80.6881 | 1.0000 | 1.84666 | 23.78 | 0.6192 |
| 18 | 32.7041 | 4.5011 | 1.88300 | 40.76 | 0.5667 |
| 19 | 61.3835 | (d19) | | | |
| 20 | 53.0034 | 8.5383 | 1.91082 | 35.25 | 0.5833 |
| 21 | −60.1640 | 1.0000 | 1.85451 | 25.15 | 0.6103 |
| 22 | −1320.5297 | 0.7000 | | | |
| 23 | 268.7319 | 4.3654 | 1.94594 | 17.98 | 0.6546 |
| 24 | −85.2300 | 1.0851 | 1.80518 | 25.46 | 0.6157 |
| 25 | 35.3252 | 10.0000 | 2.00100 | 29.13 | 0.5995 |
| 26 | −314.5307 | 0.1500 | | | |
| 27 | 82.2952 | 1.0000 | 1.83400 | 37.17 | 0.5786 |
| 28 | 37.6997 | 5.5244 | | | |
| 29* | −250.0000 | 1.3000 | 1.68948 | 31.02 | 0.5987 |
| 30* | 174.6078 | 17.0565 | | | |
| 31 | ∞ | (BF) | | | |
| Image surface | ∞ | | | | |

[Aspherical surface data]

| | Surface 12 | Surface 13 | Surface 29 | Surface 30 |
|---|---|---|---|---|
| K | 1.92920 | −9.39400 | 10.00000 | −3.01790 |
| A4 | −3.41133E−06 | −1.27223E−07 | −4.49428E−05 | −3.97507E−05 |
| A6 | −5.94524E−10 | 6.15072E−11 | 2.86365E−07 | 2.75666E−07 |
| A8 | .1.27268E−11 | −5.93579E−13 | −1.43619E−09 | −1.24380E−09 |
| A10 | 4.08832E−14 | −2.05725E−15 | 6.06628E−12 | 5.05384E−12 |
| A12 | −8.26804E−17 | 1.45244E−17 | −1.49045E−14 | −1.24553E−14 |
| A14 | 8.10711E−20 | −2.95980E−20 | 1.02833E−17 | 1.02249E−17 |
| A16 | −2.63508E−23 | 3.07995E−23 | 2.78454E−20 | 1.91594E−20 |
| A18 | −1.00531E−26 | −1.63454E−26 | −5.25351E−23 | −4.05024E−23 |
| A20 | 3.03945E−30 | 5.21606E−30 | 2.30083E−26 | 1.49020E−26 |

| | | |
|---|---|---|
| INF | 2012 mm | 1100 mm |

[Various types of data]

| | | | |
|---|---|---|---|
| Focal length | 101.18 | 99.78 | 96.96 |
| F number | 1.24 | 1.31 | 1.39 |
| Total angle of view 2ω | 23.59 | 21.82 | 20.24 |
| Image height Y | 21.63 | 21.63 | 21.63 |
| Total lens length | 144.45 | 144.45 | 144.45 |

[Variable distance data]

| | | | |
|---|---|---|---|
| d0 | ∞ | 1867.7915 | 955.8456 |
| d14 | 2.9439 | 8.2987 | 13.9994 |
| d16 | 22.6069 | 15.1736 | 7.4213 |
| d19 | 2.5000 | 4.5785 | 6.6301 |
| BF | 0.0000 | 0.0000 | 0.0000 |

[Lens group data]

| Group | Starting surface | Focal length |
|---|---|---|
| G1 | 1 | 92.68 |
| G2 | 15 | −63.28 |
| G3 | 17 | −433.52 |
| G4 | 20 | 53.82 |

### Example 7

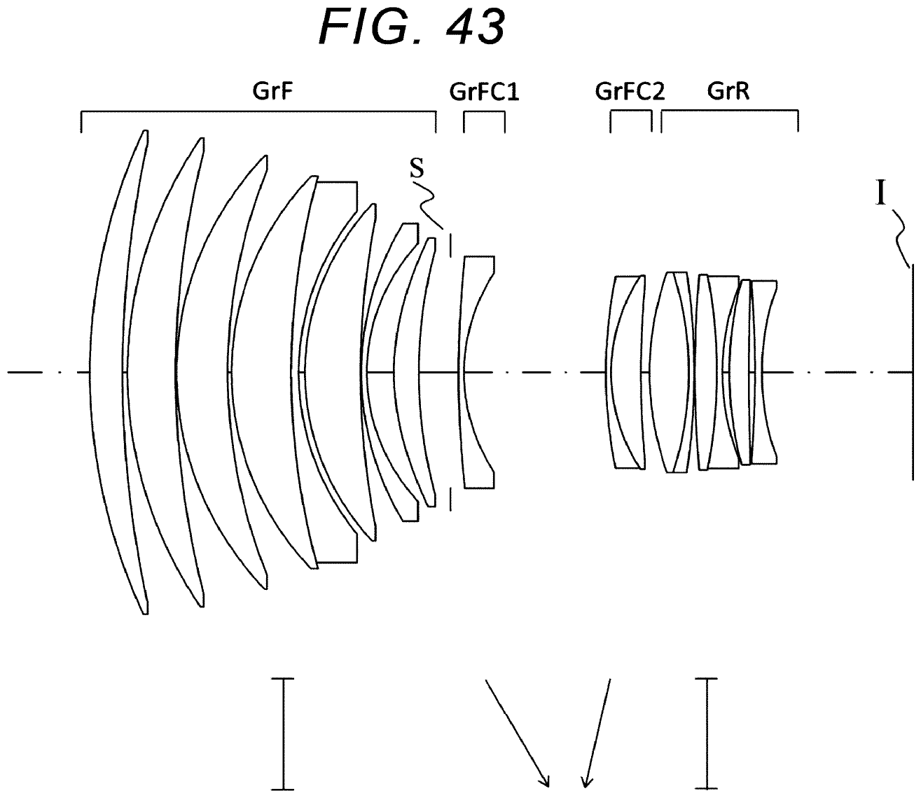

FIG. 43 is a lens configuration diagram of the imaging optical system of Example 7 of the present invention.

The imaging optical system consists of, in order from an object side, a front group GrF having a positive refractive power, a first focus group GrFC1 having a negative refractive power, a second focus group GrFC2 having a positive refractive power, and a rear group GrR having a positive refractive power. During focusing from infinity to a short distance, the front group GrF and the rear group GrR are fixed with respect to an image surface, the first focus group GrFC1 moves to the image side, and the second focus group GrFC2 moves to the object side. The aperture diaphragm is closer to the object side than the first focus group GrFC1 and is adjacent to the image side of the front group GrF.

The front group GrF consists of: a positive meniscus lens having a convex surface facing the object side, a positive meniscus lens having a convex surface facing the object side, a positive meniscus lens having a convex surface facing the object side, a cemented lens consisting of a positive meniscus lens having a convex surface facing the object side and a negative meniscus lens having a convex surface facing the object side, a positive meniscus lens having a convex surface facing the object side, a negative meniscus lens having a convex surface facing the object side, and a positive meniscus lens having a convex surface facing the object side of which the object side is aspherical.

The first focus group GrFC1 consists of a negative meniscus lens having a convex surface facing the object side. The second focus group GrFC2 consists of a cemented lens consisting of a negative meniscus lens having a convex surface facing the object side and a positive meniscus lens having a convex surface facing the object side.

The rear group GrR consists of: a cemented lens consisting of a biconvex lens and a negative meniscus lens having a concave surface facing the object side, a cemented lens consisting of a biconvex lens and a biconcave lens, a positive meniscus lens having a convex surface facing the object side, and a biconcave lens with both surfaces being aspherical.

The specification values of the imaging optical system of Example 7 are shown below.

### Numerical Example 7

Unit: mm
[Surface data]

| Surface number | r | d | nd | vd | PgF |
|---|---|---|---|---|---|
| Object surface | ∞ | (d0) | | | |
| 1 | 117.1854 | 6.0439 | 1.66382 | 27.35 | 0.6319 |
| 2 | 219.8859 | 0.9000 | | | |
| 3 | 83.9403 | 8.9280 | 1.43875 | 94.93 | 0.5340 |
| 4 | 181.6874 | 0.1500 | | | |
| 5 | 62.7203 | 9.5014 | 1.43875 | 94.93 | 0.5340 |
| 6 | 110.0951 | 0.7000 | | | |
| 7 | 56.9619 | 11.0980 | 1.43875 | 94.93 | 0.5340 |
| 8 | 149.8895 | 1.4000 | 1.85451 | 25.15 | 0.6103 |
| 9 | 51.4599 | 1.1486 | | | |
| 10 | 49.6799 | 10.2920 | 1.62200 | 30.66 | 0.6248 |
| 11 | 164.2884 | 0.1500 | | | |
| 12 | 58.6208 | 1.0000 | 1.78880 | 28.42 | 0.6006 |
| 13 | 38.0999 | 5.0485 | | | |
| 14* | 51.5388 | 4.5941 | 1.51633 | 64.06 | 0.5333 |
| 15 | 94.8428 | 5.8668 | | | |
| 16 (Diaphragm) | ∞ | (d16) | | | |
| 17 | 224.7265 | 1.0000 | 1.74100 | 52.60 | 0.5479 |
| 18 | 36.6111 | (d18) | | | |
| 19 | 96.6402 | 1.0000 | 1.85451 | 25.15 | 0.6103 |
| 20 | 35.6456 | 5.4861 | 1.69930 | 51.11 | 0.5552 |
| 21 | 195.0162 | (d21) | | | |
| 22 | 59.6636 | 7.3150 | 1.90525 | 35.04 | 0.5848 |
| 23 | −67.1153 | 1.0000 | 1.68948 | 31.02 | 0.5987 |
| 24 | −138.1863 | 0.1500 | | | |
| 25 | 230.2066 | 4.0647 | 1.75575 | 24.71 | 0.6291 |
| 26 | −103.7723 | 1.0000 | 1.80000 | 29.84 | 0.6017 |
| 27 | 47.5951 | 1.2986 | | | |
| 28 | 72.1163 | 3.6533 | 2.00069 | 25.46 | 0.6136 |
| 29 | 566.2945 | 1.0892 | | | |
| 30* | −202.7038 | 1.2934 | 1.59201 | 67.02 | 0.5358 |
| 31* | 55.8077 | 27.9878 | | | |
| 32 | ∞ | (BF) | | | |
| Image surface | ∞ | | | | |

[Aspherical surface data]

| | Surface 14 | Surface 30 | Surface 31 |
|---|---|---|---|
| K | −2.11020 | 0.00000 | 0.00000 |
| A4 | 8.15788E−07 | 9.53113E−07 | 2.86068E−06 |
| A6 | −7.29072E−10 | −4.20498E−10 | 2.14870E−09 |
| A8 | −1.51252E−13 | 1.85536E−12 | −6.10211E−12 |
| A10 | −2.09038E−16 | −1.04797E−14 | 2.97471E−14 |
| A12 | 8.41382E−19 | 9.22872E−17 | 5.85940E−17 |
| A14 | −2.04017E−21 | −4.89598E−19 | −6.01301E−19 |
| A16 | 2.93769E−24 | 1.54242E−21 | 1.95077E−21 |
| A18 | −2.31344E−27 | −2.65755E−24 | −3.46125E−24 |
| A20 | 7.67306E−31 | 1.92848E−27 | 2.58654E−27 |

| | | |
|---|---|---|
| INF | 2414 mm | 1115 mm |

[Various types of data]

| | | | |
|---|---|---|---|
| Focal length | 131.00 | 126.60 | 117.94 |
| F number | 1.45 | 1.55 | 1.68 |
| Total angle of view 2ω | 18.24 | 16.89 | 15.23 |
| Image height Y | 21.63 | 21.63 | 21.63 |
| Total lens length | 152.50 | 152.50 | 152.50 |

[Variable distance data]

| | | | |
|---|---|---|---|
| d0 | ∞ | 2261.2759 | 962.6919 |
| d16 | 1.5021 | 6.0628 | 12.9795 |
| d18 | 26.2477 | 18.6740 | 7.2783 |
| d21 | 1.5912 | 4.6042 | 9.0832 |
| BF | 0.0000 | 0.0000 | 0.0000 |

[Lens group data]

| Group | Starting surface | Focal length |
|---|---|---|
| G1 | 1 | 95.75 |
| G2 | 17 | −59.16 |
| G3 | 19 | 1007.85 |
| G4 | 22 | 90.07 |

### Example 8

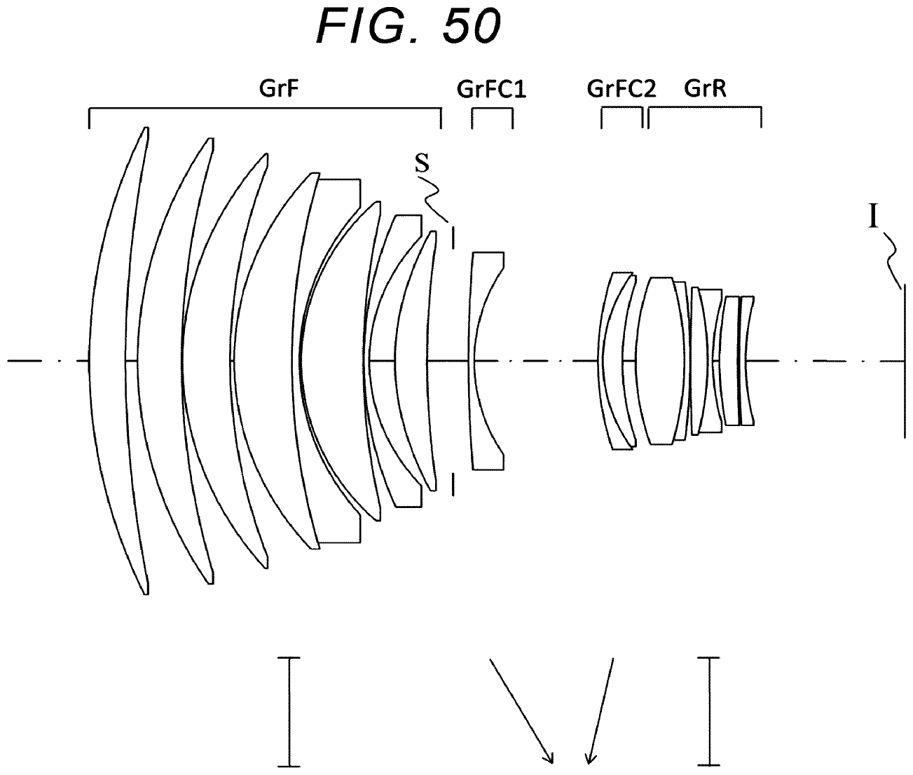

FIG. 50 is a lens configuration diagram of the imaging optical system of Example 8 of the present invention.

The imaging optical system consists of, in order from an object side, a front group GrF having a positive refractive power, a first focus group GrFC1 having a negative refractive power, a second focus group GrFC2 having a negative refractive power, and a rear group GrR having a positive refractive power. During focusing from infinity to a short distance, the front group GrF and the rear group GrR are fixed with respect to an image surface, the first focus group GrFC1 moves to the image side, and the second focus group GrFC2 moves to the object side. The aperture diaphragm S is closer to the object side than the first focus group GrFC1 and is adjacent to the image side of the front group GrF.

The front group GrF consists of: a positive meniscus lens having a convex surface facing the object side, a positive meniscus lens having a convex surface facing the object side, a positive meniscus lens having a convex surface facing the object side, a cemented lens consisting of a positive meniscus lens having a convex surface facing the object side and a negative meniscus lens having a convex surface facing the object side, a positive meniscus lens having a convex surface facing the object side, a negative meniscus lens having a convex surface facing the object side, and a positive meniscus lens having a convex surface facing the object side of which the object side is aspherical.

The first focus group GrFC1 consists of a negative meniscus lens having a convex surface facing the object side. The second focus group GrFC2 consists of a cemented lens consisting of a negative meniscus lens having a convex surface facing the object side and a positive meniscus lens having a convex surface facing the object side.

The rear group GrR consists of: a cemented lens consisting of a biconvex lens and a negative meniscus lens having a concave surface facing the object side, a cemented lens consisting of a biconvex lens and a biconcave lens, a positive meniscus lens having a convex surface facing the object side, and a biconcave lens with both surfaces being aspherical.

The specification values of the imaging optical system of Example 8 are shown below.

### Numerical Example 8

Unit: mm
[Surface data]

| Surface number | r | d | nd | vd | PgF |
|---|---|---|---|---|---|
| Object surface | ∞ | (d0) | | | |
| 1 | 154.2992 | 9.3056 | 1.66382 | 27.35 | 0.6319 |
| 2 | 329.5240 | 3.1026 | | | |
| 3 | 113.6054 | 11.2659 | 1.43700 | 95.10 | 0.5336 |
| 4 | 215.3201 | 0.2307 | | | |
| 5 | 87.7193 | 12.2279 | 1.43700 | 95.10 | 0.5336 |
| 6 | 155.8175 | 1.0286 | | | |
| 7 | 78.1457 | 14.8830 | 1.43700 | 95.10 | 0.5336 |
| 8 | 192.5337 | 1.9131 | 1.85451 | 25.15 | 0.6103 |
| 9 | 65.7184 | 0.4798 | | | |
| 10 | 60.4053 | 15.8915 | 1.62200 | 30.66 | 0.6248 |
| 11 | 188.9328 | 0.1823 | | | |
| 12 | 103.8956 | 1.3664 | 1.78880 | 28.43 | 0.6009 |
| 13 | 51.0585 | 6.5781 | | | |
| 14* | 69.1355 | 8.2892 | 1.58313 | 59.46 | 0.5405 |
| 15 | 242.7300 | 6.6998 | | | |
| 16 (Diaphragm) | ∞ | (d16) | | | |
| 17 | 381.4794 | 1.4567 | 1.69680 | 55.46 | 0.5426 |
| 18 | 47.7773 | (d18) | | | |
| 19 | 81.3290 | 1.2671 | 1.84666 | 23.78 | 0.6192 |
| 20 | 42.8285 | 5.0247 | 1.75500 | 52.32 | 0.5474 |
| 21 | 71.5810 | (d21) | | | |
| 22 | 71.8812 | 12.5637 | 1.90366 | 31.32 | 0.5948 |
| 23 | −85.6502 | 1.4479 | 1.68430 | 26.81 | 0.6232 |
| 24 | −189.0532 | 0.1500 | | | |
| 25 | 629.3453 | 4.3660 | 1.75575 | 24.71 | 0.6291 |
| 26 | −84.9383 | 1.3004 | 1.74077 | 27.76 | 0.6078 |
| 27 | 63.3895 | 1.7491 | | | |
| 28 | 97.4266 | 4.6585 | 2.00069 | 25.46 | 0.6136 |
| 29 | 351.9216 | 0.3488 | | | |
| 30* | 260.3705 | 1.7000 | 1.59201 | 67.02 | 0.5358 |
| 31* | 72.2609 | 40.9191 | | | |
| 32 | ∞ | (BF) | | | |
| Image surface | ∞ | | | | |

[Aspherical surface data]

| | Surface 14 | Surface 30 | Surface 31 |
|---|---|---|---|
| K | −2.45100 | 0.00000 | 0.00000 |
| A4 | 5.77000E−07 | −6.47454E−07 | 1.55838E−07 |
| A6 | −1.55961E−10 | 2.72492E−09 | 2.42322E−09 |
| A8 | 1.81718E−17 | −1.19788E−12 | 4.38337E−12 |
| A10 | −1.57211E−17 | −9.92547E−15 | −3.09996E−14 |
| A12 | 2.08682E−20 | 8.64616E−17 | 1.79200E−16 |
| A14 | −2.73258E−23 | −4.53735E−19 | −9.52495E−19 |
| A16 | 2.12485E−26 | 1.41399E−21 | 3.30001E−21 |
| A18 | −9.03639E−30 | −2.40992E−24 | −6.25290E−24 |
| A20 | 1.61853E−33 | 1.72989E−27 | 4.99006E−27 |

| | | |
|---|---|---|
| INF | 3310 mm | 1516 mm |

[Various types of data]

| | | | |
|---|---|---|---|
| Focal length | 180.00 | 174.09 | 162.51 |
| F number | 1.45 | 1.54 | 1.66 |
| Total angle of view 2ω | 13.46 | 12.57 | 11.49 |
| Image height Y | 21.63 | 21.63 | 21.63 |
| Total lens length | 209.50 | 209.50 | 209.50 |

[Variable distance data]

| | | | |
|---|---|---|---|
| d0 | ∞ | 3100.1185 | 1306.9229 |
| d16 | 3.8938 | 10.2637 | 20.1102 |
| d18 | 31.8008 | 22.8561 | 9.2206 |
| d21 | 3.4076 | 5.9824 | 9.7715 |
| BF | 0.0000 | 0.0000 | 0.0000 |

[Lens group data]

| Group | Starting surface | Focal length |
|---|---|---|
| G1 | 1 | 130.19 |
| G2 | 17 | −78.52 |
| G3 | 19 | −516.38 |
| G4 | 22 | 87.59 |

In all of the examples, the aperture diaphragm S is positioned between the front group GrF and GrFC1, but the aperture diaphragm S may be disposed in the front group GrF.

In addition, although not described in Examples, a hybrid aspherical surface, a diffraction grating, a refractive index distribution lens, or the like may be used as the lens element to reduce the size or improve the performance. The shape of the aspherical surface may also have an inflection point and may be a gullwing shape or may be a free curved surface.

In addition, although Examples describe the refractive index and the Abbe number, the present invention is not limited to numerical ranges, and a material having a refractive index nd of 1.43 or less or 2.01 or more may be used, and a material having an Abbe number vd of 17.0 or less or 101.0 or more may be used.

In addition, a material having a feature not described in Examples may be used for miniaturization or weight reduction or for favorable aberration correction. A micro-movement for focusing may be performed using a liquid lens or a gel lens.

In addition, in Examples, a part or the whole of the lens group may be moved in a direction substantially perpendicular to the optical axis to have an anti-vibration effect.

The following shows a list of corresponding values of the conditional expressions in each of the above examples.

### [Conditional Expression Corresponding Value]

| Conditional | | | | | | | | |
|---|---|---|---|---|---|---|---|---|
| Expressions | EX1 | EX2 | EX3 | EX4 | EX5 | EX6 | EX7 | EX8 |
| (1) | 0.64 | 0.61 | 0.69 | 0.71 | 0.55 | 0.59 | 0.64 | 0.67 |
| (2) | 1.74 | 1.71 | 1.48 | 1.44 | 1.48 | 1.55 | 1.57 | 1.63 |
| (3) | 0.26 | 0.27 | 0.25 | 0.25 | 0.27 | 0.27 | 0.28 | 0.26 |
| (4) | 95.04 | 94.93 | 95.10 | 95.10 | 95.10 | 91.72 | 94.93 | 95.10 |
| (5) | 0.096 | 0.022 | 0.156 | 0.182 | 0.016 | 0.045 | 0.045 | 0.075 |
| (6) | 0.315 | 0.228 | 0.316 | 0.318 | 0.315 | 0.317 | 0.245 | 0.433 |
| (7) | 1.825 | 1.740 | 2.543 | 2.563 | 1.444 | 1.099 | 1.716 | 1.753 |
| (8) | 0.16 | 0.04 | 0.16 | 0.18 | 0.04 | 0.12 | 0.06 | 0.12 |
| (9) | 0.54 | 0.11 | 0.62 | 0.72 | 0.09 | 0.23 | 0.13 | 0.35 |
| (10) | 20.02 | 27.35 | 20.88 | 20.88 | 20.02 | 20.02 | 27.35 | 27.35 |
| (11) | 0.031 | 0.033 | 0.028 | 0.028 | 0.031 | 0.031 | 0.033 | 0.033 |
| (12) | 0.63 | 0.64 | 0.52 | 0.51 | 0.72 | 0.70 | 0.59 | 0.62 |
| (13) | 0.160 | 0.163 | 0.148 | 0.149 | 0.120 | 0.158 | 0.161 | 0.159 |
| (14) | 1.40 | 1.36 | 1.67 | 1.69 | 1.23 | 1.09 | 1.37 | 1.38 |
| (15) | 2.36 | 1.85 | 2.15 | 2.22 | 1.63 | 1.88 | 1.45 | 2.06 |
| (16) | 2.46 | 2.32 | 2.96 | 2.95 | 1.82 | 1.60 | 2.21 | 2.29 |
| (4′) | 95.04 | 94.93 | 95.10 | 95.10 | 95.10 | 91.72 | 94.93 | 95.10 |
| (5′) | 0.096 | 0.022 | 0.156 | 0.182 | 0.016 | 0.045 | 0.045 | 0.075 |
| (6′) | 0.315 | 0.228 | 0.316 | 0.318 | 0.315 | 0.317 | 0.245 | 0.433 |

Although the configurations of the examples according to the imaging optical system of the present invention have been described above, various modification examples can be made without being limited to the description of the above-mentioned embodiments and examples. The shape and numerical value of each part shown in each of the above numerical examples are merely an example for carrying out the present technology, and the technical scope of the present invention is not limited by these examples.

The above described embodiments can adopt the following configurations.

### [Item 1]

An imaging optical system consisting of, in order from an object side:
a front group GrF having a positive refractive power;
a first focus group GrFC1 having a negative refractive power;
a second focus group GrFC2 having a negative refractive power; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side, and
following conditional expression is satisfied.

$$0.20 < LGrF / fF < 1.4 \qquad ( 1 )$$

LGrF: a length of the front group GrF on an optical axis in an infinity-focusing state
fF: a focal length of the front group GrF in the infinity-focusing state

### [Item 2]

An imaging optical system consisting of, in order from an object side:
a front group GrF having a positive refractive power;
a first focus group GrFC1 having a negative refractive power;
a second focus group GrFC2 having a negative refractive power; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side, and
following conditional expression is satisfied.

$$0.42 < f / fFC 2 R < 4.00 \qquad ( 2 )$$

f: a focal length of the entire lens system at focusing on infinity
fFC2R: a total focal length of the second focus group GrFC2 and the rear group GrR during focusing on infinity

### [Item 3]

An imaging optical system consisting of, in order from an object side:
a front group GrF having a positive refractive power;
a first focus group GrFC1 having a negative refractive power;
a second focus group GrFC2 having a negative refractive power; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side, and
following conditional expression is satisfied.

$$0.15 < LGrFGrR / LALL < 0.5 \qquad ( 3 )$$

LGrFGrR: a length on the optical axis from a surface of the front group GrF closest to the image side to a surface of the rear group GrR closest to the object side in the infinity-focusing state
LALL: a length on the optical axis from a surface of the front group GrF closest to the object side to an image surface in the infinity focusing state

### [Item 4]

An imaging optical system consisting of, in order from an object side:
a front group GrF having a positive refractive power;
a first focus group GrFC1 having a negative refractive power;
a second focus group GrFC2 having a negative refractive power; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side, and
following conditional expression is satisfied.

$$50. < vdG 24 < 102. \qquad ( 4 )$$

vdG24: a mean value of Abbe numbers of a second positive lens, a third positive lens, and a fourth positive lens of the front group GrF from the object side

### [Item 5]

An imaging optical system consisting of, in order from an object side:
a front group GrF having a positive refractive power;
a first focus group GrFC1 having a negative refractive power;
a second focus group GrFC2 having a negative refractive power; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side, and
following conditional expression is satisfied.

$$0. < \vert K 2 \vert < 0.37 \qquad ( 5 )$$

   |K2|: focus sensitivity of the second focus group GrFC2 in the infinity-focusing state

$$\vert K 2 \vert = \vert ( 1 - β FC 2 \hat{} 2 ) * ( β R \hat{} 2 ) \vert$$

ßFC2: lateral magnification of second focus group GrFC2 in the infinity-focusing state
ßR: lateral magnification of the rear group GR in the infinity-focusing state

### [Item 6]

An imaging optical system consisting of, in order from an object side:
a front group GrF having a positive refractive power;
a first focus group GrFC1 having a negative refractive power;
a second focus group GrFC2; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side, and
following conditional expressions are satisfied.

$$0. < \vert K 2 \vert < 0.37 \qquad ( 5 )$$

$$0.107 < Δ Gr 1 GrFC 1 / Y max < 1. \qquad ( 6 )$$

   |K2|: focus sensitivity of the second focus group GrFC2 in the infinity-focusing state

$$\vert K 2 \vert = \vert ( 1 - β FC 2 \hat{} 2 ) * ( β R \hat{} 2 ) \vert$$

ßFC2: lateral magnification of second focus group GrFC2 in the infinity-focusing state
ßR: lateral magnification of the rear group GR in the infinity-focusing state
ΔGr1GrFC1: a length parallel to optical axis between a position of an axial ray height of a surface of the front group GrF closest to the image side and a position of an axial ray height of a surface of the first focus group GrFC1 closest to the object side in the infinity focusing state
Ymax: maximum image height

### [Item 7]

An imaging optical system consisting of, in order from an object side:
a front group GrF having a positive refractive power;
a first focus group GrFC1 having a negative refractive power;
a second focus group GrFC2; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side, and
following conditional expressions are satisfied.

$$55. < vdG 24 < 102. \qquad ( {4}^{′} )$$

$$0.095 < Δ Gr 1 GrFC 1 / Y max < 1. \qquad ( {6}^{′} )$$

vdG24: a mean value of Abbe numbers of a second positive lens, a third positive lens, and a fourth positive lens of the front group GrF from the object side
ΔGr1GrFC1: a length parallel to optical axis between a position of an axial ray height of a surface of the front group GrF closest to the image side and a position of an axial ray height of a surface of the first focus group GrFC1 closest to the object side in the infinity focusing state
Ymax: maximum image height

### [Item 8]

An imaging optical system consisting of, in order from an object side:
a front group GrF having a positive refractive power;
a first focus group GrFC1 having a negative refractive power;
a second focus group GrFC2; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side, and
a shape of a second positive lens to a fourth positive lens from the object side in the front group GrF is a positive meniscus shape of an object side convex surface.

### [Item 9]

An imaging optical system consisting of, in order from an object side:
a front group GrF having a positive refractive power;
a first focus group GrFC1 having a negative refractive power;
a second focus group GrFC2; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side,
an aperture diaphragm S is closer to the object side than the first focus group GrFC1, and
following conditional expression is satisfied.

$$55. < vdG 24 < 102. \qquad ( {4}^{′} )$$

vdG24: a mean value of Abbe numbers of a second positive lens, a third positive lens, and a fourth positive lens of the front group GrF from the object side

### [Item 10]

An imaging optical system consisting of, in order from an object side:
a front group GrF having a positive refractive power;
a first focus group GrFC1 having a negative refractive power;
a second focus group GrFC2; and
a rear group GrR having a positive refractive power,
in which during focusing from infinity to a short distance, the front group GrF and the rear group GrR are fixed with respect to an image surface,
the first focus group GrFC1 moves to the image side, the second focus group GrFC2 moves to the object side,
the aperture diaphragm S is adjacent to the front group GrF on the image side, and
following conditional expression is satisfied.

$$0. < \vert K 2 \vert < 0.6 \qquad ( {5}^{′} )$$

   |K2|: focus sensitivity of the second focus group GrFC2 in the infinity-focusing state

$$\vert K 2 \vert = \vert ( 1 - β FC 2 \hat{} 2 ) * ( β R \hat{} 2 ) \vert$$

ßFC2: lateral magnification of second focus group GrFC2 in the infinity-focusing state
ßR: lateral magnification of the rear group GR in the infinity-focusing state

### [Item 11]

The imaging optical system according to any one of [Item 6] to [Item 9], in which the second focus group GrFC2 has a negative refractive power.

### [Item 12]

The imaging optical system according to any one of [Item 1] to [Item 9] and [Item 11], further comprising: an aperture diaphragm S, in which the aperture diaphragm S is adjacent to the image side of the front group GrF.

### [Item 13]

The imaging optical system according to any one of [Item 1] to [Item 7] and [Item 9] to [Item 12], in which shapes of a second to fourth positive lenses in the front group GrF are positive menisci each having an object side convex surface.

### [Item 14]

The imaging optical system according to any one of [Item 1] to [Item 13], in which the first focus group GrFC1 consists of one lens.

### [Item 15]

The imaging optical system according to any one of [Item 1] to [Item 14], in which the second focus group GrFC2 consists of one or two lenses.

### [Item 16]

The imaging optical system according to any one of [Item 1] to [Item 15], in which the rear group GrR having a positive refractive power has one or more negative lenses on the image side of the positive lens.

### [Item 17]

The imaging optical system according to any one of [Item 1] to [Item 16], in which the following conditional Expressions are satisfied.

$$0.6 < \vert K 1 \vert < 4. \qquad ( 7 )$$

$$0. < \vert fFC 12 / fFC 2 \vert < 0.5 \qquad ( 8 )$$

$$0. < \vert f / fFC 2 \vert < 1. \qquad ( 9 )$$

$$15. < vdGla 1 < 40. \qquad ( 10 )$$

$$0.01 < Δ PgFGla 1 < 0.1 \qquad ( 11 )$$

$$0.25 < \vert exp / f \vert < 1.5 \qquad ( 12 )$$

$$0.08 < ( Y 1 GrF - Y 2 GrF ) / f < 0.3 \qquad ( 13 )$$

$$0.75 < f / fF < 2.5 \qquad ( 14 )$$

$$0.7 < f / fR < 3.5 \qquad ( 15 )$$

$$1. < \vert f / fFC 1 \vert < 4. \qquad ( 16 )$$

   |K1|: focus sensitivity of the first focus group GrFC1 in the infinity-focusing state

$$\vert K 1 \vert = \vert ( 1 - β FC 1 \hat{} 2 ) * ( ( β FC 2 * β R ) \hat{} 2 ) \vert$$

ßFC1: lateral magnification of the first focus group GrFC1 in the infinity-focusing state
ßFC2: lateral magnification of the second focus group GrFC2 in the infinity-focusing state
ßR: lateral magnification of the rear group GR in the infinity-focusing state
fFC12: a total focal length from the first focus group GrFC1 to the second focus group GrFC2 at focusing on infinity
fFC2: a focal length of the second focus group GrFC2
f: a focal length of the entire lens system at focusing on infinity
vdGla1: Abbe number of the positive lens closest to the object side
ΔPgFGla1: ΔPgF of the positive lens closest to the object side

Here,

ΔPgF is an anomalous dispersion between g and F lines, and is represented by following expression.

$$Δ Pgf = PgF - 0.64833 + 0.0018 vd$$

PgF=(ng− nF)/(nF−nC): a partial dispersion ratio between g and F lines
ng: a refractive index with respect to g line (wavelength λ=435.84 nm)
nF: a refractive index with respect to F line (wavelength λ=486.13 nm)
nC: a refractive index with respect to C line (wavelength λ=656.27 nm)
exp: a length from exit pupil position to image surface
Y1GrF: an axial ray height of a surface of the front group GrF closest to the object side
Y2GrF: an axial ray height of a surface of the front group GrF closest to the image side
fF: a focal length of the front group GrF in the infinity-focusing state
fR: a focal length of the rear group GrR in the infinity-focusing state
fFC1: a focal length of the first focus group GrFC1 in the infinity-focusing state

### DESCRIPTION OF REFERENCE NUMERALS AND SIGNS

GrF: front group
GrR: rear group
GrFC1: first focus group
GrFC2: second focus group
I: image surface
S: aperture diaphragm

What is claimed is:

1. An imaging optical system comprising, in order from an object side:
a front group GrF having a positive refractive power;
a first focus group GrFC1 having a negative refractive power;
a second focus group GrFC2 having a negative refractive power; and
a rear group GrR having a positive refractive power, wherein
during focusing from infinity to a short distance, the front group GrF and the rear group GrR are fixed with respect to an image surface, the first focus group GrFC1 moves to the image side, and the second focus group GrFC2 moves to the object side, and
following conditional expressions are satisfied:
$$0.2 < LGrF / fF < 1.4 \qquad ( 1 )$$
$$0.42 < f / fFC 2 R < 4. \qquad ( 2 )$$
$$0.15 < LGrFGrR / LALL < 0.5 \qquad ( 3 )$$
LGrF: a length of the front group GrF on an optical axis in an infinity-focusing state
fF: a focal length of the front group GrF in the infinity focusing state
f: a focal length of the entire lens system at focusing on infinity
fFC2R: a total focal length of the second focus group GrFC2 and the rear group GrR during focusing on infinity
LGrFGrR: a length on the optical axis from a surface of the front group GrF closest to the image side to a surface of the rear group GrR closest to the object side in the infinity focusing state
LALL: a length on the optical axis from a surface of the front group GrF closest to the object side to an image surface in the infinity focusing state.

2. The imaging optical system according to claim 1, wherein following conditional expression is satisfied:
$$0.107 < Δ Gr 1 GrFC 1 / Y max < 1. \qquad ( 6 )$$
ΔGr1GrFC1: a length parallel to optical axis between a position of an axial ray height of a surface of the front group GrF closest to the image side and a position of an axial ray height of a surface of the first focus group GrFC1 closest to the object side in the infinity-focusing state
Ymax: maximum image height.

3. The imaging optical system according to claim 1, wherein following conditional expression is satisfied:
$$50. < vdG 24 < 102. \qquad ( 4 )$$
vdG24: a mean value of Abbe numbers of a second positive lens, a third positive lens, and a fourth positive lens of the front group GrF from the object side.

4. The imaging optical system according to claim 1, further comprising: an aperture diaphragm S, wherein the aperture diaphragm S is adjacent to the image side of the front group GrF.

5. The imaging optical system according to claim 1, wherein the first focus group GrFC1 consists of one lens.

6. The imaging optical system according to claim 1, wherein the second focus group GrFC2 consists of one or two lenses.

7. The imaging optical system according to claim 1, wherein the following conditional expressions are satisfied:
$$0.6 < \vert K 1 \vert < 4. \qquad ( 7 )$$
$$0. < \vert fFC 12 / fFC 2 \vert < 0.5 \qquad ( 8 )$$
$$0. < \vert f / fFC 2 \vert < 1. \qquad ( 9 )$$
$$15. < vdGla 1 < 40. \qquad ( 10 )$$
$$0.01 < Δ PgFGla 1 < 0.1 \qquad ( 11 )$$
$$0.25 < \vert exp / f \vert < 1.5 \qquad ( 12 )$$
$$0.08 < ( Y 1 GrF - Y 2 GrF ) / f < 0.3 \qquad ( 13 )$$
$$0.75 < f / fF < 2.5 \qquad ( 14 )$$
$$0.7 < f / fR < 3.5 \qquad ( 15 )$$
$$1. < \vert f / fFC 1 \vert < 4. \qquad ( 16 )$$

|K1|: focus sensitivity of the first focus group GrFC1 in the infinity-focusing state
$$\vert K 1 \vert = \vert ( 1 - βFC1 \hat{} 2 ) ⋆ ( βFC2 * βR ) \hat{} 2 \vert$$
ßFC1: lateral magnification of first focus group GrFC1 in the infinity-focusing state
ßFC2: lateral magnification of second focus group GrFC2 in the infinity-focusing state
ßR: lateral magnification of the rear group GR in the infinity-focusing state
fFC12: a total focal length from the first focus group GrFC1 to the second focus group GrFC2 at focusing on infinity
fFC2: a focal length of the second focus group GrFC2
f: a focal length of the entire lens system at focusing on infinity
vdGla1: Abbe number of the positive lens closest to the object side
ΔPgFGla1: ΔPgF of the positive lens closest to the object side
Here, ΔPgF is an anomalous dispersion between g and F lines, and is represented by the following expression: ΔPgF=PgF−0.64833+0.00180vd
PgF=(ng−nF)/(nF−nC): a partial dispersion ratio between g and F lines
ng: a refractive index with respect to g line (wavelength λ=435.84 nm)
nF: a refractive index with respect to F line (wavelength λ=486.13 nm)
nC: a refractive index with respect to C line (wavelength λ=656.27 nm)
exp: a length from exit pupil position to image surface
Y1GrF: an axial ray height of a surface of the front group GrF closest to the object side
Y2GrF: an axial ray height of a surface of the front group GrF closest to the image side
fF: a focal length of the front group GrF in the infinity focusing state
fR: a focal length of the rear group GrR in the infinity focusing state
fFC1: a focal length of the first focus group GrFC1 in the infinity focusing state.

8. An imaging optical system comprising, in order from an object side:
a front group GrF having a positive refractive power;
a first focus group GrFC1 having a negative refractive power;
a second focus group GrFC2 having a negative refractive power; and
a rear group GrR having a positive refractive power, wherein
during focusing from infinity to a short distance, the front group GrF and the rear group GrR are fixed with respect to an image surface, the first focus group GrFC1 moves to the image side, and the second focus group GrFC2 moves to the object side, and
following conditional expression is satisfied:
$$0.0 \; 00 < \vert K 2 \vert < 0. 370 \qquad ( 5 )$$

|K2|: focus sensitivity of the second focus group GrFC2 in the infinity-focusing state
$$\vert K 2 \vert = \vert ( 1 - βFC2 \hat{} 2 ) ⋆ ( βR \hat{} 2 ) \vert$$
ßFC2: lateral magnification of the second focus group GrFC2 in the infinity-focusing state
ßR: lateral magnification of the rear group GR in the infinity-focusing state.

9. The imaging optical system according to claim 8, wherein following conditional expressions are satisfied:
$$0.2 < LGrF / fF < 1.4 \qquad ( 1 )$$
$$0.42 < f / fFC 2 R < 4 \text{.00} \qquad ( 2 )$$
$$0.15 < LGrFGrR / LALL < 0.5 \qquad ( 3 )$$
LGrF: a length of the front group GrF on an optical axis in an infinity-focusing state
fF: a focal length of the front group GrF in the infinity-focusing state
f: a focal length of the entire lens system at focusing on infinity
fFC2R: a total focal length of the second focus group GrFC2 and the rear group GrR during focusing on infinity
LGrFGrR: a length on the optical axis from a surface of the front group GrF closest to the image side to a surface of the rear group GrR closest to the object side in the infinity-focusing state
LALL: a length on the optical axis from a surface of the front group GrF closest to the object side to an image surface in the infinity-focusing state.

10. The imaging optical system according to claim 8, wherein following conditional expression is satisfied:
$$0.1 \; 07 < Δ Gr 1 GrFC 1 / Y max < 1. \qquad ( 6 )$$
ΔGr1GrFC1: a length parallel to optical axis between a position of an axial ray height of a surface of the front group GrF closest to the image side and a position of an axial ray height of a surface of the first focus group GrFC1 closest to the object side in the infinity-focusing state
Ymax: maximum image height.

11. The imaging optical system according to claim 8, wherein the following conditional expression is satisfied:
$$50.00 < v d G 24 < 102.00 \qquad ( 4 )$$
vdG24: a mean value of Abbe numbers of a second positive lens, a third positive lens, and a fourth positive lens of the front group GrF from the object side.

12. The imaging optical system according to claim 8, further comprising: an aperture diaphragm S, wherein the aperture diaphragm S is adjacent to the image side of the front group GrF.

13. The imaging optical system according to claim 8, wherein the first focus group GrFC1 consists of one lens.

14. The imaging optical system according to claim 8, wherein the second focus group GrFC2 consists of one or two lenses.

15. The imaging optical system according to claim 8, wherein the following conditional expressions are satisfied:
$$0.6 < \vert K 1 \vert < 4. 000 \qquad ( 7 )$$
$$0. < \vert fFC 12 / fFC 2 \vert < 0.5 \qquad ( 8 )$$
$$0. < \vert f / fFC 2 \vert < 1. \qquad ( 9 )$$
$$15. < vdGla 1 < 40. \qquad ( 10 )$$
$$0.01 < Δ PgFGla 1 < 0.1 \qquad ( 11 )$$
$$0.25 < \vert exp / f \vert < 1.5 \qquad ( 12 )$$
$$0.08 < ( Y 1 GrF - Y 2 GrF ) / f < 0 \text{.300} \qquad ( 13 )$$
$$0.75 < f / fF < 2 \text{.50} \qquad ( 14 )$$
$$0.7 < f / fR < 3 \text{.50} \qquad ( 15 )$$
$$1. 00 < \vert f / fFC 1 \vert < 4. 00 \qquad ( 16 )$$

|K1|: focus sensitivity of the first focus group GrFC1 in the infinity-focusing state
$$\vert K 1 \vert = \vert ( 1 - βFC1 \hat{} 2 ) ⋆ ( βFC2 * βR ) \hat{} 2 \vert$$
ßFC1: lateral magnification of first focus group GrFC1 in the infinity-focusing state
ßFC2: lateral magnification of second focus group GrFC2 in the infinity-focusing state
ßR: lateral magnification of the rear group GR in the infinity-focusing state
fFC12: a total focal length from the first focus group GrFC1 to the second focus group GrFC2 at focusing on infinity
fFC2: a focal length of the second focus group GrFC2
f: a focal length of the entire lens system at focusing on infinity
vdGla1: Abbe number of the positive lens closest to the object side
ΔPgFGla1: ΔPgF of the positive lens closest to the object side
Here, ΔPgF is an anomalous dispersion between g and F lines, and is represented by the following expression: ΔPgF=PgF−0.64833+0.00180vd
PgF=(ng−nF)/(nF−nC): a partial dispersion ratio between g and F lines
ng: a refractive index with respect to g line (wavelength λ=435.84 nm)
nF: a refractive index with respect to F line (wavelength λ=486.13 nm)
nC: a refractive index with respect to C line (wavelength λ=656.27 nm)
exp: a length from exit pupil position to image surface
Y1GrF: an axial ray height of a surface of the front group GrF closest to the object side
Y2GrF: an axial ray height of a surface of the front group GrF closest to the image side
fF: a focal length of the front group GrF in the infinity-focusing state
fR: a focal length of the rear group GrR in the infinity-focusing state
fFC1: a focal length of the first focus group GrFC1 in the infinity-focusing state.

16. An imaging optical system comprising, in order from an object side:
a front group GrF having a positive refractive power;
a first focus group GrFC1 having a negative refractive power;
a second focus group GrFC2; and
a rear group GrR having a positive refractive power, wherein
during focusing from infinity to a short distance, the front group GrF and the rear group GrR are fixed with respect to an image surface, the first focus group GrFC1 moves to the image side, and the second focus group GrFC2 moves to the object side, and
following conditional expressions are satisfied:
$$0. < \vert K 2 \vert < 0.370 \qquad ( 5 )$$
$$0.107 < Δ Gr 1 GrFC 1 / Y max < 1. \qquad ( 6 )$$

|K2|: focus sensitivity of the second focus group GrFC2 in the infinity-focusing state
$$\vert K 2 \vert = \vert ( 1 - βFC2 \hat{} 2 ) ⋆ ( βR \hat{} 2 ) \vert$$
ßFC2: lateral magnification of the second focus group GrFC2 in the infinity-focusing state
ßR: lateral magnification of the rear group GR in the infinity-focusing state
ΔGr1GrFC1: a length parallel to optical axis between a position of an axial ray height of a surface of the front group GrF closest to the image side and a position of an axial ray height of a surface of the first focus group GrFC1 closest to the object side in the infinity-focusing state
Ymax: maximum image height.

17. The imaging optical system according to claim 16, wherein the following conditional expressions are satisfied:
$$0.2 < LGrF / fF < 1.4 \qquad ( 1 )$$
$$0.42 < f / fFC 2 R < 4 \text{.00} \qquad ( 2 )$$
$$0.15 < LGrFGrR / LALL < 0.5 \qquad ( 3 )$$
LGrF: a length of the front group GrF on an optical axis in an infinity-focusing state
fF: a focal length of the front group GrF in the infinity-focusing state
f: a focal length of the entire lens system at focusing on infinity
fFC2R: a total focal length of the second focus group GrFC2 and the rear group GrR during focusing on infinity
LGrFGrR: a length on the optical axis from a surface of the front group GrF closest to the image side to a surface of the rear group GrR closest to the object side in the infinity-focusing state
LALL: a length on the optical axis from a surface of the front group GrF closest to the object side to an image surface in the infinity-focusing state.

18. The imaging optical system according to claim 16, wherein the following conditional expression is satisfied:
$$50.00 < v d G 24 < 102.00 \qquad ( 4 )$$
vdG24: a mean value of Abbe numbers of a second positive lens, a third positive lens, and a fourth positive lens of the front group GrF from the object side.

19. The imaging optical system according to claim 16, further comprising: an aperture diaphragm S, wherein the aperture diaphragm S is adjacent to the image side of the front group GrF.

20. The imaging optical system according to claim 16, wherein the first focus group GrFC1 consists of one lens.

21. The imaging optical system according to claim 16, wherein the second focus group GrFC2 consists of one or two lenses.

22. The imaging optical system according to claim 16, wherein the following conditional expressions are satisfied:
$$0.6 < \vert K 1 \vert < 4. 000 \qquad ( 7 )$$
$$0. < \vert fFC 12 / fFC 2 \vert < 0.5 \qquad ( 8 )$$
$$0. < \vert f / fFC 2 \vert < 1. \qquad ( 9 )$$
$$15. < vdGla 1 < 40. \qquad ( 10 )$$
$$0.01 < Δ PgFGla 1 < 0.1 \qquad ( 11 )$$
$$0.25 < \vert exp / f \vert < 1.5 \qquad ( 12 )$$
$$0.08 < ( Y 1 GrF - Y 2 GrF ) / f < 0 \text{.300} \qquad ( 13 )$$
$$0.75 < f / fF < 2 \text{.50} \qquad ( 14 )$$
$$0.7 < f / fR < 3 \text{.50} \qquad ( 15 )$$
$$1. 00 < \vert f / fFC 1 \vert < 4. 00 \qquad ( 16 )$$

|K1|: focus sensitivity of the first focus group GrFC1 in the infinity-focusing state
$$\vert K 1 \vert = \vert ( 1 - βFC1 \hat{} 2 ) ⋆ ( βFC2 * βR ) \hat{} 2 \vert$$
ßFC1: lateral magnification of first focus group GrFC1 in the infinity-focusing state
ßFC2: lateral magnification of second focus group GrFC2 in the infinity-focusing state
ßR: lateral magnification of the rear group GR in the infinity-focusing state
fFC12: a total focal length from the first focus group GrFC1 to the second focus group GrFC2 at focusing on infinity
fFC2: a focal length of the second focus group GrFC2
f: a focal length of the entire lens system at focusing on infinity
vdGla1: Abbe number of the positive lens closest to the object side
ΔPgFGla1: ΔPgF of the positive lens closest to the object side
Here, ΔPgF is an anomalous dispersion between g and F lines, and is represented by the following expression: ΔPgF=PgF−0.64833+0.00180vd
PgF=(ng−nF)/(nF−nC): a partial dispersion ratio between g and F lines
ng: a refractive index with respect to g line (wavelength λ=435.84 nm)
nF: a refractive index with respect to F line (wavelength λ=486.13 nm)
nC: a refractive index with respect to C line (wavelength λ=656.27 nm)
exp: a length from exit pupil position to image surface
Y1GrF: an axial ray height of a surface of the front group GrF closest to the object side
Y2GrF: an axial ray height of a surface of the front group GrF closest to the image side
fF: a focal length of the front group GrF in the infinity-focusing state
fR: a focal length of the rear group GrR in the infinity-focusing state
fFC1: a focal length of the first focus group GrFC1 in the infinity-focusing state.
